(19) United States
(12) Patent Application Publication
(10) Pub. No.: US 2019/0265492 A1
(43) Pub. Date: Aug. 29, 2019

(54) DISPLAY DEVICE AND DISPLAY DEVICE DRIVING METHOD

(71) Applicant: Mitsubishi Electric Corporation, Tokyo (JP)

(72) Inventors: Akimasa YUUKI, Tokyo (JP); Kazunori OKUMOTO, Tokyo (JP); Yohei IIDA, Tokyo (JP)

(73) Assignee: Mitsubishi Electric Corporation, Tokyo (JP)

(21) Appl. No.: 16/260,164

(22) Filed: Jan. 29, 2019

(30) Foreign Application Priority Data
Feb. 26, 2018 (JP) 2018-031588

(51) Int. Cl. G02B 27/22; G02B 27/26; G02F 1/1343; G02F 1/1335; G02F 1/13357; G09G 3/36; H04N 13/31

(52) U.S. Cl. CPC G02B 27/2214; G02B 27/26; G02F 1/134309; G02F 2201/123; G02F 1/1336; G09G 3/36; H04N 13/31; G02F 1/133512

(57) ABSTRACT

A display device includes a display panel, parallax barrier, and a backlight. The parallax barrier includes a liquid crystal layer, a first electrode layer, and a second electrode layer. The first electrode layer is disposed while corresponding to a plurality of pixels, and the first electrode layer includes 2N divided electrode layers divided from each other in a unit region corresponding to one pixel set. A first voltage applied to at least one of the divided electrode layers located at an end of the light shielding part is lower than a second voltage applied to at least one of the divided electrode layers located at a position except for the end of the light shielding part.

### BACKGROUND OF THE INVENTION

### Field of the Invention

The technique disclosed in the specification relates to a display device such as a parallax barrier type naked-eye three-dimensional display or a multi-image display that displays different images in each observation direction.

### Description of the Background Art

Conventionally, there has been proposed a naked-eye stereoscopic image display device capable of performing stereoscopic vision with no use of special eyeglasses.

For example, Japanese Patent No. 2857429 discloses a three-dimensional image display device including barrier generating means for generating a parallax barrier stripe by electronic control using a transmission display element and image display means in which a display screen is disposed backwardly apart from an occurrence position of the parallax barrier stripe by a predetermined distance, the image display means capable of outputting and displaying a multi-direction image in which a strip of a left image and a strip of a right image are alternately arrayed to the display screen according to the parallax barrier stripe at a time of three-dimensional image display.

In the three-dimensional image display device, a barrier stripe is electronically generated, and a shape (for example, the number of stripes, a width of a stripe, and an interval between stripes), a position (that is, a phase), density, or the like of the generated barrier stripe can freely and variably be controlled. For this reason, the variable control can be used as not only two-dimensional image display device and method but also three-dimensional image display device and method, and compatible image display device and method can be implemented.

In Japanese Patent No. 2857429, a position of an observer's head is detected, and a phase of the position (that is, the phase) of an electronic barrier is reversed (that is, a positional relationship between the barrier and the transmission part is reversed) by a detection signal every time the head moves laterally by a distance of the pupil interval, thereby solving a parallactic phenomenon in a binocular parallax stereogram to widen an observation range where stereoscopic vision can be performed.

Japanese Patent No. 3668116 discloses a stereoscopic image display device without eyeglasses including image display means for alternately displaying a stripe-shaped left-eye image and a stripe-shaped right-eye image, light shielding means for being able to move a position of a light shielding part that causes a binocular parallax effect with ¼ of a pitch of the light shielding part, a sensor that detects whether the lateral movement of the position of the observer's head and the position of the observer's head deviate back and forth from an optimum viewing range, and region division movement control means for laterally dividing the light shielding means into regions and for controlling movement or non-movement of the position of the light shielding part of the light shielding means in each divided region according to a state in which the position of the observer's head deviates back and forth from the optimum viewing range.

In the stereoscopic image display apparatus disclosed in Japanese Patent No. 3668116, when the observer's head moves to a shifted position, a right-eye image can be supplied to a right eye of the observer by performing movement control of the light shielding part and the display control of the image display means, and the observer can recognize the stereoscopic image because a left-eye image is supplied to a left eye of the observer.

Japanese Patent Application Laid-Open No. 2011-76095 discloses a display device including a black mask part having at least two different widths between a right-eye pixel and a left-eye pixel of a display part horizontally adjacent to a pixel corresponding to an opening of the barrier, and the black mask part between the pixels constituting a parallax image pair is made larger than other places.

This enables a 3D crosstalk (that is, a phenomenon in which the image of the right-eye (left-eye) image appears in on the left eye (right eye)) to be decreased at the boundary between the regions displaying the right-eye image and the left-eye image, and observer can recognize the stereoscopic image without a double image caused by the 3D crosstalk in a wider range. When a different image is displayed instead of the parallax image, a multi-directional image without the double image caused by the 3D crosstalk can be recognized in a wider range for each observation direction.

### SUMMARY

In general, in a naked-eye stereoscopic display or a multi-image display that displays different images for each observation direction, a luminance difference of the display image exists depending on the observation direction. For this reason, in the three-dimensional display devices disclosed in Japanese Patent Nos. 2857429 and 3668116 and Japanese Patent Application Laid-Open No. 2011-76095, even if the movement control of the barrier light shielding part and the display control of the image display means are performed by electronic control according to the movement of the head of the observer, because a delay of operation is inevitably generated, observer's eyes may feel a change in luminance of the image or enter the boundary region to visually recognize the double image by the 3D crosstalk. The observer particularly feels uncomfortable when the observer's head moves quickly or when the movement is frequently performed.

Thus, desirably the luminance is not change depending on the position in the observation region of each image, and the region where the 3D crosstalk is generated is narrow at the boundary with the viewing region of the image in another direction.

An object of the technique disclosed in the specification is to provide a technique capable of continuing the stereoscopic vision over a wide range even if the observer moves and capable of preventing the generation of the 3D crosstalk.

A first aspect of the technique disclosed in the specification is a display device including: a display panel on which a pixel set including at least two pixels as one set that display each of images observed from different directions is disposed; a parallax barrier that is disposed while overlapping the display panel in planar view; and a backlight that is disposed while overlapping the display panel in planar view. The parallax barrier includes: a liquid crystal layer; and a first electrode layer and a second electrode layer, which overlap the liquid crystal layer in planar view and are disposed with the liquid crystal layer interposed therebetween, the parallax barrier is of a normally white type in which transmittance of the liquid crystal layer is decreased with increasing voltage applied to the liquid crystal layer, the first electrode layer in the parallax barrier is disposed while corresponding to the plurality of the pixels in the display panel, the first electrode layer includes 2N divided electrode layers divided from each other in a unit region corresponding to the one pixel set, a transmission part is formed by applying voltage at which the transmittance of the liquid crystal layer becomes greater than or equal to 90% to the consecutive N divided electrode layers, a light shielding part is formed by applying voltage at which the transmittance of the liquid crystal layer becomes less than or equal to 10% to the N divided electrode layers continuously extended from the divided electrode layer adjacent to the transmission part, and a first voltage applied to at least one of the divided electrode layer located at an end of the light shielding part is lower than a second voltage applied to at least one of the divided electrode layer located at a position except for the end of the light shielding part.

A second aspect of the technique disclosed in the specification is a display device driving method for driving a display device including: a display panel on which a pixel set including at least two pixels as one set that display each of images observed from different directions is disposed; a parallax barrier that is disposed while overlapping the display panel in planar view; and a backlight that is disposed while overlapping the display panel in planar view. The parallax barrier includes: a liquid crystal layer; and a first electrode layer and a second electrode layer, which overlap the liquid crystal layer in planar view and are disposed with the liquid crystal layer interposed therebetween, the parallax barrier is of a normally white type in which transmittance of the liquid crystal layer is decreased with increasing voltage applied to the liquid crystal layer, the first electrode layer in the parallax barrier is disposed while corresponding to the plurality of the pixels in the display panel, the first electrode layer includes 2N divided electrode layers divided from each other in a unit region corresponding to the one pixel set, a transmission part is formed by applying voltage at which the transmittance of the liquid crystal layer becomes greater than or equal to 90% to the consecutive N divided electrode layers, a light shielding part is formed by applying voltage at which the transmittance of the liquid crystal layer becomes less than or equal to 10% to the N divided electrode layers continuously extended from the divided electrode layer adjacent to the transmission part, a first voltage is applied to at least one of the divided electrode layer located at an end of the light shielding part, a second voltage is applied to at least one of the divided electrode layer located at a position except for the end of the light shielding part, and the first voltage is lower than the second voltage.

According to the first and second aspects of the technique disclosed in the specification, the stereoscopic vision can be continued over the wide range even if the observer moves, and the generation of the 3D crosstalk can be prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating examples of a measurement value, a geometrical optics calculation result, and a wave optics calculation result of a lateral light distribution characteristic in a parallax barrier type naked-eye stereoscopic display;

FIG. 2 is an enlarged view illustrating a low-luminance part of the measurement value, the geometric optics calculation result, and the wave optics calculation result of the lateral light distribution characteristic in the parallax barrier type naked-eye stereoscopic display;

FIG. 3 is a schematic diagram illustrating a wave optics calculation model for calculating a light distribution characteristic of a display device having a parallax barrier;

FIG. 4 is a perspective view illustrating a structure of a display device according to a first prerequisite technique;

FIG. 5 is a sectional view illustrating the structure of the display device of the first prerequisite technique;

FIG. 6 is a view illustrating examples of the measured value and the wave optics calculation result of a lateral light distribution characteristic in a two-image display device;

FIG. 7 is an enlarged view illustrating a boundary of the measured values and the wave optics calculation result of the lateral light distribution characteristic in the two-image display device;

FIG. 8 is a view illustrating an example of the wave optics calculation result of the lateral light distribution characteristic when a width of a translucent part in the display device of the first prerequisite technique is changed;

FIG. 9 is an enlarged view illustrating the wave optics calculation result of the lateral light distribution characteristic when the width of the translucent part in the display device of the first prerequisite technique is changed;

FIG. 10 is a view illustrating an example of the wave optics calculation result of the lateral light distribution characteristic when transmittance of the translucent part in the display device of the first prerequisite technique is changed;

FIG. 11 is a schematic diagram illustrating a method for manufacturing the parallax barrier of the display device of the first prerequisite technique;

FIG. 12 is a schematic diagram illustrating the method for manufacturing the parallax barrier of the display device of the first prerequisite technique;

FIG. 13 is a schematic diagram illustrating the method for manufacturing the parallax barrier of the display device of the first prerequisite technique;

FIG. 14 is a schematic diagram illustrating the method for manufacturing the parallax barrier of the display device of the first prerequisite technique;

FIG. 15 is a schematic diagram illustrating the method for manufacturing the parallax barrier of the display device of the first prerequisite technique;

FIG. 16 is a schematic diagram illustrating an optical path difference that is a necessary condition for a structure pitch of the translucent part;

FIG. 17 is a sectional view illustrating a structure of a display device according to a second prerequisite technique;

FIG. 18 is a schematic diagram illustrating operation of the translucent part of a barrier liquid crystal in the display device of the second prerequisite technique;

FIG. 19 is a schematic diagram illustrating barrier movement operation of the display device of the second prerequisite technique;

FIG. 20 is a schematic diagram illustrating the barrier movement operation of the display device of the second prerequisite technique;

FIG. 21 is a schematic diagram illustrating the barrier movement operation of the display device of the second prerequisite technique;

FIG. 22 is a schematic diagram illustrating the barrier movement operation of the display device of the second prerequisite technique;

FIG. 23 is a schematic diagram illustrating the barrier movement operation of the display device of the second prerequisite technique;

FIG. 24 is a schematic diagram illustrating barrier movement operation of the display device of the second prerequisite technique;

FIG. 25 is a schematic diagram illustrating the barrier movement operation of the display device of the second prerequisite technique;

FIG. 26 is a schematic diagram illustrating the barrier movement operation of the display device of the second prerequisite technique;

FIG. 27 is a schematic diagram illustrating the barrier movement operation of the display device of the second prerequisite technique;

FIG. 28 is a view illustrating examples of the geometrical optics calculation result and the wave optics calculation result of the lateral light distribution characteristic in the parallax barrier type naked-eye stereoscopic display;

FIG. 29 is a view illustrating an example of a normalized lateral light distribution characteristic of the parallax barrier type naked-eye stereoscopic display by wave optics calculation;

FIG. 30 is a view illustrating how a difference between the wave optics calculation and the geometric optics calculation varies depending on a structure size;

FIG. 31 is a view illustrating an example of the wave optics calculation result of the lateral light distribution characteristic in the display device of the second prerequisite technique;

FIG. 32 is a view illustrating an example of the wave optics calculation result of the lateral light distribution characteristic in the display device of the second prerequisite technique;

FIG. 33 is a perspective view illustrating a structure of a display device according to a third prerequisite technique;

FIG. 34 is a view illustrating an example of the wave optics calculation result of the lateral light distribution characteristic in the display device of the third prerequisite technique;

FIG. 35 is a view illustrating an example of the wave optics calculation result of the lateral light distribution characteristic in the display device of the third prerequisite technique;

FIG. 36 is a view illustrating a configuration of a transmission part of a liquid crystal panel in a display device according to a fourth prerequisite technique;

FIG. 37 is a view illustrating the configuration of the transmission part of the liquid crystal panel in the display device of the fourth prerequisite technique;

FIG. 38 is a view schematically illustrating an optical path of light passing through openings of upper and lower barriers of the fourth prerequisite technique;

FIG. 39 is a view illustrating a thickness distribution of a high-refractive index film in the transmission part of the liquid crystal panel of the fourth prerequisite technique;

FIG. 40 is a view illustrating an example of a calculation result of the lateral light distribution characteristic by the wave optics calculation when a distribution of an average refractive index exists in a transmission part of the liquid crystal panel of the fourth prerequisite technique;

FIG. 41 is a view illustrating the configuration of the transmission part of the liquid crystal panel in the display device of the fourth prerequisite technique;

FIG. 42 is a view illustrating the configuration of the transmission part of the liquid crystal panel in the display device of the fourth prerequisite technique;

FIG. 43 is a view illustrating the configuration of the transmission part of the liquid crystal panel in a display device according to a modification of the fourth prerequisite technique;

FIG. 44 is a diagram illustrating a configuration of a transmission part of a liquid crystal panel of a display device in another modification of the fourth prerequisite technique;

FIG. 45 is a perspective view illustrating a configuration of a transmission part of a liquid crystal panel according to a fifth prerequisite technique;

FIG. 46 is a sectional view illustrating the configuration of the transmission part in the liquid crystal panel of the fifth prerequisite technique;

FIG. 47 is a sectional view illustrating the configuration of the transmission part in the liquid crystal panel of the fifth prerequisite technique;

FIG. 48 is a view illustrating an undesirable configuration as the transmission part of the liquid crystal panel;

FIG. 49 is a view illustrating an ITO film thickness distribution that causes a phase difference when the undesirable configuration is adopted as the transmission part of the liquid crystal panel;

FIG. 50 is a view illustrating the configuration of the transmission part in the liquid crystal panel of the fifth prerequisite technique;

FIG. 51 is a view illustrating the configuration of the transmission part in the liquid crystal panel of the fifth prerequisite technique;

FIG. 52 is a perspective view illustrating a structure of a display device according to a sixth prerequisite technique;

FIG. 53 is a sectional view illustrating the structure of the display device of the sixth prerequisite technique;

FIG. 54 is a schematic diagram illustrating the barrier movement operation of the display device of the sixth prerequisite technique;

FIG. 55 is a view illustrating an example of the wave optics calculation result of the lateral light distribution characteristic in the display device of the sixth prerequisite technique;

FIG. 56 is a perspective view illustrating a structure and operation of a display device according to a preferred embodiment;

FIG. 57 is a sectional view illustrating a structure and operation of a parallax barrier in the display device of the preferred embodiment;

FIG. 58 is a sectional view illustrating a difference depending on a voltage applied to a barrier having an optical characteristic in the display device of the preferred embodiment;

FIG. 59 is a sectional view illustrating the difference depending on the voltage applied to the barrier having the optical characteristic in the display device of the preferred embodiment;

FIG. 60 is a sectional view illustrating the difference depending on the voltage applied to the barrier having the optical characteristic in the display device of the preferred embodiment;

FIG. 61 is a sectional view illustrating the difference depending on the voltage applied to the barrier having the optical characteristic in the display device of the preferred embodiment;

FIG. 62 is a graph illustrating a relationship with the voltage applied to the barrier having the optical characteristic in the display device of the preferred embodiment; and

FIG. 63 is a graph illustrating the relationship with the voltage applied to the barrier having the optical characteristic in the display device of the preferred embodiment.

### DESCRIPTION OF THE PREFERRED EMBODIMENTS

Hereinafter, preferred embodiments will be described with reference to the accompanying drawings.

The drawings are schematically illustrated, and omission or simplification of the configuration is appropriately made for convenience. A mutual relationship between a size and a position of the configuration illustrated in the different drawings is not necessarily described accurately, but can appropriately be changed.

In the following description, the same components are denoted by the same reference numeral, and it is assumed that names and functions of the same components are also similar. Thus, the detailed description of the same component is occasionally omitted in order to avoid duplication.

In the following description, even if an ordinal number such as “first” or “second” is used, these terms are used only for convenience sake in order to easily understand contents of the preferred embodiment, and are not limited to the order and the like that can be generated by these ordinal numbers.

<Prediction of Optical Performance by Wave Optics Calculation>

Conventionally, in a naked-eye stereoscopic display or a two-image display device, optical design of a light distribution characteristic has been performed by geometrical optics calculation.

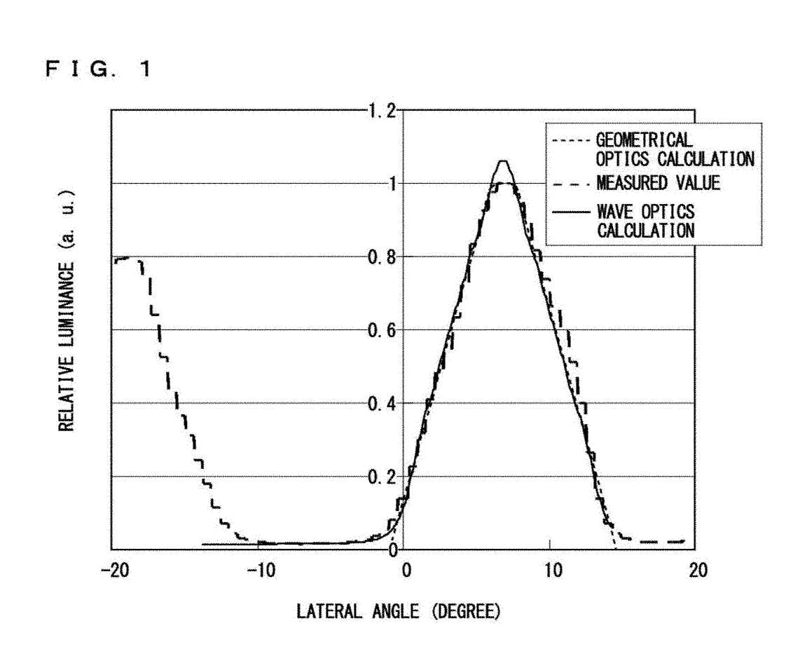

FIG. 1 illustrates a measured value of a lateral light distribution characteristic and a calculation result by the geometrical optics calculation of a naked-eye stereoscopic display device including a liquid crystal shutter panel on a front side (that is, an image viewing side) of a liquid crystal display panel, and illustrates a light distribution of the case that a white image and a black image are displayed on a right-eye image and a left-eye image, respectively.

At this point, a pixel pitch (that is, a disposition interval) of the liquid crystal display panel is 0.096 mm, an opening pitch of the liquid crystal shutter panel is 0.192 mm, and a distance between the opening of the liquid crystal shutter panel and the pixel is 0.62 mm.

A width of a pixel light emitting part of the liquid crystal panel is 0.051 mm, a center of the left eye pixel is located at −0.048 mm on the left side, and the center of the right eye pixel is located at 0.048 mm on the right side. The opening of the liquid crystal shutter panel has a width of 0.062 mm, and the opening is located in the substantial center between the right eye pixel and the left eye pixel of the liquid crystal panel. A member has a refractive index of 1.5.

In FIG. 1, a horizontal axis indicates a lateral angle (degree) and a vertical axis indicates relative luminance (a.u.: arbitrary unit), and the measured value and the geometrical optics calculation result substantially agree with each other. A luminance profile has a triangular shape, and a peak of luminance exists in a direction of 6.5 degrees. The lateral position of the luminance peak at a visual distance of 280 mm is close to a half of an interocular distance of 65 mm, which is a reasonable value.

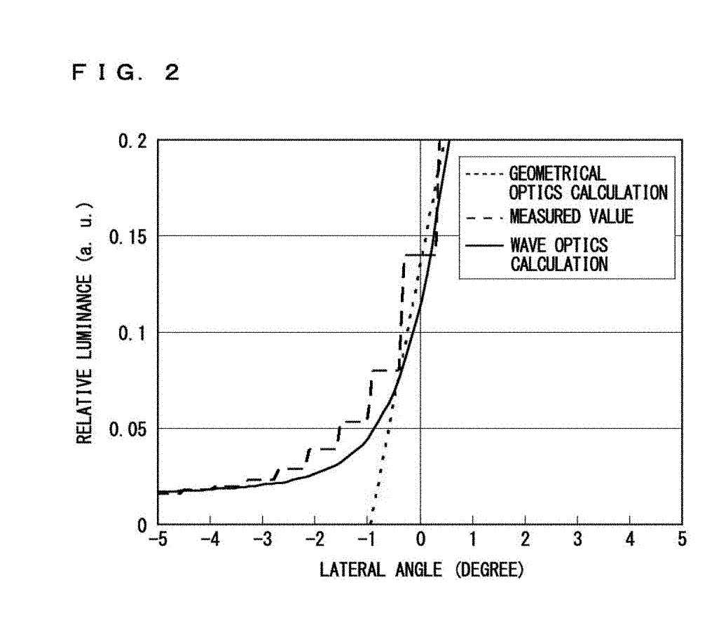

FIG. 2 illustrates a detail of a base of the luminance profile In FIG. 2, the luminance becomes 0 in the direction of −1 degree in the geometric optics calculation. On the other hand, in the measured value, the base expands and leak light exists. It is estimated that this mismatch is caused by an influence of light scattering or diffraction of the member that is not taken into consideration in the geometrical optics calculation. However, how much diffraction is affected is unclear.

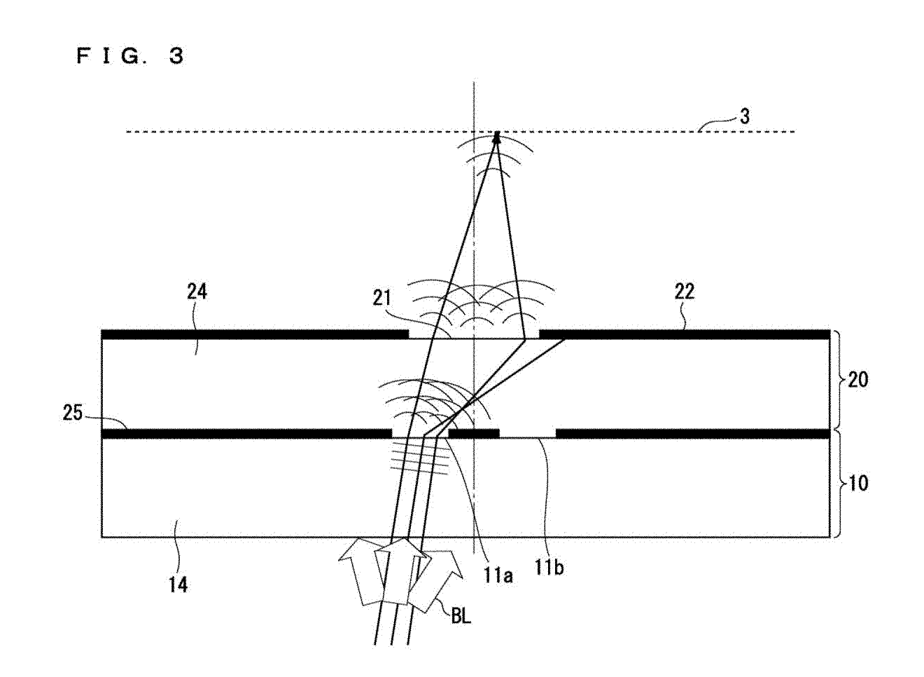

In view of such a situation, a new wave optics calculation model was created in order to investigate the influence of the diffraction on the light distribution characteristic of the display device including the display panel and the parallax barrier panel. FIG. 3 illustrates a basic principle model for calculation.

In FIG. 3, a parallax barrier panel 20 is mounted on a main surface on a front side of a display panel 10, and two openings provided in a display panel light shielding part 25 in the main surface on the front side of the display panel 10 transmits backlight light BL from a backlight (not illustrated) provided on a back side of the display panel 10, thereby constituting a right-direction pixel light emitting part 11a and a left-direction pixel light emitting part 11b. The backlight light BL transmitted through the right-direction pixel light emitting part 11a and the left-direction pixel light emitting part 11b passes through a transparent glass substrate 24 of the parallax barrier panel 20, and is observed on an observation surface 3 through a barrier transmission part 21 provided in the barrier light shielding part 22 in the main surface on the front side of the parallax barrier panel 20.

The newly devised wave optics calculation model follows a Kirchhoff's diffraction theory, and the wave optics calculation model is a two-dimensional model in which a wave spreading into a columnar shape from minute regions of the right-direction pixel light emitting part 11a and the left-direction pixel light emitting part 11b, which are pixels of the display panel 10, generates secondary element waves from minute regions of the barrier transmission part 21 of the parallax barrier panel 20 and the element waves interfere with each other at one point on the observation surface 3. At this point, the wavelength is set to 550 nm.

The calculation result by the wave optics calculation model is illustrated by a solid line in FIG. 1 as the wave optics calculation. As illustrated in FIG. 1, the luminance profile obtained from the wave optics calculation has a triangular shape similar to the measurement value or the geometrical optics calculation result, and a peak angle of the wave optics calculation result also agree with a peak angle of the measurement value or the geometrical optics calculation result.

Also in FIG. 2 illustrating the detail of the base of the luminance profile, in the wave optics calculation result indicated by a solid line, the base expands similarly to the measured value, and it is fund that the influence of the diffraction is reproduced.

As described above, it was found that the geometrical optics calculation is not enough to elucidate a behavior of the leak light in a vicinity of the boundary, and that the wave optics calculation based on the newly devised wave optics calculation model is effective. A preferred embodiment will be described below using this wave optics calculation.

<First Prerequisite Technique>

A first prerequisite technique that is a prerequisite technique of the preferred embodiment (to be described later) will be described below.

<Device Configuration>

FIG. 4 is a schematic perspective view illustrating a display device 100 that is a two-image display that displays different images according to the observation direction of the first prerequisite technique. Although the display panel may be an organic EL panel, a plasma display panel, or a liquid crystal panel, a liquid crystal panel is illustrated below as an example.

As illustrated in FIG. 4, a parallax barrier 12 is disposed on the front side (that is, the image viewing side) of the display panel 10 in which a plurality of pixels are arranged in a matrix form. A backlight 30 is provided on a back side of the display panel 10.

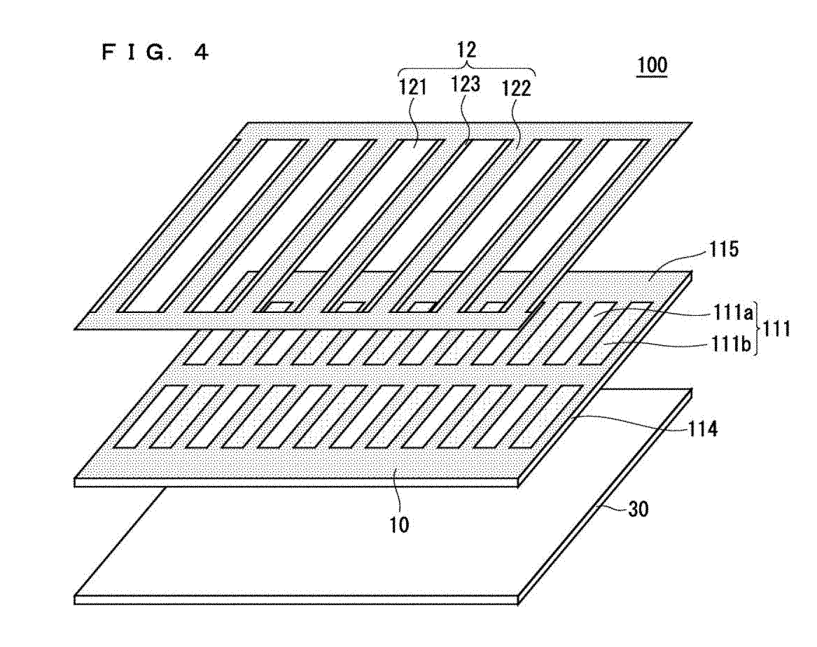

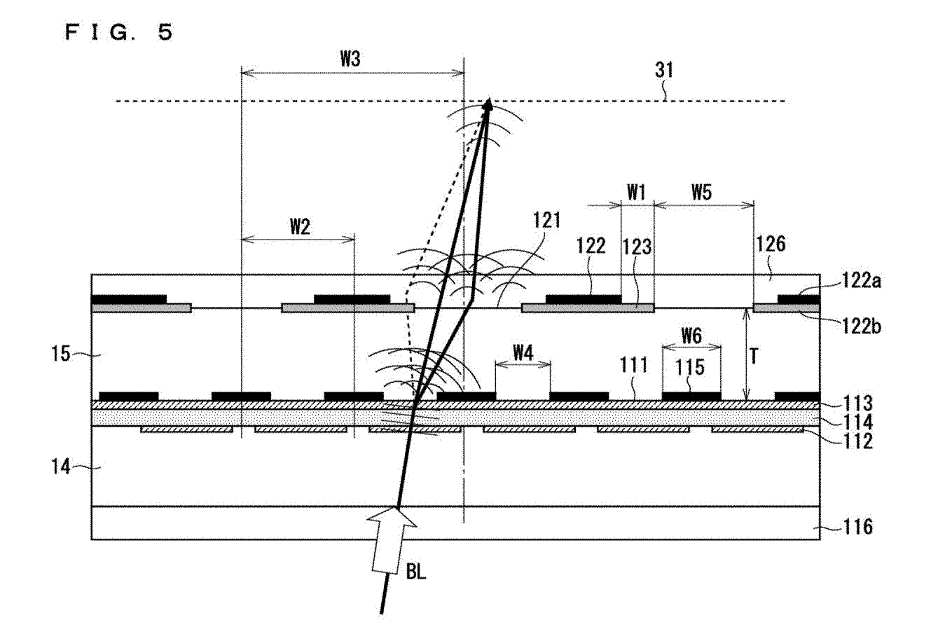

In the parallax barrier 12, a plurality of openings of a barrier light shielding part 122 provided in a main surface on the front side of the display panel 10 constitutes a barrier transmission part 121. Each barrier transmission part 121 has a stripe shape in planar view, and the barrier transmission parts 121 are arrayed such that long sides are parallel to each other. A barrier translucent part 123 is provided along the long side of each barrier transmission part 121. The configuration of the parallax barrier 12 will further be described with reference to FIG. 5.

In the display panel 10, a plurality of openings of a light shielding part 115 provided on a liquid crystal layer 114 constitute pixel light emitting parts 111. Each of the pixel light emitting parts 111 has a stripe shape in planar view, and the pixel light emitting parts 111 are arrayed such that the long sides are parallel to each other. In the he pixel light emitting part 111, a right-direction pixel light emitting part 111a and a left-direction pixel light emitting part 111b are alternately arranged. The configuration of the display panel 10 will be further described with reference to FIG. 5.

FIG. 4 is a schematic diagram illustrating a positional relationship among a backlight 30, the pixel light emitting part 111 of the display panel 10, and the barrier transmission part 121 of the parallax barrier 12 and a position where the barrier translucent part 123 is provided, and is a view in which the transparent electrode or transparent glass substrate that is provided on the display panel 10 is not illustrated. The pixel light emitting part 111 of the display panel 10 and the barrier transmission part 121 of the parallax barrier 12 may be disposed apart from each other with a predetermined distance, and a medium such as air or glass may exist therebetween.

FIG. 5 is a sectional view of the display panel 10 along the arrangement direction of the pixel light emitting parts 111 in FIG. 4. As illustrated in FIG. 5, the display panel 10 is a liquid crystal panel, and includes a liquid crystal layer 114 sandwiched between two transparent glass substrates 14 and 15, a back surface polarizing plate 116 provided on the main surface on the back side (that is, a light source side) of the transparent glass substrate 14, and a front-surface polarizing plate 126 provided on the main surface on the front side of the transparent glass substrate 15.

A transparent electrode 112 divided for each pixel is disposed in the main surface on the back side of the liquid crystal layer 114, a counter transparent electrode 113 provided integrally over the entire surface is disposed on the main surface on the front side of the liquid crystal layer 114, and an electric field is applied to each pixel between the two electrodes.

The opening of the light shielding part 115 provided on the counter transparent electrode 113 forms the pixel light emitting part 111. The light shielding part 115 is provided so as to cover a boundary between the adjacent transparent electrodes 112, and prevents leakage light from a pixel boundary.

The parallax barrier 12 is disposed on the main surface on the front side of the transparent glass substrate 15. In the parallax barrier 12, translucent films 122b having energy transmittance of 4% to 64% are arranged apart from each other, and a light shielding film 122a having energy transmission rate of 0% narrower than that of the translucent film 122b is disposed on the translucent film 122b, whereby the barrier translucent part 123 and the barrier light shielding part 122 are formed and the barrier transmission part 121 is formed between the adjacent translucent films 122b. The front-surface polarizing plate 126 is formed so as to cover the parallax barrier 12.

At this point, the barrier light shielding part 122 of the parallax barrier 12 is provided at a pitch equal to a disposition width of a pair of the right-direction pixel light emitting part 111a and the left-direction pixel light emitting part 111b of the display panel 10.

The barrier translucent part 123 extending on the barrier transmission part 121 has a width W1 of 0.5 μm to 10 μm, amplitude transmittance ranges from 20% to 80%, and the energy transmittance ranges from 4% to 64%.

The barrier translucent part 123 of the parallax barrier 12 differs from the barrier transmission part 121 in the refractive index such that an additional phase difference Δnd of 0 to a half wavelength (that is, λ/2) is generated between the barrier translucent part 123 and the barrier transmission part 121. At this point, the additional phase difference Δnd can be set by a combination of a refractive index difference Δn between the translucent film 122b and a peripheral member and a thickness d of the translucent film.

The barrier translucent part 123 is configured such that the additional phase difference is generated, which allows obtainment of an effect that a luminance gradient in the boundary direction of the left and right two images is steepened. This will further be described in the third prerequisite technique.

<Optimization of Structure by Wave Optics Calculation>

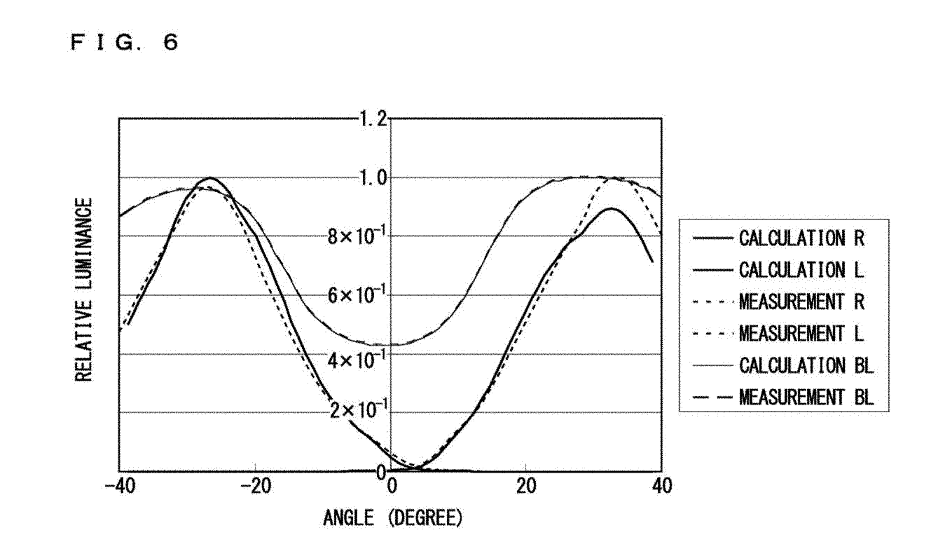

In the display device 100 that is the two-image display, different images are displayed in the left and right directions of 30 degrees, and FIG. 6 illustrates the wave optics calculation result and the measurement value with respect to the light distribution characteristic.

At this point, a pitch W2 between the pixels of the display panel 10 is 0.064 mm, a pitch W3 between the openings of the parallax barrier 12 is 0.128 mm, a distance T between the openings of the parallax barrier 12 and the display panel 10 is 0.09 mm. The distance from the display panel 10 to the observation surface 31 is 50 mm.

the pixel light emitting part 111 of the display panel has a width W4 of 0.032 mm, the center of the left-eye pixel is located at −0.032 mm on the left, the center of the right-eye pixel is located at 0.032 mm on the right, the opening of the parallax barrier 12 has a width W5 of 0.032 mm, and the opening of the parallax barrier 12 is provided substantially above the center of the pair of the right-eye pixel and the left-eye pixel of the display panel 10. The light shielding part 115 has a width W6 of 0.032 mm.

In FIG. 6, the horizontal axis indicates a lateral angle (degree), the vertical axis indicates relative luminance, a calculated value of the light of the right-direction pixel light emitting part obtained by the wave optics calculation is a calculation R, the measured value is a measurement R, a calculated value of the light of the left-direction pixel light emitting part is a calculation L, the measured value is a measurement L, a calculated value of the light distribution characteristic of the backlight 30 used for the wave optics calculation is calculated BL and the calculated value of the light of the left direction pixel light emitting part is a calculation BL, and the measured value is a measurement BL. In the calculation, it is assumed that parallel light according to the actually measured light distribution characteristic of the backlight light BL of the display panel 10 is uniformly incident on the light emitting part of the display panel 10.

As illustrated in FIG. 6, it is found that the actually measured luminance profile and the luminance profile obtained from the wave optics calculation substantially agree with each other.

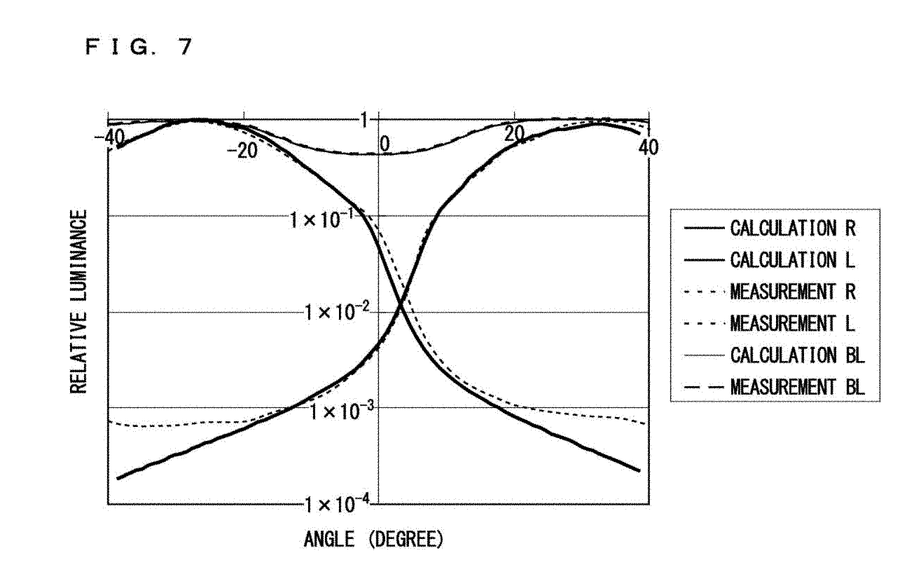

FIG. 7 illustrates a profile of a low-luminance region (specifically, 1×10⁻¹ to 1×10⁻⁴) with the vertical axis as a logarithmic representation. However, even in the low-luminance region, it is found that the actually measured luminance profile and the luminance profiles obtained from the wave optics calculation substantially agree with each other.

The reason why the luminance of the wave optics calculation result is lower than the measurement value in the direction higher than an angle of 30 degrees on the right and left is that the plurality of luminance pixels of the display panel 10 and the plurality of openings of the parallax barrier 12 are arranged in the crosswise direction in the actual device while the wave optics calculation is performed in consideration only of the single light emitting pixel and the opening of the parallax barrier.

Thus, considering that the light passing through the openings of the other parallax barrier is superimposed on the result of the wave optics calculation in the direction higher than the angle of 30 degrees on the right and left, the actually measured value and the result of the wave optics calculation well agree with each other.

As described above, the luminance profile obtained from the wave optics calculation well reproduces the actually measured luminance profile in the boundary region, and the wave optics calculation is effective in analyzing the luminance profile at the boundary and in the low-luminance region.

Generally in the two-image display, the following two characteristics are important. The first is to narrow the boundary region where two images appear in a mixed manner as much as possible, and the second is to eliminate a glare of the image in the other direction even if a dark image is displayed in the image in the observation direction, so that a ratio of the leakage light to peak luminance of the original display image is prevented less than or equal to about 1/1000.

As illustrated in FIG. 7, it is found that the leakage light luminance due to the diffraction of the image in the other direction is about 1/1000 of the peak luminance even in the right and left 30-degree direction near the peak of the display light, and that it is necessary to prevent the diffraction in order to prevent the leakage light luminance.

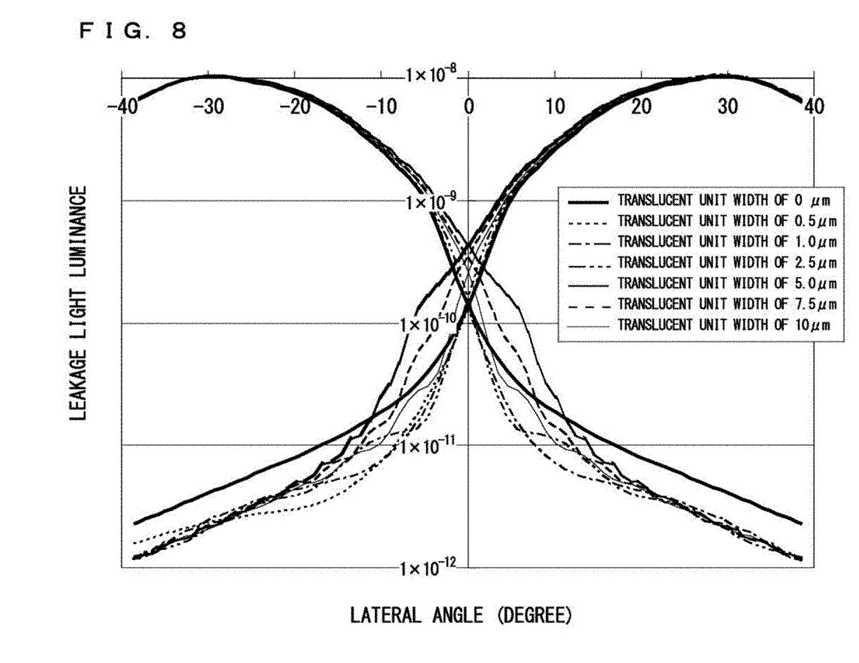

FIG. 8 illustrates calculation results of the light distribution characteristic of the display device 100 that is the two-image display of the first prerequisite technique by the wave optics calculations. FIG. 8 illustrates the luminance profile obtained by the calculation, in which the width of the opening of the parallax barrier 12 is set to 32.2 μm, the barrier translucent parts 123 having the energy transmittance of 16% are provided on the right and left of the barrier transmission part 121, and the width of the barrier translucent part 123 is variously changed.

In FIG. 8, the horizontal axis indicates the lateral angle (degree), the vertical axis indicates the leakage light luminance, and the luminance profile is illustrated in each of the case that the barrier translucent part 123 has the width of 0, the case that the barrier translucent part 123 has the width of 0.5 μm, the case that the barrier translucent part 123 has the width of 1.0 μm, the case that the barrier translucent part 123 has the width of 2.5 μm, the case that the barrier translucent part 123 has the width of 5.0 μm, the case that the barrier translucent part 123 has the width of 7.5 μm, and the case that the barrier translucent part 123 has the width of 10 μm.

As can be seen from FIG. 8, when the width of the barrier translucent part 123 is greater than or equal to 0.5 μm, leakage light intensity in the left and right 30-degree direction decreases by a half as compared with the case that the barrier translucent part 123 indicated by the solid line is not provided.

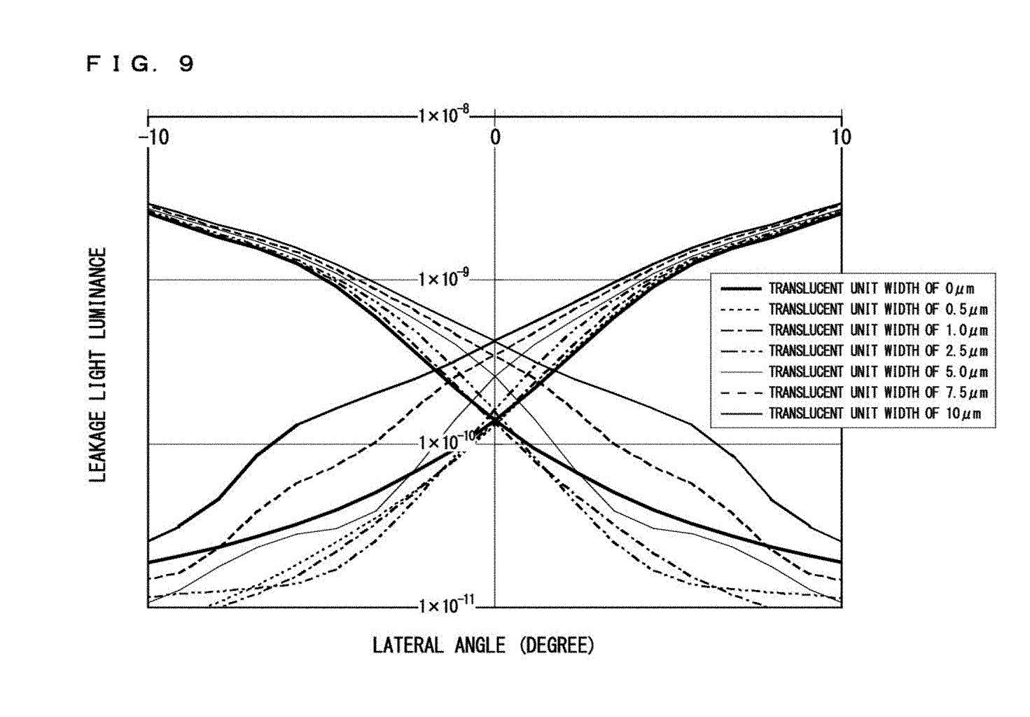

FIG. 9 is an enlarged view of the boundary of the right and the left. In FIG. 9, as the barrier translucent part 123 is widened, a luminance gradient at the boundary of the right and the left becomes steeper, and becomes the maximum at a width of 5 μm. As the width of the barrier translucent part 123 is further increased, the maximum luminance gradient is gradually decreased, and at the same time the angle at which the maximum luminance gradient is generated is shifted in the display direction of the other image and the luminance gradient in the front direction is decreased.

For this reason, in order to increase the luminance gradient in the front direction when the barrier translucent part 123 is wider than 5 μm, it is necessary to reduce the width of the barrier transmission part 121 to the width of the barrier translucent part 123.

FIG. 10 illustrates the calculation result of the luminance profile obtained by the wave optics calculation, in which the width of the barrier translucent part 123 is fixed to 5 μm and the energy transmittance is variously changed.

In FIG. 10, the horizontal axis indicates the lateral angle (degree), the vertical axis indicates the leakage light luminance, and the luminance profile is illustrated in each of the case that the barrier translucent part 123 has the energy translucency of 0, the case that the barrier translucent part 123 has the energy translucency of 0.04 (that is, 4%), the case that the barrier translucent part 123 has the energy translucency of 0.16 (that is, 16%), the case that the barrier translucent part 123 has the energy translucency of 0.36 (that is, 36%), and the case that the barrier translucent part 123 has the energy transmittance of 0.64 (that is, 64%).

As can be seen from FIG. 10, the leakage light luminance in the right and left 30-degrees direction is minimized in the vicinity between the energy transmittances of 16% and 36%, and the maximum luminance gradient in the boundary direction is the steepest in the vicinity of the energy transmittance of 16%.

As described above, in the display device 100 that is the two-image display of the first prerequisite technique, the barrier translucent part 123 is provided in the parallax barrier 12, and the barrier translucent part 123 has the width of 0.5 μm or more and the energy transmittance of 4% to 64%, so that the leakage light luminance in the right and left 30-degree direction can be prevented and the luminance gradient in the boundary direction between the right and left images can be steepened.

Consequently, the boundary region where the double image is generated due to the luminance change or the 3D crosstalk can be narrowed, and the good image in which the double image due to the luminance change or the 3D crosstalk is not generated can visually recognized in a wide range even if the observer's observation position moves to the right or the left. It is most preferable that the barrier translucent part 123 has the width of 2.5 μm to 5 μm and the energy transmittance of 16% to 36%.

<First Barrier Translucent Part Manufacturing Method>

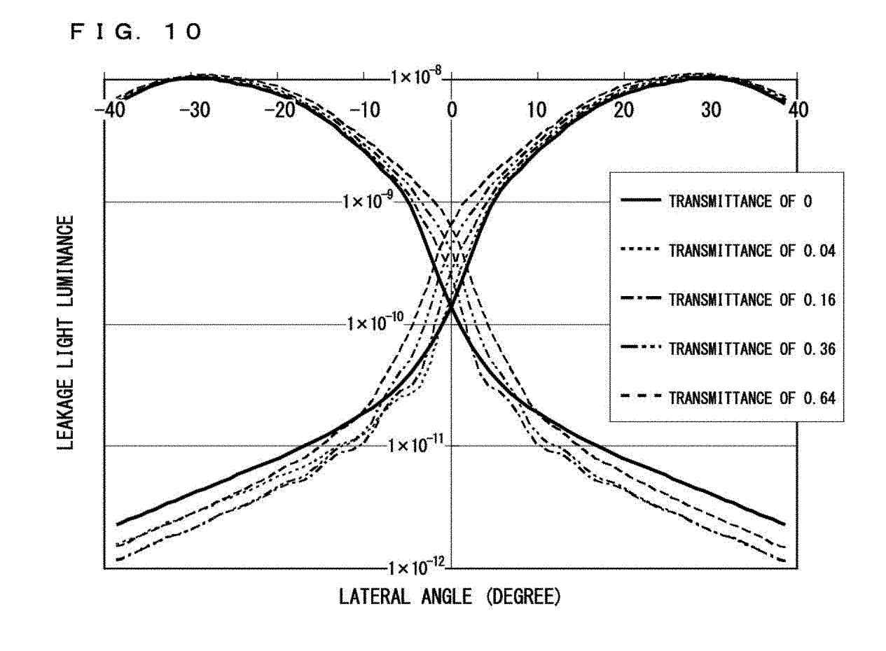

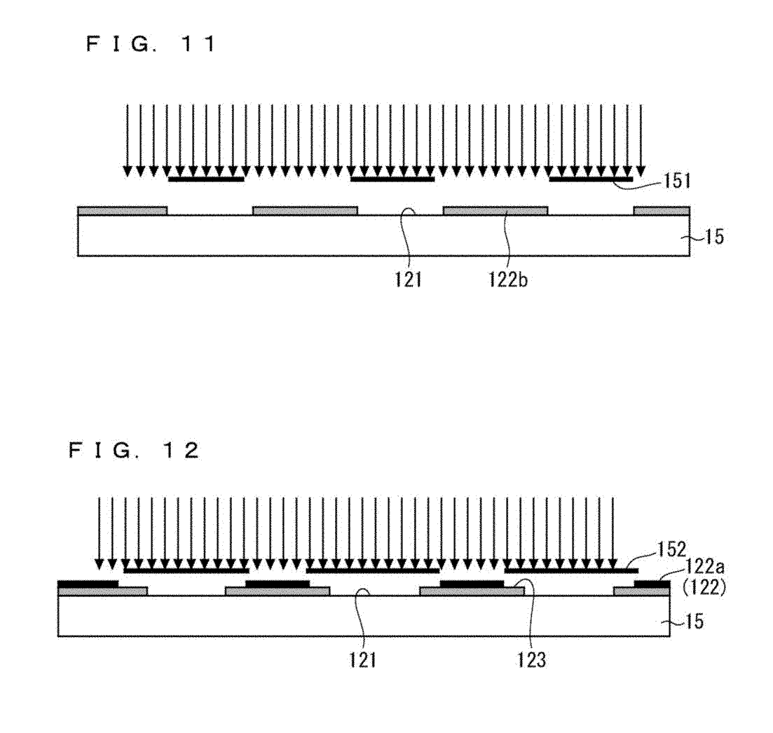

A barrier translucent part manufacturing method will be described below with reference to FIGS. 11 and 12. As illustrated in FIG. 11, a sputtering mask 151 is disposed above the main surface of the transparent glass substrate 15. Chromium oxide or graphite that is a material for the barrier translucent part 123 is deposited from above the sputtering mask 151 onto the main surface of the transparent glass substrate 15 by sputtering, thereby forming the translucent film 122b. The translucent film 122b has the energy transmittance of 4% to 64%. The energy transmittance is controlled by controlling the film thickness of the translucent film 122b.

At this point, the sputtering mask 151 has a pattern in which a portion constituting the barrier transmission part 121 of the transparent glass substrate 15 is masked while a portion where the translucent film 122b is formed constitutes an opening.

Subsequently, after the sputtering mask 151 is removed, a sputtering mask 152 is formed above the main surface of the transparent glass substrate 15 as illustrated in FIG. 12. Then, from the upper side of the sputtering mask 152, chromium oxide that is a material for the barrier light shielding part 122 is deposited from above the sputtering mask 152 onto the translucent film 122b by sputtering, thereby forming the light shielding film 122a having the energy transmittance of 0%. The sputtering mask 152 has a pattern in which only the portion where the light shielding film 122a is formed constitutes the opening while other portions are masked.

Through the above processes, the barrier translucent part 123 and the barrier light shielding part 122 are formed, and the space between the adjacent barrier translucent parts 123 constitutes the barrier transmission part 121. The mask sputtering method is described as an example of the method for depositing the light shielding film 122a and the translucent film 122b. However, the deposition method is not limited to the mask sputtering method, but the light shielding film 122a and the translucent film 122b may be formed by a pad printing method or the like.

<Second Barrier Translucent Part Manufacturing Method>

In the barrier translucent part manufacturing method in FIGS. 11 and 12, two sputtering masks are used to form the barrier translucent part 123. In this case, accuracy is required for alignment of the sputtering mask.

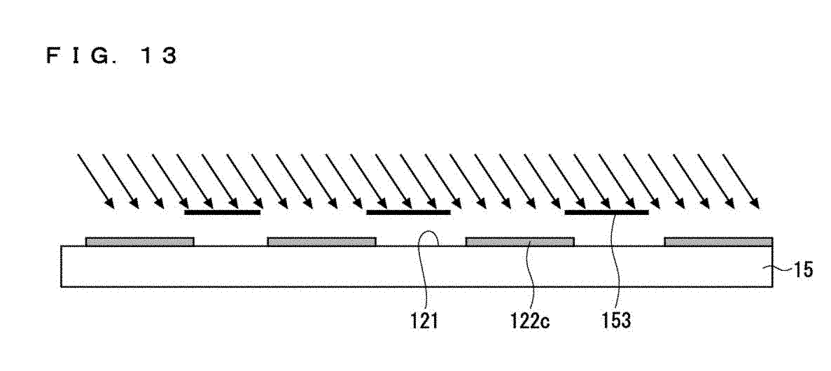

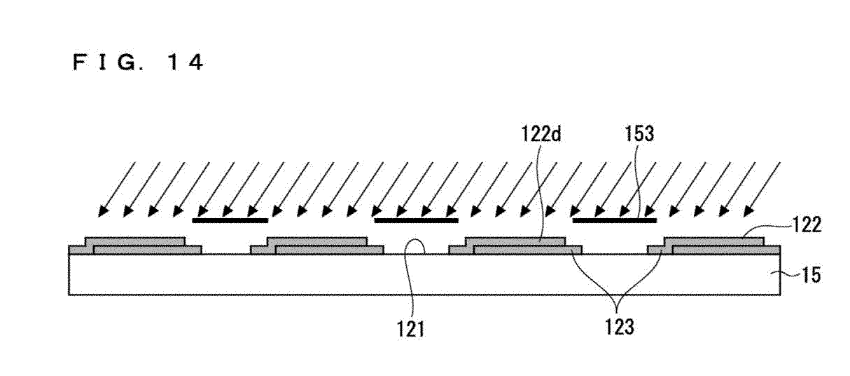

For this reason, as another example of the barrier translucent part manufacturing method, a method for forming the barrier translucent part 123 with one sputtering mask will be described with reference to FIGS. 13 and 14.

As illustrated in FIG. 13, a sputtering mask 153 is formed on the main surface of the transparent glass substrate 15. Chromium oxide that is the material for the barrier translucent part 123 is deposited from obliquely above the sputtering mask 153 onto the main surface of the transparent glass substrate 15 by sputtering, thereby forming a translucent film 122c. The translucent film 122c has the energy transmittance of 4% to 64%. The energy transmittance is controlled by controlling the film thickness of the translucent film 122c.

In this case, the translucent film 122c extends below an edge of the sputtering mask 153 in a flight direction of the sputtering material. On the other hand, the translucent film 122c does not extend below an end edge of the sputtering mask 153 in the direction opposite to the flight direction of the sputtering material.

As illustrated in FIG. 14, chromium oxide that is the material for the barrier translucent part 123 is deposited from the obliquely upper side opposite to the sputtering mask 153 onto the main surface of the transparent glass substrate 15 by sputtering, thereby forming a translucent film 122d. The translucent film 122d has the energy transmittance of 4% to 64% identical to that of the translucent film 122c. The energy transmittance is controlled by controlling the film thickness of the translucent film 122d.

In this case, the translucent film 122d is formed on the translucent film 122c, and extends below the end edge of the sputtering mask 153 in the flight direction of the sputtering material. On the other hand, the translucent film 122d does not extend below the end edge of the sputtering mask 153 in a direction opposite to the flight direction of the sputtering material.

This allows the formation of a structure having a central portion where the translucent film 122c and the translucent film 122d overlap each other and an end edge portion where only the translucent film 122c or the translucent film 122d is formed. In this structure, the central portion constitutes the barrier light shielding part 122, and the edge portion constitutes the barrier translucent part 123.

In this way, the barrier light shielding part 122 and the barrier translucent part 123 can be formed using one sputtering mask by two-time sputtering from the oblique direction in which the angle is changed.

In this case, because the sputtering mask 153 is commonly used, the problem of the alignment accuracy can be solved, and the number of mask types can be decreased to reduce manufacturing cost.

However, because the barrier translucent part 123 has a film thickness of only a half of the film thickness of the barrier light shielding part 122, the transmittance of the barrier light shielding part 122 is only the square of the barrier translucent part 123. For example, in the case that the barrier translucent part 123 has the transmittance of 0.1 (that is, 10%), the barrier light shielding part 122 has the transmittance of 0.01 (that is, 1%).

<Third Barrier Translucent Part Manufacturing Method>

The above barrier translucent part manufacturing method is a method for manufacturing the configuration in which the barrier translucent part 123 is provided along the long side of the stripe-shaped barrier transmission part 121, and the barrier translucent part 123 has also the stripe shape.

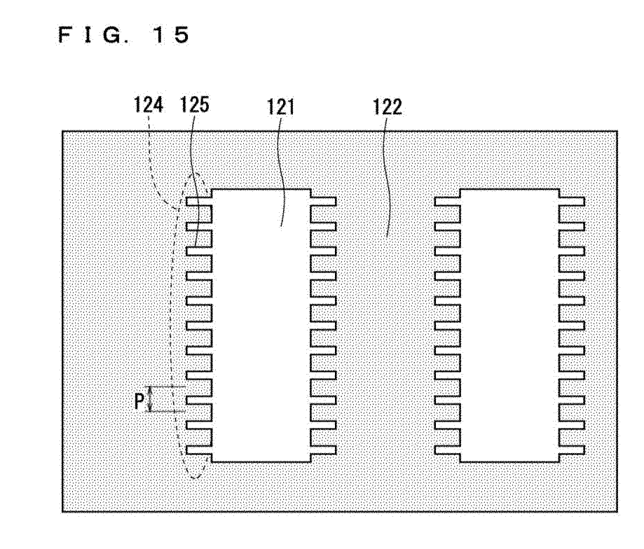

A barrier translucent part 124 in which fine openings and barrier light shielding parts 122 are alternately disposed may be adopted as illustrated in FIG. 15.

In FIG. 15, in the light shielding film forming the barrier light shielding part 122, in the case that disposition direction of the barrier transmission part 121 is set to the lateral direction, the plurality of fine openings 125 arranged in the vertical direction orthogonal to the lateral direction are formed along the two long sides of the barrier transmission part 121. Consequently, the barrier translucent part 124, in which a structure in which the fine opening 125 becomes a recess while the barrier light shielding part 122 becomes a protrusion is alternately repeated, is obtained.

At this point, when a reference parallax barrier pitch P of the fine opening 125 is sufficiently small, the effective energy transmittance of the translucent part can be adjusted to an average value of a light blocking area and an opening area.

The necessary reference parallax barrier pitch P will be described with reference to FIG. 16. As illustrated in the example in FIG. 16, when a model in which light emitted from a pixel point G of the display panel 10 travels in a Z-axis direction (that is, in the vertical direction) to reach a point B of the parallax barrier 12 is considered, an optical path difference dL in the case that the light reaches a point B′ shifted by the reference parallax barrier pitch P in an X-axis direction orthogonal to the vertical direction is approximately given by the following Formula (1). Where T is the distance between the pixel point G of the display panel 10 and the parallax barrier 12 and n is a refractive index of the optical path.

dL=4×P×P/T (1)

At this point, in order to regard the barrier translucent part 124 as the region having the uniform transmittance, it is necessary that a phase difference be small, namely, the optical path difference dL be sufficiently smaller than a wavelength of light (for example, about 1/10). In order to satisfy this condition, it is necessary to satisfy the following Formula (2).

P<2×(wavelength/refractive index/10×T)^{0.5} (2)

In the above formula, for example, assuming that the wavelength is 550 nm (that is, 0.55 μm) and substituting T=80 μm and n=1.5, the following Formula (3) is given.

P<2×(0.55/1.5/10×80)^{0.5}=3.4 μm (3)

That is, when the reference parallax barrier pitch P of the fine opening 125 is less than or equal to 2 μm, the barrier translucent part 124 effectively functions as the translucent part having the uniform transmittance. Similarly, in the case that a distance T between the pixel point G of the display panel 10 and the parallax barrier 12 is as thick as 720 μm, the barrier translucent part 124 effectively functions as the translucent part having the uniform transmittance when the reference parallax barrier pitch P of the fine opening 125 is less than or equal to 10 μm.

When the barrier translucent part 124 effectively functions as the translucent part having the uniform transmittance, it is not necessary to form the translucent film on the transparent glass substrate 15 but it is only necessary to form the barrier light shielding part 122, so that the high accuracy is not required for the thickness of the translucent film or the alignment of the mask, and the manufacturing process can be simplified.

The reference parallax barrier pitch P of the fine opening 125 may satisfy above Formulas (1), (2), and (3), and need not be uniform, but may be random. The opening may have an isolated polka-dot shape.

### Example in Second Prerequisite Technique

A second prerequisite technique that is the prerequisite technique of the preferred embodiment (to be described later) will be described below,

<Device Configuration>

FIG. 17 illustrates a sectional configuration of a display device 200 that is an naked-eye stereoscopic display according to the second basic technology. As illustrated in FIG. 17, the display device 200 includes a display panel 210, a parallax barrier shutter panel 220 disposed on the front side (that is, the image viewing side) of the display panel 210, and a backlight 23 disposed on the rear surface side (that is, the light source side) of the display panel 210.

The display panel 210 is a matrix type display panel. Although the display panel 210 may be an organic EL panel, a plasma display panel, or a liquid crystal panel, the liquid crystal panel is illustrated below as an example.

As illustrated in FIG. 17, the display panel 210 is a liquid crystal panel, and includes a liquid crystal layer 214 sandwiched between two transparent glass substrates 204 and 205, a back surface polarizing plate 216 provided on the main surface on the back side (that is, the light source side) of the transparent glass substrate 204, and an intermediate polarizing plate 217 provided on the main surface on the front side of the transparent glass substrate 205.

A counter transparent electrode 215 provided integrally over the entire surface is disposed on the main surface on the back side of the liquid crystal layer 214, a sub-pixel transparent electrode 212 divided for each pixel is disposed in the main surface on the front side of the liquid crystal layer 214, and the electric field is applied to each pixel between the two electrodes.

The sub-pixel transparent electrode 212 is divided by a light shielding part 218, and a color filter 219 is provided on the sub-pixel transparent electrode 212, and also divided by the light shielding part 218.

A sub-pixel 2110, a sub-pixel 2111, a sub-pixel 2112, a sub-pixel 2113, and a sub-pixel 2114 are formed in the crosswise direction (that is, in the horizontal direction) according to the sub-pixel transparent electrode 212 divided by the light shielding part 218. A sub-pixel pair 241 that displays different parallax images in the right direction and the left direction is constructed by combining, for example, two adjacent sub-pixels of the sub-pixel 2111 and the sub-pixel 2112. A subpixel pair 242 that displays different parallax images in the right direction and the left direction is constructed by combining two adjacent sub-pixels of the sub-pixel 2113 and the sub-pixel 2114.

A parallax barrier shutter panel 220 includes a liquid crystal layer 224 sandwiched between a transparent glass substrate 222 (first transparent substrate) and a transparent glass substrate 226 (second transparent substrate) and a display surface polarizing plate 228 provided on the main surface on the front side of the transparent glass substrate 222. A polarizing plate is also provided on the main surface of the transparent glass substrate 226 on the side of the display panel 210. However, in this case, the intermediate polarizing plate 217 is also used as the polarizing plate.

The mode of the liquid crystal layer 224 may be twisted nematic (TN), super twisted nematic (STN), inplane switching (IPS), optically compensated bend (OCB), or the like.

A transparent electrode 225 (second transparent electrode) provided integrally over the entire surface is disposed on the main surface on the back side of the liquid crystal layer 224, and a transparent electrode 223 is disposed on the main surface on the front side of the liquid crystal layer 214.

The reference parallax barrier pitch is defined with a length corresponding to the disposition width of each sub-pixel pair, and the transparent electrode 223 is divided into a plurality of electrically insulated pieces within the reference parallax barrier pitch. Although FIG. 17 illustrates an example in which the transparent electrode 223 is divide into eight pieces, it is not limited thereto, and the number of divisions may further be increased. Each of the divided transparent electrodes 223 constitutes a sub-opening 301, and the width of the sub-opening 301 becomes a sub-opening pitch.

At this point, the reference parallax barrier pitch is set such that a virtual light LO, which emerges from the center of the light shielding part 218 located between the sub-pixel 2111 and the sub-pixel 2112 constituting the sub-pixel pair 241 and passes through a central point within the corresponding reference parallax barrier pitch, is concentrated at a design viewing point Q set in front of the display device.

In the parallax barrier shutter panel 220 having the above configuration, the plurality of sub-openings 301 are alternately switched between a light transmission state and a light shielding state by applying the electric field to the liquid crystal layer 224 using the transparent electrode 223 and the transparent electrode 225.

An example of an operating state of the parallax barrier shutter panel 220 will be described with reference to FIG. 18. FIG. 18 schematically illustrates the display device 200 that is the naked-eye stereoscopic display in FIG. 17.

In FIG. 18, the electric field is applied to the liquid crystal layer 224 using each transparent electrode 223 such that four of the eight sub-openings 301 within the reference parallax barrier pitch are set to the transmission state to form a transmission part 321, such that two sub-openings 301 on both sides of transmission part 321 are set to a translucent state to form a translucent part 323, and such that the remaining two sub-openings 301 are set to the light shielding state to form a light shielding part 322, thereby controlling the liquid crystal.

The light emitting part in the liquid crystal layer 214 of the display panel 210 is illustrated as a pixel light emitting part 211. Light shielding parts (not illustrated) are disposed apart from each other on the liquid crystal layer 214, and the light is not emitted from the light shielding part, so that the pixel light emitting parts 211 exist while being skipped.

In addition to birefringence due to the alignment state of the liquid crystal layer of the translucent part 323, when a change Δn in the refractive index and a thickness d of the liquid crystal layer are properly selected, the transmittance of the translucent part 323 is lowered, and a phase difference of And (that is, an additional phase difference) can be generated as the phase difference with the light passing through the transmission part 321.

An example of an operation pattern of the sub-opening 301 of the parallax barrier shutter panel 220 will be described below with reference to FIGS. 19 to 27.

In FIGS. 19 to 27, the arrangement of twelve sub-openings 301 is illustrated as a part of the plurality of sub-openings 301, reference numerals 1 to 8 are given in order from the left side in the drawing, and the reference numerals are repeated from the sub-opening 301 on the right side of the eighth sub-opening 301.

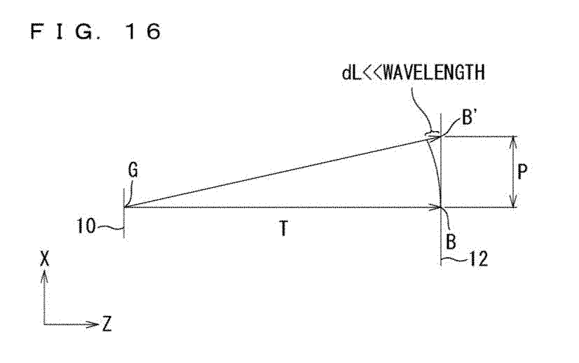

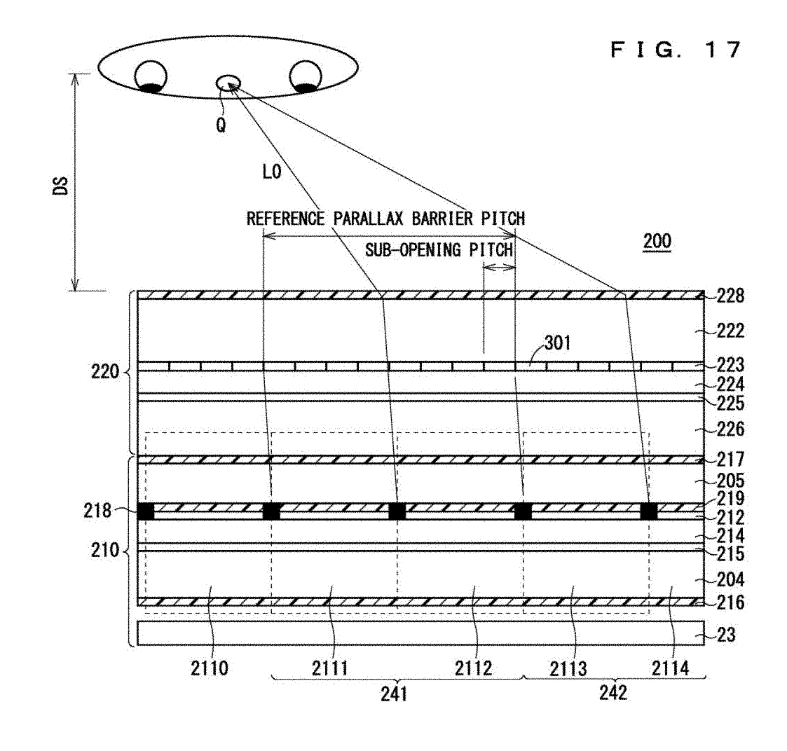

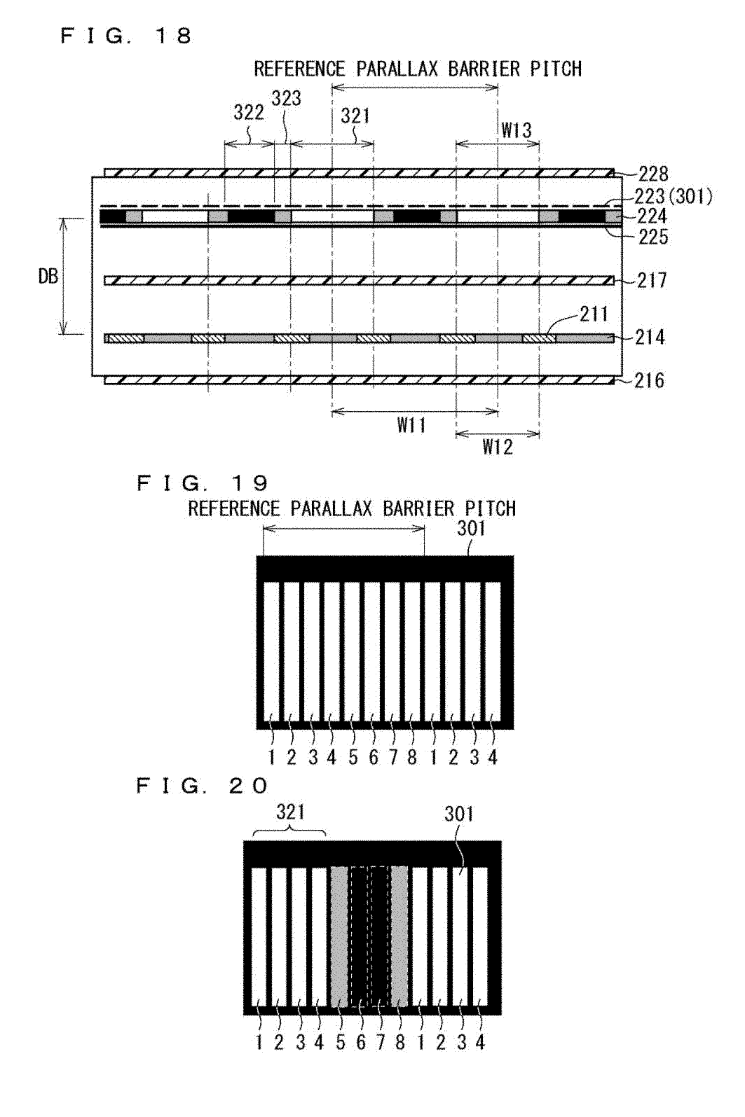

FIG. 19 illustrates a pattern in which all the sub-openings 301 are in the transmission state. In FIG. 20, as a pattern 1, four consecutive sub-openings 1 to 4 out of the eight sub-openings 301 within the reference parallax barrier pitch are set to the light transmission state, the sub-openings 5 and 8 are set to the translucent state, and the sub-openings 6 and 7 are set to the light shielding state, thereby forming a pattern having transmission parts 321 on the right and left.

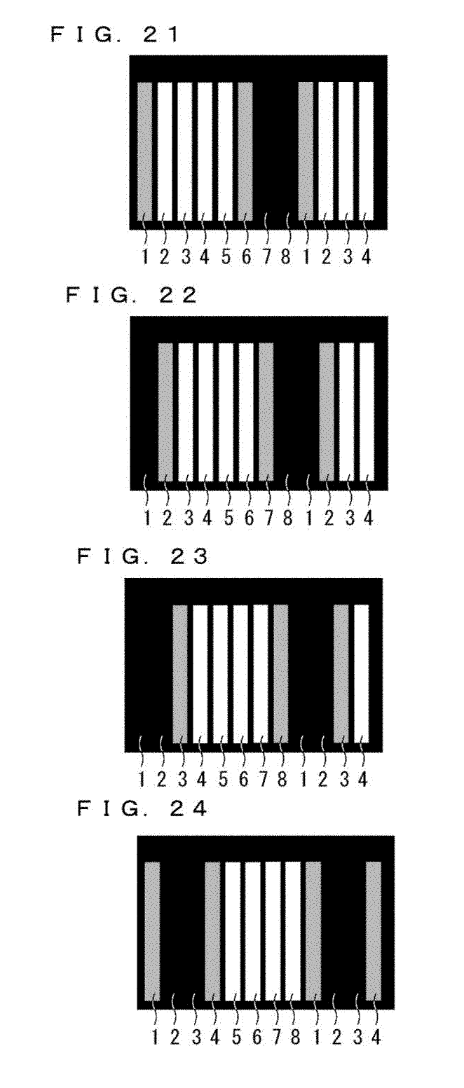

FIG. 21 illustrates a pattern in which the sub-openings 7 and 8 are to the light shielding state, the sub-openings 1 and 6 are set to the translucent state, and the remaining sub-openings are set to the transmission state as a pattern 2.

FIG. 22 illustrates a pattern in which the sub-openings 8 and 1 are set to the light shielding state, the sub-openings 7 and 2 are set to the translucent state, and the remaining sub-openings are to the transmission state as a pattern 3.

FIG. 23 illustrates a pattern in which the sub-openings 1 and 2 are set to the light shielding state, the sub-openings 8 and 3 are set to the translucent state, and the remaining sub-openings are set to the transmission state as a pattern 4.

FIG. 24 illustrates a pattern in which the sub-openings 2 and 3 are set to the light shielding state, the sub-openings 1 and 4 are set to the translucent state, and the remaining sub-openings are set to the transmitting state as a pattern 5.

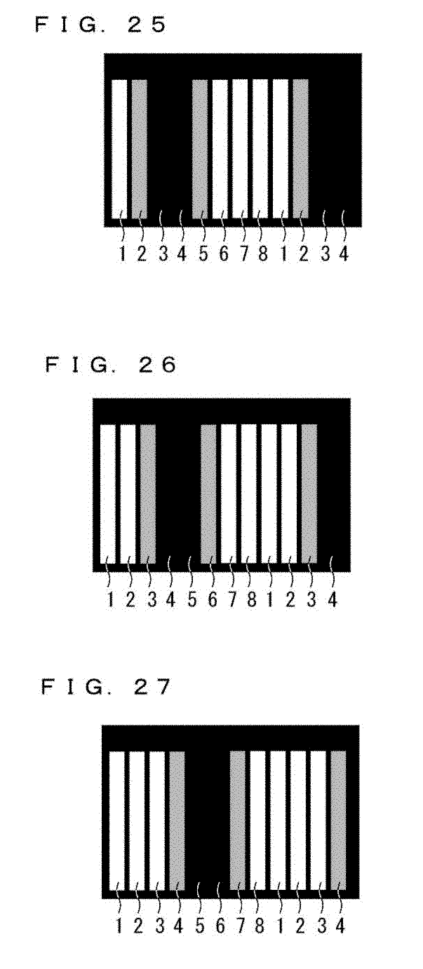

FIG. 25 illustrates a pattern in which the sub-openings 3 and 4 are set to the light shielding state, the sub-openings 5 and 2 are set to the translucent state, and the remaining sub-openings are set to the transmission state as a pattern 6.

FIG. 26 illustrates a pattern in which the sub-openings 4 and 5 are set to the light shielding state, the sub-openings 6 and 3 are set to the translucent state, and the remaining sub-openings are set to the transmission state as a pattern 7.

FIG. 27 illustrates a pattern in which the sub-openings 5 and 6 are set to the light shielding state, the sub-openings 4 and 7 are set to the translucent state, and the remaining sub-openings are set to the transmission state as a pattern 8.

As in the patterns 2 to 8, the position of the transmission part 321 can be moved at the pitch of the sub-opening 301 by selecting the sub-opening 301 to be set to the light transmission state and the translucent state.

<Light Distribution Characteristic in Typical Naked-Eye Stereoscopic Display>

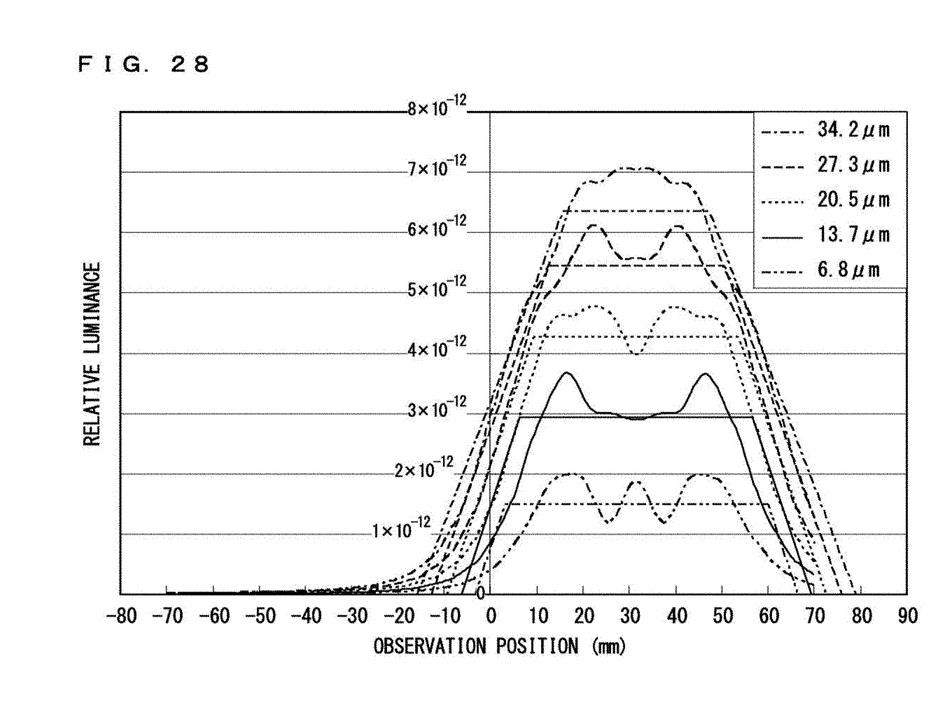

FIG. 28 illustrates the geometrical optics calculation result and the wave optics calculation result for the light distribution characteristic in the case of displaying the white image and the black image in the right-eye image and the left-eye image, respectively, in a typical naked-eye stereoscopic display using the parallax barrier.

At this point, the pixel pitch of the liquid crystal panel is 0.069 mm, the pitch of the opening of the liquid crystal shutter panel is 0.138 mm, and the distance between opening of the liquid crystal shutter panel and the pixels is 1.224 mm.

The center of the left-eye pixel of the liquid crystal panel is located at −0.034 mm on the left, the center of the right-eye pixel is located at 0.034 mm on the right, the liquid crystal shutter panel has the opening width of 0.069 mm, and the opening is located above the substantial center of the pair of the right-eye pixel and the left-eye pixel of the liquid crystal panel.

FIG. 28 illustrates the calculation result of the light distribution characteristic by changing the opening width of the pixel of the display panel, the transparent glass member has the refractive index of 1.5, and the wavelength is set to 550 nm in the wave optics calculation. The calculation result is a relative luminance distribution on the screen located at a position separated from the liquid crystal shutter panel by a design observation distance of 750 mm. In FIG. 28, the geometrical optics calculation result appears as a straight line, and the wave optics calculation result appears as a curve.

In FIG. 28, the horizontal axis indicates the observation position [mm] on the screen, the vertical axis indicates the relative luminance, and the geometrical optics calculation result and the wave optics calculation result are illustrated in each of the case that the display panel has the pixel opening width of 34.2 μm, the case that the display panel has the pixel opening width of 27.3 μm, that case that the display panel has the pixel opening width of 20.5 μm, the case that the display panel has the pixel opening width of 13.7 μm, and the case that the display panel has the pixel opening width of 6.8 μm.

In FIG. 28, in the geometrical optics calculation result, as the pixel opening width of the display panel is decreased, the luminance peak is decreased, the flat portion of the luminance is widened, and it is expected that the viewing region having the uniform luminance will expand. The region where the light leaks to the other-direction image display region on the left side of the boundary is narrowed, and the boundary region is expected to be reduced.

However, the wave optics calculation result is different from this. Although the luminance peak is decreased as the pixel opening width of the display panel is decreased, a large distribution is generated because a plurality of peaks appear, and the width of the luminance peak region is also narrower than that of the geometrical optics calculation result.

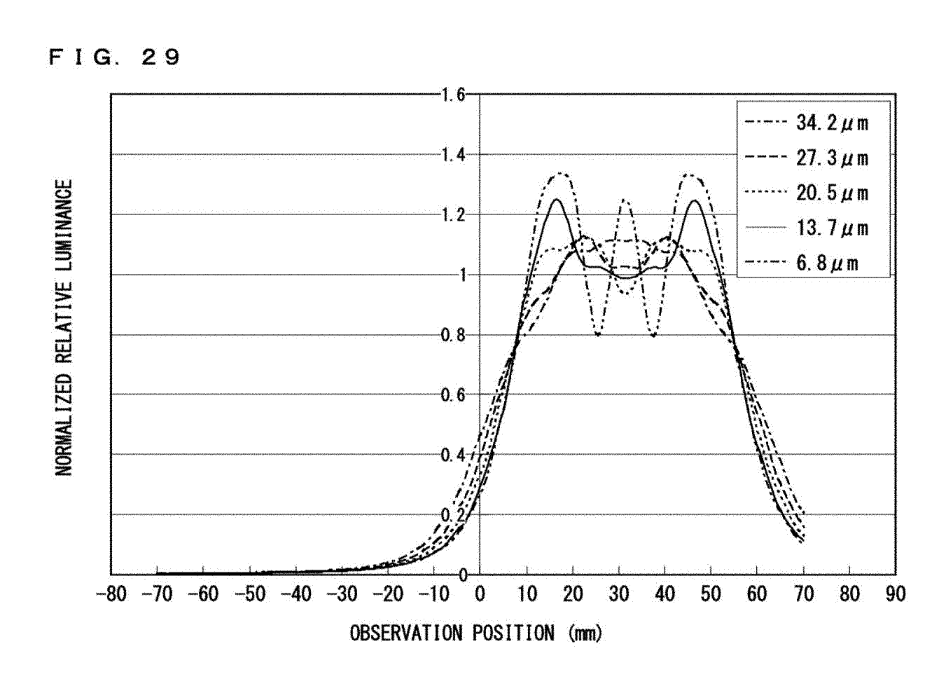

FIG. 29 illustrates a profile in which the luminance profile in FIG. 28 is normalized using the peak luminance, and the vertical axis indicates normalized relative luminance.

As can be seen from FIG. 29, the range where the light leaks to the other-direction image display region on the left side of the boundary is not so different from the range expected from the geometric optics calculation even if the pixel opening width is narrowed to 6.8 μm.

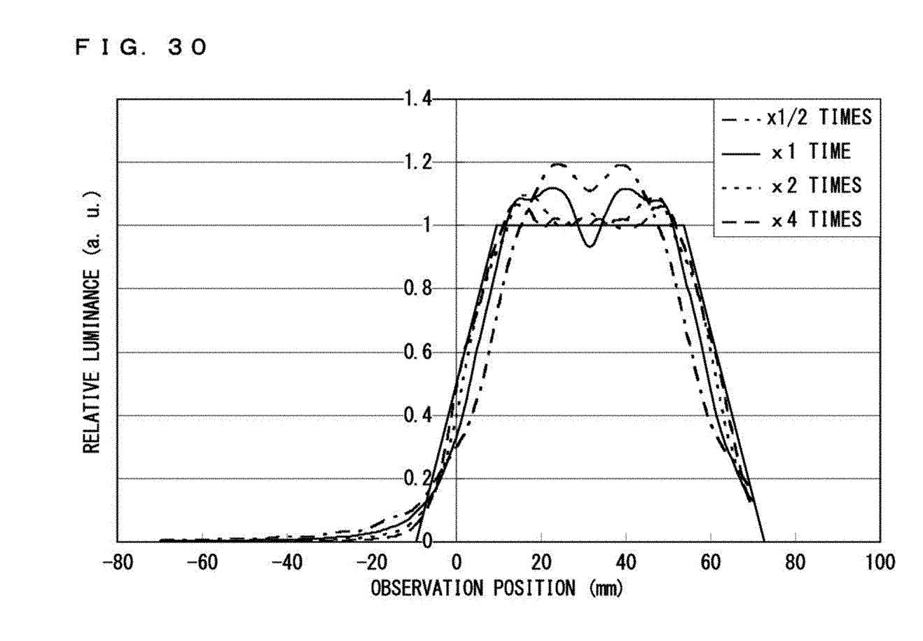

FIG. 30 illustrates how a difference between the wave optics calculation and the geometric optics calculation varies depending on a structure size As illustrated in FIG. 28, the liquid crystal panel has the pixel pitch of 0.069 mm, the liquid crystal shutter panel has the opening pitch of 0.138 mm, the distance between the opening of the liquid crystal shutter panel and the pixel is 1.224 mm, the center of the left-eye pixel of the liquid crystal panel is located at −0.034 mm on the left, the center of the right-eye pixel is located at 0.034 mm on the right, the liquid crystal shutter panel has the opening width of 0.069 mm, the pixel is located above the substantial center of the pair of the right-eye pixel and the left-eye pixel of the liquid crystal panel, and the case that the display panel has the pixel opening width of 34.2 μm is assumed to be a reference structure. FIG. 30 illustrates calculation results when the reference structure is similarly changed to ½, 2, or 4 times.

In FIG. 30, the transparent glass member has the refractive index of 1.5, and the wavelength of light is set to 550 nm. The calculation result is the relative luminance distribution (a.u.) on the screen located at a position away from the liquid crystal shutter panel by the design observation distance of 750 mm. In FIG. 28, the geometrical optics calculation result appears as a straight line, and the wave optics calculation result appears as a curve.

As can be seen from FIG. 30, the wave optics calculation result is not so different from the geometrical optics calculation result indicated by the solid straight line in the luminance at the point of 0 mm or flatness of the peak in the structure similarly enlarged by 4 times, and a difference between the wave optics calculation result and the geometrical optics calculation result becomes larger as the size is similarly reduced. In the structure similarly enlarged by 2 times, in the wave optics calculation result, a variation of the peak luminance exceeds 10%, the luminance at the point of −10 mm where the luminance becomes 0 in the geometrical optics calculation exceeds 10% of the peak. Thus, in a structure similarly enlarged by 4 times, there is no difference from geometrical optics calculation, and a merit using wave optics calculation is eliminated. In other words, in the case that the similar size is less than 4 times, it can be said that there is the merit of using the wave optics calculation.

As to the specific size, in consideration of 0.138 mm that is double the opening width of 0.069 mm of the liquid crystal shutter panel located behind the optical path, which has a more influence from a principle of the wave optics, in the case that the opening width closer to the viewer is less than 0.138 mm, the adjustment of the luminance profile using the wave optics calculation is effectively performed.

In view of the above, a method for adjusting the luminance profile in consideration of the diffraction will be described below.

<Light Distribution Characteristic in Naked-Eye Stereoscopic Display>

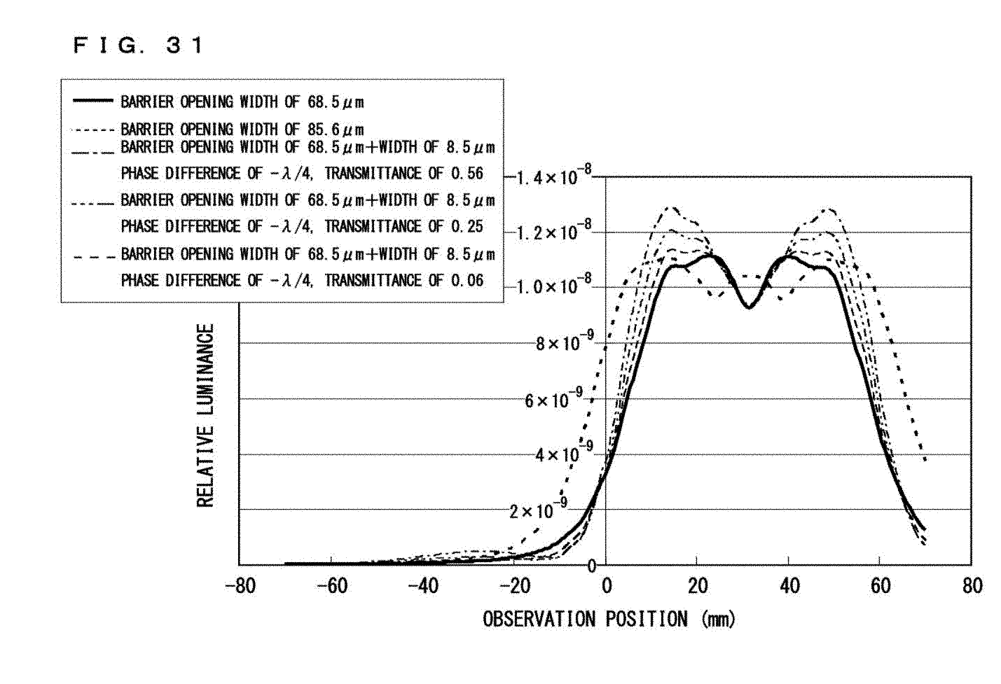

The wave optics calculation result of the light distribution characteristic in the display device 200 that is the naked-eye stereoscopic display of the second basic technology will be described below with reference to FIG. 31.

In the following description, the pitch of the sub-opening 301 is calculated for the case that the reference parallax barrier pitch is divided into 16 pieces (the case that the reference parallax barrier pitch is divided into 8 pieces is illustrated in FIGS. 17 and 18). The display panel 210 has a pixel pitch W12 of 0.069 mm, the transmission part 321 of the parallax barrier shutter panel 220 has the pitch of 0.138 mm, and a distance DB between the transmission part 321 of the parallax barrier shutter panel 220 and the pixels of the display panel 210 is 1.224 mm.

The pixel light emitting part 211 of the display panel 210 has the width of 20.5 μm, the center of the left-eye pixel is located at −0.034 mm on the left, and the center of the right-eye pixel is located at 0.034 mm on the right.

The transmission part 321 of the parallax barrier shutter panel 220 has a width W13 (that is, the barrier opening width) of 0.069 mm (specifically, 68.5 μm) that is the sum of the widths of the eight sub-openings 301, translucent parts 323 having one sub-opening portion of 8.5 μm exist on both sides of the transmission part 321, and are located above the substantially center of the pair of the right-eye pixel and the left-eye pixel of the display panel 210.

FIG. 31 illustrates the calculation result of the light distribution characteristic by variously changing the transmittance and the additional phase of the translucent part 323, the transparent glass member has the refractive index of 1.5, and the wavelength set to 550 nm in the wave optics calculation. The light distribution characteristic is illustrated in the case that the white light image and the black image are displayed in the right-eye image and the left-eye image, respectively, and the calculation result is the relative luminance distribution on the screen located at position separated from the parallax barrier shutter panel 220 by the design observation distance DS of 750 mm.

In FIG. 31, the horizontal axis illustrates the observation position [mm] on the screen, the vertical axis illustrates the relative luminance. In FIG. 31, assuming that the phase of the light passing through the translucent part 323 (width of 8.5 μm) travels longer by a ¼ wavelength as an additional phase difference, as compared with the case that light passes through the transmission part 321 (width of 68.5 μm), the calculation result is indicated by various chain lines in each of the case that the energy transmittance is set to 6%, the case that the energy transmittance is set to 25%, and the case that the energy transmittance is set to 56%.

The case that the translucent part 323 does not exist but the transmission part 321 is widened by the translucent part 323 (specifically, the barrier opening width is 85.6 μm) is indicated by a thick chain line, and the case that the translucent part 323 does not exist but the transmission part 321 has the width of 68.5 μm is indicated by a solid line.

As can be seen from FIG. 31, the luminance gradient is steep in both cases that the translucent part 323 exists as compared with the case that the translucent part 323 indicated by the solid line does not exist, and the leakage light can be prevented at the point of −10 mm. However, in the case that the transmittance is 56%, the leakage light is increased at the point of −30 mm. In this condition, it is found that the transmittance of about 25% is suitable.

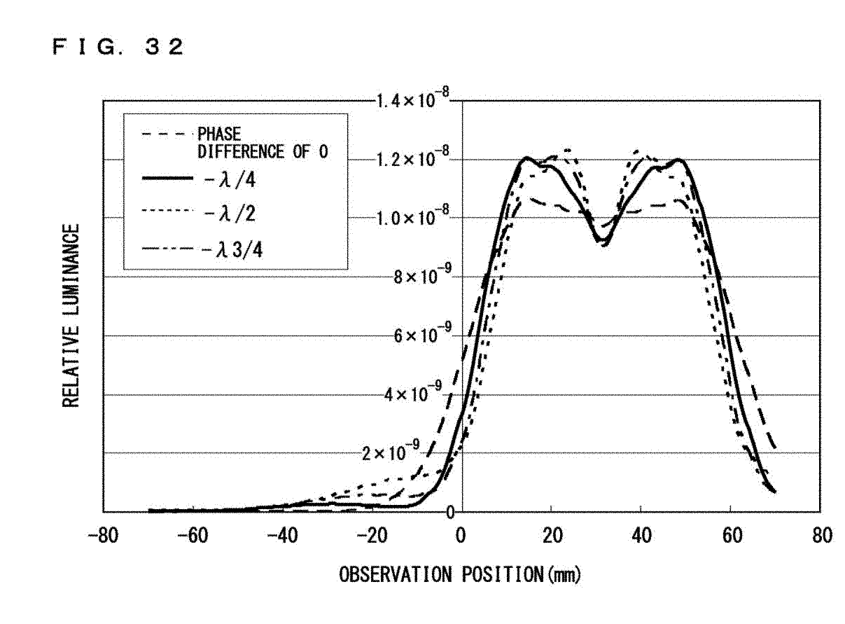

FIG. 32 illustrates a calculation result illustrating the influence of the additional phase difference that is caused when the light passes through the translucent part 323 in the case that the translucent part 323 has the energy transmittance of 25% together with the case that the additional phase difference does not exist (that is, the case of 0).

In FIG. 32, the horizontal axis indicates the observation position [mm] on the screen and the vertical axis indicates the relative luminance. The case that the light travels longer by the ¼ wavelength (that is, −λ/4) as compared with the case that the light passes through the transmission part 321, the case that the light travels longer by the ½ wavelength (that is, −λ/2), the case that the light travels longer by the ¾ wavelength (that is, −3λ/4), and the case that the phase difference is zero are illustrated in FIG. 32.

As can be seen from FIG. 32, in the case the light travels longer by λ/4 as compared with the case that the light passes through the transmission part 321 (that is, the case that the phase difference is zero), the gradient of the boundary is steep, and the luminance of the leakage light is low in the 20-degree direction.

As described above, in the display device 200 that is the naked-eye stereoscopic display of the second basic technology, the translucent part 323 is provided in the parallax barrier shutter panel 220, the transmittance of the translucent part 323 is set to about 25%, and the translucent part 323 is configured such that the light travels longer by λ/4 as compared with the case that the light passes through the transmission part 321, so that the leakage light luminance in the right and left 20-degree direction can be prevented to steepen the luminance gradient in the boundary direction.

Consequently, the boundary region where the double image is generated due to the luminance change or the 3D crosstalk can be narrowed, and the good image in which the double image due to the luminance change or the 3D crosstalk is not generated can visually recognized in a wide range when the observer's observation position moves to the right or the left.

In the above calculation, the preferable size is discussed for green light having the wavelength of 550 nm. However, in the case of red light (specifically, a wavelength of 650 nm) or blue light (specifically, a wavelength of 450 nm), the wavelength varies and the preferable sizes controlling the leakage light varies. Thus, coloring of the leakage light can be eliminated by changing the size of the translucent part of the parallax barrier according to the color of the target pixel.

In the above description, the parallax barrier has the elongated stripe shape, and the long sides are arranged in a line in parallel. Alternatively, but the parallax barrier is also applicable to a staggered arrangement (that is, a checker flag pattern shape). In the case of the staggered arrangement, a sense of resolution of the stereoscopic image is improved.

Although that case that the number of direction-specific images is two is described above as an example, the present invention is not limited to this case. Even in the case of at three parallax images, the effect that the luminance of leakage light is prevented can be obtained.

### Example in Third Prerequisite Technique

A third prerequisite technique which is a prerequisite technique of the preferred embodiment (to be described later) will be described below.

<Device Configuration>

In the first prerequisite technique, the display device including the display panel in which the pixels are arranged in the matrix form and the parallax barrier formed on the front side (that is, the image viewing side) of the display panel is described as an example. In the case that the display panel is a liquid crystal display panel, the prerequisite technique can also be applied to a device in which the parallax barrier is located on the back side of the display panel.

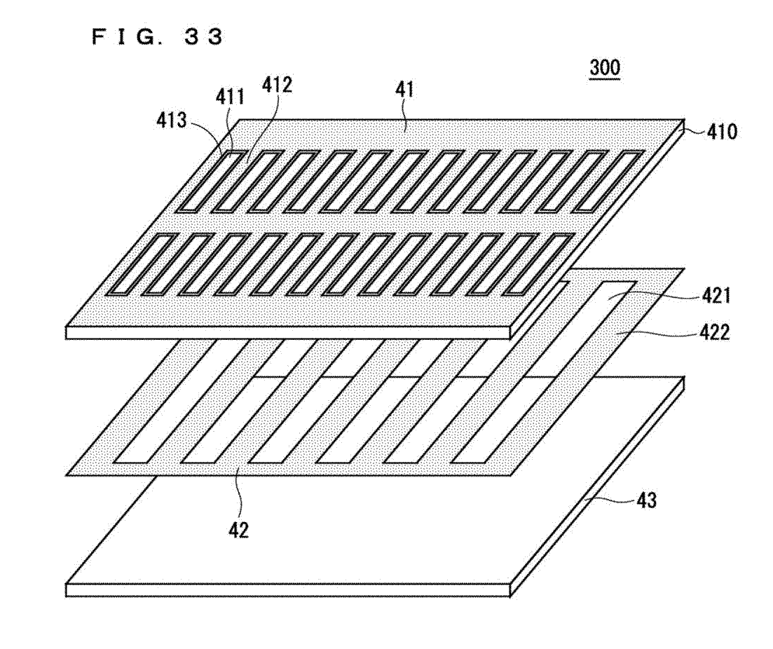

FIG. 33 is a schematic perspective view illustrating a display device 300, which is a two-image display that displays different images according to the observation direction, according to a third prerequisite technique.

As illustrated in FIG. 33, a parallax barrier 42 is disposed on the back side of a display panel 41 in which a plurality of pixels are arranged in a matrix form. A backlight 43 is provided on the back side of the parallax barrier 42.

In the display panel 41, a plurality of openings of a light shielding part 412 provided on a liquid crystal layer 410 constitute pixel transmission parts 411. Each of the pixel transmission parts 411 has a stripe shape in planar view, and is arranged such that the long sides are parallel to each other. A translucent part 413 is provided along each long side.

In the parallax barrier 42, a plurality of openings of a barrier light shielding part 422 constitute barrier transmission parts 421. Each of the barrier transmission parts 421 has a stripe shape in planar view, and is arranged such that long sides are parallel to each other.

FIG. 33 is a schematic diagram illustrating a positional relationship among a backlight 43, the pixel transmission part 411 of the display panel 41, and the barrier transmission part 421 of the parallax barrier 42, and is a view in which the transparent electrode or transparent glass that is provided on the display panel is not illustrated. The pixel transmission part 411 of the display panel 41 and the barrier transmission part 421 of the parallax barrier 42 may be disposed apart from each other with a predetermined distance, and a medium such as air or glass may exist therebetween.

FIG. 33 is a schematic diagram illustrating the positional relationship among the backlight 43, the display panel 41, and the parallax barrier 42 and the position where the translucent part 413 is provided in the pixel transmission part 411 of the display panel 41, and is a view in which the transparent electrode or transparent glass substrate that is provided on the display panel is not illustrated. The backlight 43, the display panel 41, and the parallax barrier 42 may be in close contact with one another, or media such as air or glass may be present therebetween.

At this point, the translucent part 413 of the display panel 41 has the width of 0.5 μm to 10 μm, the amplitude transmittance ranges from 20% to 80%, and the energy transmittance ranges from 4% to 64%. The translucent part 413 differs from the pixel transmission part 411 in the refractive index, and is configured such that the phase difference Δnd from zero to a half wavelength is generated between the translucent part 413 and the pixel transmission part 411.

As described above, even in the display device including the display panel 41 in which the pixels are arranged in the matrix form and the parallax barrier 42 formed on the back side of the display panel 41, the translucent part 413 is provided in the long side of the pixel transmission part 411 of the display panel 41, which allows the luminance gradient to be steepened at the boundary between the images.

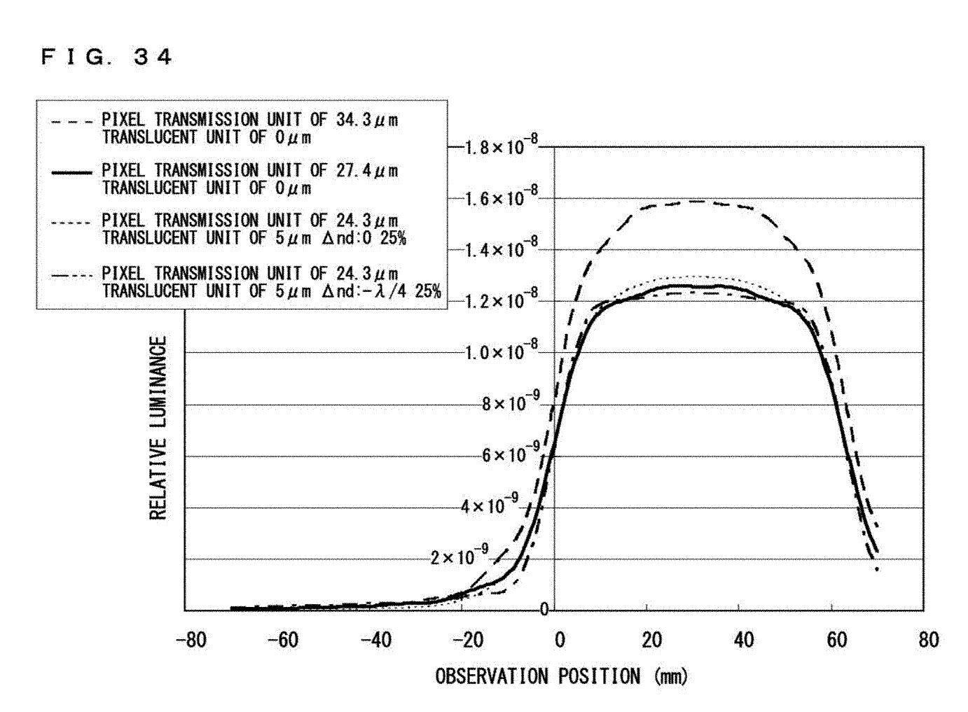

FIG. 34 illustrates the wave optics calculation result of the light distribution characteristic in the display device 300 that is the two-image display of the third basic technology. The display panel 41 has the pixel pitch of 0.069 mm, the barrier transmission part 421 of the parallax barrier 42 has the pitch of 0.138 mm, and distance between the pixel transmission part 411 of the display panel 41 and the barrier transmission part 421 of the parallax barrier 42 is 1.224 mm.

In the center position of the pixel transmission part 411 of the display panel 41, the left-eye pixel is located at −0.034 mm, the right-eye pixel is located at 0.034 mm. The barrier transmission part 421 of the parallax barrier 42 has the width of 0.069 mm.

In FIG. 34, the light distribution characteristic is calculated in the case that the energy transmittance of the translucent part 413 provided on the right and left sides of the pixel transmission part 411 and the additional phase difference Δnd in which the phase of the light passing through the translucent part 413 is added as compared with the case that the light passes through the pixel transmission part 411 are variously changed. At this point, the refractive index of the transparent glass member is 1.5, and the wavelength is 550 nm in the wave optics calculation. The calculation result is the relative luminance distribution on the screen located at a position away from the liquid crystal shutter panel by the design observation distance of 750 mm.

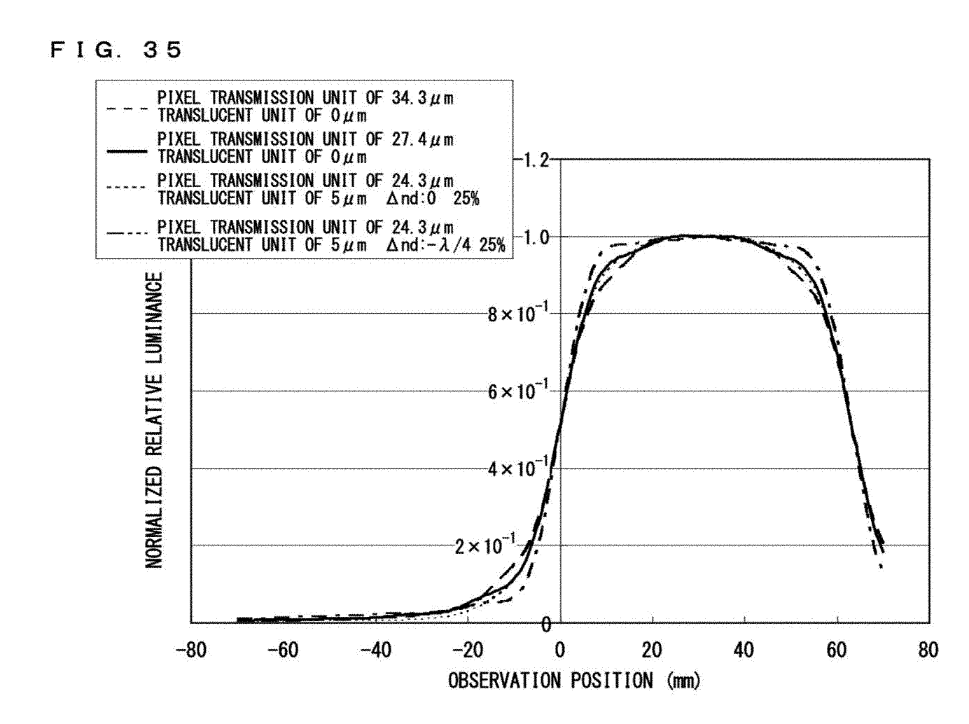

FIG. 35 illustrates a normalized relative luminance profile obtained by normalizing the respective luminance profile with the peak luminance.

The additional phase difference Δnd can be set by a combination of the refractive index change Δn and the thickness d of the liquid crystal layer. Because the thickness d of the liquid crystal layer is fixed, in order to vary the refractive index of the translucent part 413 different from that of the pixel transmission part 411, the translucent part 413 and the pixel transmission part 411 may be different from each other in the thickness of the ITO (Indium Tin Oxide) electrode having the refractive index larger than that of the liquid crystal.

In FIGS. 34 and 35, the horizontal axis indicates the observation position [mm] on the screen, and the vertical axis indicates the relative luminance. In FIGS. 34 and 35, the case that the translucent part 413 does not exist but the pixel transmission part 411 has the width of 34.3 μm is indicated by a thick chain line, the case that the translucent part 413 does not exist but the pixel transmission part 411 has the width of 27.4 μm is indicated by a solid line, the case that the translucent part 413 has the width of 5 the transmittance is 25%, and the additional phase difference (And) is 214 is indicated by a broken line, and the case that the width of the translucent part 413 has the width of 5 μm, the transmittance is 25%, and the additional phase difference (And) is zero is indicated by a chain line.

As can be seen from FIG. 35, in the case that the transmittance is 25% and the additional phase difference (Δnd) is λ/4, as compared with the case that the translucent part 413 indicated by the solid line does not exist, the peak luminance is not largely decreased and the luminance gradient is steep at the boundary, and the leakage light can be prevented at the point of −10 mm.

Additionally, in the case that the translucent part 413 has the transmittance of 25% and the additional phase difference (And) is zero, as compared with the case that the translucent part 413 indicated by the solid line does not exist, the peak luminance is not largely decreased, and the leakage light can be prevented at the point of −30 mm.

In this way, the good leakage light characteristic can be obtained by appropriately setting the transmittance of the translucent part 413 and the additional phase difference (Δnd) according to the configuration of the display device.

### Example in the Fourth Prerequisite Technique

A fourth prerequisite technique which is a prerequisite technique of the preferred embodiment (to be described later) will be described below.

A specific configuration of the liquid crystal display panel in the device of the third prerequisite technique, in which the display panel is the liquid crystal display panel and the parallax barrier is located on the back side of the display panel, will be described in the fourth prerequisite technique.

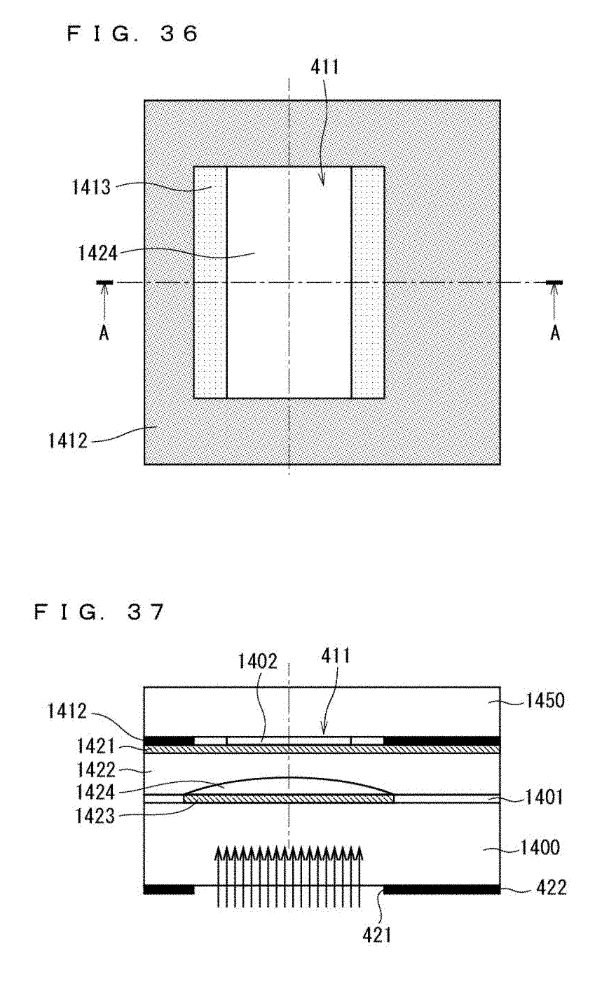

FIG. 36 is a plan view illustrating an example of the specific configuration of the pixel transmission part 411 of the display panel 41 in FIG. 33. FIG. 37 is a sectional view illustrating an example of the specific configuration of the pixel transmission part 411 of the display panel 41 in FIG. 33. FIG. 37 is a sectional view taken along a line A-A in FIG. 36. The center line passing vertically through the pixel transmission part 411 in FIG. 37 is common to the center line passing vertically through the pixel transmission part 411 in FIG. 36.

As illustrated in FIG. 36, the pixel transmission part 411 has a vertically elongated rectangular shape in planar view, and translucent films 1413 are provided along the two long sides of the pixel transmission part 411. A light shielding film 1412 is formed around the pixel transmission part 411 including the translucent film 1413.

As illustrated in FIG. 37, a liquid crystal layer 1422 is sandwiched between a lower transparent substrate 1400 and an upper transparent substrate 1450, a pixel electrode 1423 is disposed on the lower transparent substrate 1400, a counter electrode 1421 is disposed on the bottom surface of the upper transparent substrate 1450, and the pixel electrode 1423 and the counter electrode 1421 are opposed to each other with the liquid crystal layer 1422 interposed therebetween. The pixel electrode 1423 is independently provided for each pixel transmission part 411 (also referred to as an upper opening), and is provided in at least a region corresponding to the lower portion of the upper opening (the pixel transmission part 411). The counter electrode 1421 is provided on the entire bottom surface of the upper transparent substrate 1450. The barrier light shielding part 422 and the barrier transmission part 421 (also referred to as a lower barrier opening) of the parallax barrier 42 are provided on the lower main surface (that is, the main surface on the side opposite to the side on which the pixel electrode 1423 is provided) of the lower transparent substrate 1400.

The electric field can be formed between the pixel electrode 1423 and the counter electrode 1421 by appropriately applying voltage to the pixel electrode 1423. The transmittance of the light can be changed in each upper opening (pixel transmitting part 411) by controlling orientation of the liquid crystal layer 1422 using the electric field.

The ordinary pixel electrode 1423 is constructed with a transparent conductive film, such as ITO, which has the refractive index of about 2.1, and is constructed with a thin film having a uniform thickness. In the fourth prerequisite technique, a high-refractive index film 1424 is provided on the pixel electrode 1423, the high-refractive index film 1424 having a curved shape, in which a thickness of a sectional shape is maximized in the center of the pixel transmission part 411 and decreased toward the end edge. This high-refractive index film 1424 is also made of ITO, and functions as the pixel electrode.

The pixel electrode 1423 is formed on the lower transparent substrate 1400. As to a method for forming the pixel electrode 1423, a transparent conductive film such as ITO is formed over the entire surface of the lower transparent substrate 1400, and the transparent conductive film is patterned by photolithography to provide the pixel electrode 1423. The patterned pixel electrode 1423 is covered with a transparent insulating film 1401, and the transparent insulating film 1401 is flattened to the thickness of the pixel electrode 1423.

A method for forming the counter electrode 1421 is also similar. After the translucent film 1413 and the light shielding film 1412, in which portions corresponding to the pixel transmission part 411 are the opening, are formed on the upper transparent substrate 1450, the translucent film 1413 and the light shielding film 1412 are covered with the transparent insulating film 1402, the transparent insulating film 1402 is flattened to the thicknesses of the translucent film 1413 and the light shielding film 1412, and the transparent conductive film is formed over the entire surfaces of the transparent insulating film 1402, the translucent film 1413, and the light shielding film 1412, thereby obtaining the counter electrode 1421. The method described with reference to FIGS. 11, 12, 13, and 14 can be adopted as the method for forming the translucent film 1413 and the light shielding film 1412.

After the high-refractive index film 1424 is formed on the pixel electrode 1423, the upper transparent substrate 1450 and the lower transparent substrate 1400 are disposed so as to be opposed to each other such that the pixel electrode 1423 and the counter electrode 1421 face each other, and the liquid crystal layer 1422 is formed by sealing the liquid crystal material between the pixel electrode 1423 and the counter electrode 1421.

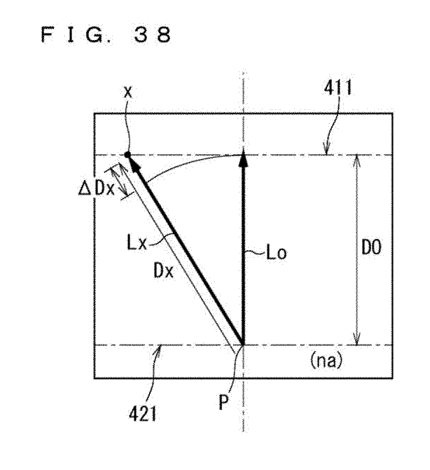

A thickness distribution of the high-refractive index film 1424 will be described below with reference to FIG. 38. FIG. 38 is a view schematically illustrating the optical path of the light passing through the pixel transmission part 411 (upper opening) of the display panel 41 in FIG. 33 and the barrier transmission part 421 (lower barrier opening) of the parallax barrier 42, and illustrates a state in which the upper opening (pixel transmission part 411) is opposed to the lower barrier opening (barrier transmitting portion 421) while separated from the lower barrier opening (barrier transmitting portion 421) by a distance D0 in the observation direction.

The light emitted from the point P in the lower barrier opening (barrier transmission part 421) propagates radially toward the upper opening (pixel transmission part 411). At this point, as compared with light L0 traveling directly upward from the point P, a phase delay (ΔDx−D0)·na decided by an optical path difference ΔDx=(Dx−D0) and a surrounding refractive index na is generated in light Lx passing through a position x in the upper opening (pixel transmission part 411).

In order that the light emitted from the point P in the lower barrier opening (barrier transmission part 421) to pass through the upper opening (pixel transmission part 411) is focused and imaged at the observer's position, it is effective to match the phase immediately after the light passing through the upper opening (pixel transmission part 411). In order to compensate for the phase delay of the light Lx with respect to the light L0, the high-refractive index film 1424 having a refractive index nh larger than the surrounding refractive index na is disposed in the central portion in the opening, and the high-refractive index film 1424 is formed such that a thickness t of the high-refractive index film 1424 satisfies the following Formula (4).

ΔDx·na=(nh−na)·t (4)

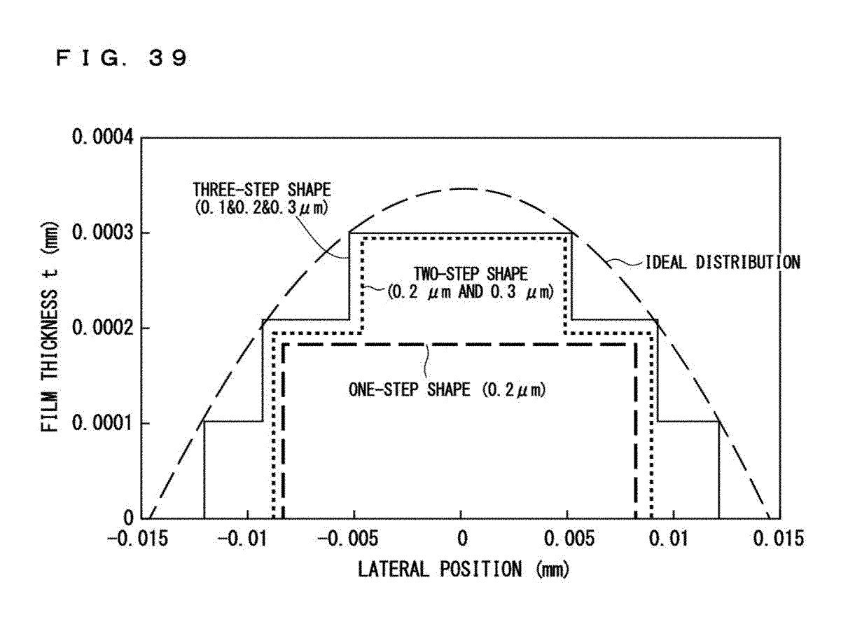

In FIG. 39, the horizontal axis indicates the lateral position [mm] representing the position from the center axis in the width direction (that is, the lateral direction) of the high-refractive index film 1424, the vertical axis indicates the film thickness t [mm], and the film thickness distribution of the high-refractive index film 1424 is illustrated. The ideal film thickness distribution of the high-refractive index film 1424 satisfying Formula (4) is indicated by a broken line.

At this point, the distance between the upper opening (the pixel transmission part 411) and the lower barrier opening (the barrier transmitting portion 421) is set to the distance D0=0.9 mm, the upper opening (the pixel transmission part 411) has the width of 0.030 mm, the barrier opening (barrier transmitting portion 421) has the width of 0.050 mm, the surrounding refractive index na is set to the refractive index na=1.5 of the liquid crystal layer 1422, and the refractive index of the high-refractive index film 1424 is set to the refractive index nh=2.1 of ITO.

In this case, in the film thickness distribution of the ideal high-refractive index film 1424, the film thickness is 0 μm at the end of the upper opening (pixel transmission part 411), the maximum thickness in the central portion of the upper opening (pixel transmission part 411) is about 0.35 and the ideal high-refractive index film 1424 is thinner than the general liquid crystal layer 1422 having the thickness of 3 μm to 5 μm, so that the influence on the light shielding effect of the liquid crystal panel can be ignored.

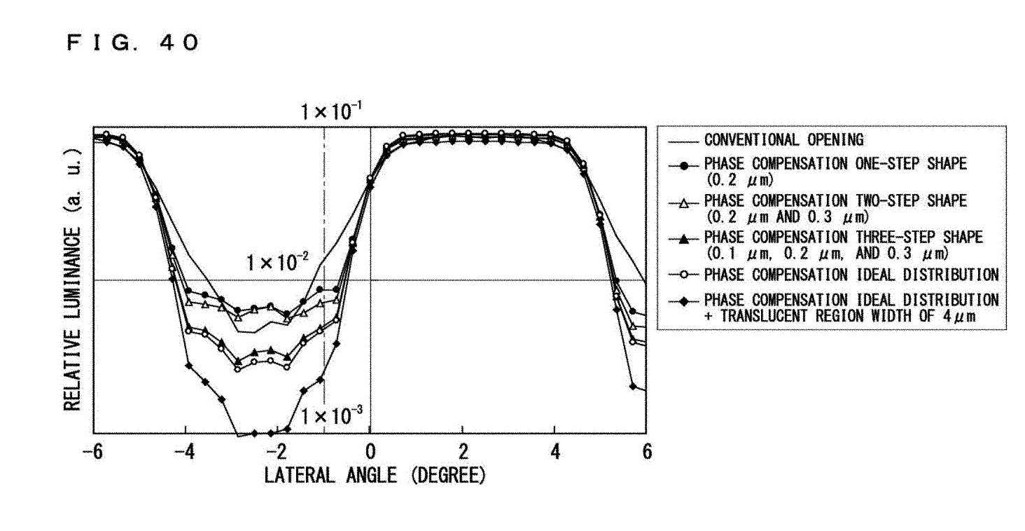

FIG. 40 illustrates the calculation result of the light distribution characteristic by the wave optics calculation in the case that the high-refractive index film 1424 has the ideal film thickness distribution. In FIG. 40, the horizontal axis indicates the light distribution angle as the lateral angle (degree), the vertical axis indicates the relative luminance (a.u.: arbitrary unit), and the characteristic plotted by a hollow circle is the calculation result for the ideal film thickness distribution, and is called a “phase compensation ideal distribution”. Under this condition, it is assumed that the translucent region does not exist.

In FIG. 40, the calculation result in the case that the pixel electrode 1423 has the uniform ITO film thickness, the high-refractive index film 1424 is not included, and the translucent region does not exist is illustrated as a “conventional opening”. In the phase compensation ideal distribution, the minimum leakage light luminance appearing in the −2.5-degree direction and the leakage light intensity in the −1-degree direction are decreased as compared with the conventional opening. This indicates that the observer can observe the stereoscopic image without the double image due to the 3D crosstalk in a wider viewing region in a wider range.

In the state of the phase guarantee ideal distribution, the calculation result in the case that the translucent region having the amplitude transmittance of 50% is formed with a width of 4 μm at the end of the opening is referred to as “phase guarantee ideal distribution+translucent region 4 μm”, which is plotted by a filled diamond. In this characteristic, both the minimum leakage light luminance appearing in the −2.5-degree direction and the leakage light luminance in the −1-degree direction are further decreased.

As described above, the film having the refractive index higher than that of the surroundings is formed close to the upper opening (pixel transmitting part 411) such that the film thickness (t) has a distribution satisfying Formula (4), which allows the width of the boundary region having the large 3D cross talk to be narrowed to implement the light distribution characteristic having a low minimum leak luminance. Additionally, the translucent region is provided at the end in the width direction (that is, the lateral direction) of the upper opening (pixel transmitting part 411), which allows the width of the boundary region having the large 3D cross talk to be further narrowed to implement the light distribution characteristic having a lower minimum leak luminance.

However, the improvement of the leak light luminance distribution is not limited to the case that the high-refractive index film 1425 has the ideal film thickness distribution satisfying Formula (4). That is, a plurality of high refractive index thin films having the uniform thickness may be laminated to form a multilayered high-refractive index film having the film thickness distribution approximate to the ideal phase distribution phase distribution. FIG. 32 illustrates an example of the multilayered high-refractive index film.

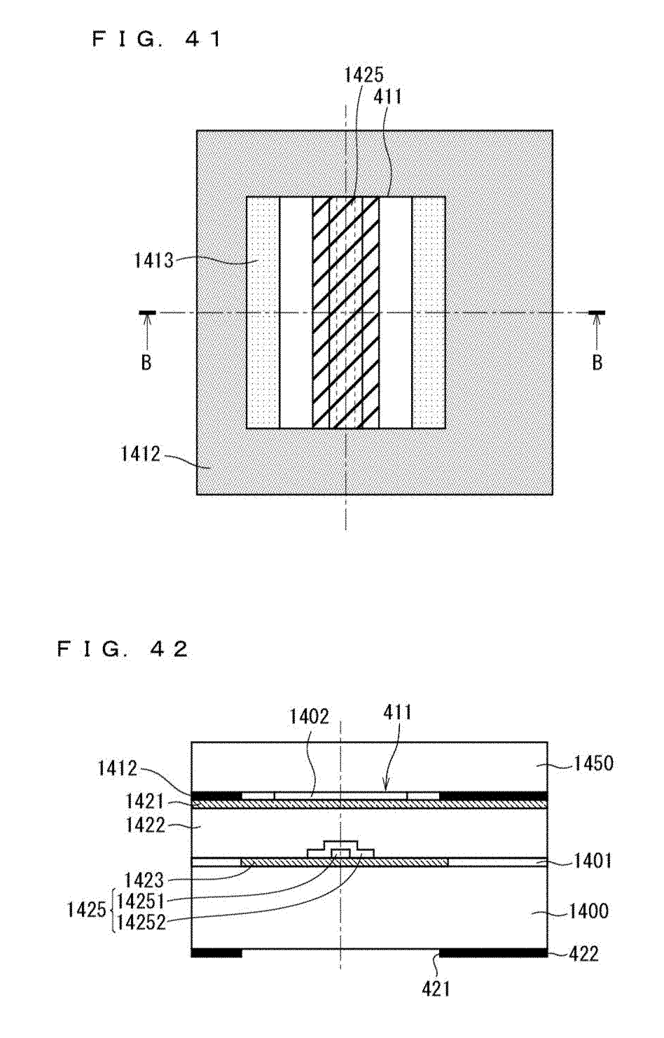

FIG. 41 is a plan view illustrating an example of the specific configuration of the pixel transmission part 411 of the display panel 41 in FIG. 33. FIG. 37 is a sectional view illustrating an example of the specific configuration of the pixel transmission part 411 of the display panel 41 in FIG. 33. FIG. 37 is a sectional view taken along a line A-A in FIG. 36. The center line passing vertically through the pixel transmission part 411 in FIG. 37 is common to the center line passing vertically through the pixel transmission part 411 in FIG. 36.

FIG. 41 is a view corresponding to FIG. 36, and is a plan view illustrating an example of the specific configuration of the pixel transmission part 411 of the display panel 41. FIG. 42 is a view corresponding to FIG. 37, and is a sectional view illustrating an example of the specific configuration of the pixel transmission part 411 of the display panel 41. FIG. 42 is a sectional view taken along a line B-B in FIG. 41, The center line passing vertically through the pixel transmission part 411 in FIG. 42 is common to the center line passing vertically through the pixel transmission part 411 in FIG. 41. The configuration identical to that in FIGS. 36 and 37 is denoted by the identical reference numeral, and the redundant description is omitted.

In FIGS. 41 and 42, a high-refractive index film 1425 having a two-step shape is provided on the pixel electrode 1423. A first thickness that is the maximum in the center of the upper opening (pixel transmission part 411) and a second thickness smaller than the first thickness in other portions are provided in the sectional shape of the high-refractive index film 1425. The high-refractive index film 1425 includes a high-refractive index film 14251 that is provided the center of the upper opening (pixel transmitting part 411) and along the long side of the opening and a high-refractive index film 14252 that is provided so as to cover the high-refractive index film 14251. The high-refractive index film 14251 and the high-refractive index film 14252 become the first thickness, and the high-refractive index film 14252 corresponds to the second thickness.

In FIG. 39, in addition to the two-step-shaped high-refractive index film, the film thickness distributions in the case of using a three-step-shaped high-refractive index film and a one-step-shaped high-refractive index film are also illustrated as an example of the multilayered high-refractive index film. That is, the one-step-shaped high-refractive index film has the uniform thickness of 0.2 μm, and the two-step-shaped high-refractive film has the thickness of 0.3 μm at the center and the thickness of 0.2 μm both sides, and the three-step-shaped high-refractive index film has the thickness of 0.3 μm at the center, the thickness of 0.2 μm on both sides, and the thickness of 0.1 μm on the outside.

FIG. 40 illustrates the light distribution characteristic in the case of using the one-step-shaped high-refractive index film as a characteristic plotted by a filled circle with the phase compensation of one stage (0.2 μm), the light distribution characteristic in the case of using the two-step-shaped high-refractive index film as a characteristic plotted by a hollow triangle with the phase compensation of two stages (0.2 μm and 0.3 μm), and the light distribution in the case of using the three-step-shaped high-refractive index film as characteristic plotted by a filled triangles with the phase compensation of three steps (0.1 μm, 0.2 μm, and 0.3 μm). Under any condition, it is assumed that the translucent region does not exist.

In any case, these characteristics are inferior to the ideal film thickness distribution in the effect that the leakage light luminance, but the leakage light luminance in the −1-degree direction can be reduced as compared with the case of the “conventional opening”.

That is, the film having a refractive index higher than that of the surroundings is formed in the vicinity of the upper opening (pixel transmission part 411) with the film thickness distribution in which the central portion of the opening is thick while the edge is thin, which allows the increase of the gradient at which the leakage light is decreased. That is, the three-dimensional viewing region can be widened by narrowing width of the boundary region having the large 3D crosstalk that is close to the observation region boundary.

The high-refractive index film having the refractive index higher than that of the surroundings and the central portion thicker than the both ends is provided in the vicinity of the upper opening (pixel transmission part 411), and the translucent region is provided at the end in the width direction of the upper opening (pixel transmission part 411), which allows the width in the boundary region having the large 3D crosstalk to be narrowed to implement the light distribution characteristic having the low minimum leak luminance.

<Modifications>

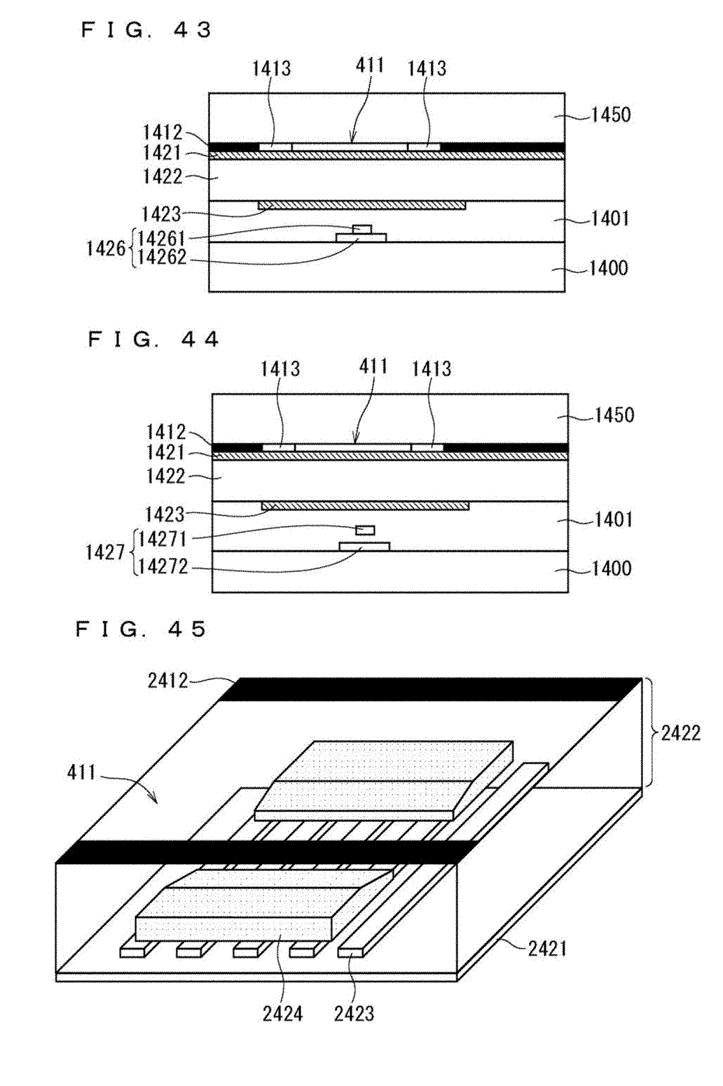

In FIGS. 43 and 44, other configurations of the high-refractive index film having the refractive index higher than that of the surroundings and the film thickness distribution in which the central portion of the opening is thick while the end is thin are illustrated in the vicinity of the upper opening (pixel transmission part 411). That is, the high-refractive index film 1424 in FIGS. 36 and 37 and the high-refractive index film 1425 in FIGS. 41 and 42 are provided in the liquid crystal layer 1422. On the other hand, a high-refractive index film 1426 and a high-refractive index film 1427 in FIGS. 43 and 44 are formed in the transparent insulating film 1401 disposed on the lower transparent substrate 1400.

At this point, the thickness of the general liquid crystal layer 1422 ranges from 3 μm to 5 μm, the thickness of the thin film layer on the lower transparent substrate 1400 ranges from about 1 μm to about 3 μm, and these thicknesses are smaller than the distance D0 of about 1 mm between the lower barrier opening (barrier transmission part 421) and the upper opening (pixel transmission part 411), so that it can be said that the high-refractive index films 1426, 1427 are located in the vicinity of the liquid crystal layer 1422.

More specifically, the high-refractive index film 1426 in FIG. 43 has the two-step shape in which a high-refractive index film 14261 made of a nitride film narrower than that of a high-refractive index film 14262 made of a silicon nitride film (SiN, nh=1.8 to 2.2) is laminated on the high-refractive index film 14262, and the high-refractive index film 1426 is disposed below the pixel electrode 1423. At this point, when the transparent insulating film 1401 is made of a silicon oxide film (SiO₂, na=1.5), the condition is satisfied because the refractive index of the high-refractive index film 1426 is higher than that of the transparent insulating film 1401.

In a high-refractive index film 1427 in FIG. 44, a high-refractive index film 14271 made of a silicon nitride film having a width narrower than that of a high-refractive index film 14272 made of a silicon nitride film is disposed above the high-refractive index film 14272, and a transparent insulating film 1401 is interposed therebetween. However, because the gap between the high-refractive index film 14271 and the high-refractive index film 14272 is narrow, the phase delay of the light passing through the high-refractive index film 14271 and the high-refractive index film 14272 becomes the sum of the delay in the high-refractive index film 14271 and the delay in the high-refractive index film 14272. For this reason, the high-refractive index film 1427 is substantially identical to the case of the two-step shape.

When the position of the high-refractive index film 1426 and the position of the high-refractive index film 1427 are located within several micrometers from the liquid crystal layer 1422, because it is about 1/10 of the width of the upper opening (pixel transmission part 411), the effect identical to that of the case of being provided in the liquid crystal layer 1422 is exerted.

A typical thin film transistor (TFT)-driven liquid crystal display manufacturing method includes a process of depositing a plurality of thin films, such as a transparent conductive film (ITO), a silicon oxide film (SiO₂), a silicon nitride film (SiN), and an oxide semiconductor, which have different refractive indexes, and a photolithography process of patterning the plurality of thin films.

Thus, among the plurality of materials, a material (for example, a silicon nitride film, ITO, or an oxide semiconductor) having a relatively high refractive index (specifically, 1.9 or more) is left in a material (for example, a liquid crystal, a silicon oxide film, or an organic film) having a relatively low refractive index (specifically, 1.5 to 1.6) while the pattern shape of the conventional mask is change, which allows the high-refractive index film 1426 and the high-refractive index film 1427 to be formed. Consequently, the high-refractive index film can be formed without increasing the process cost.

The fourth premise technology and its modifications can be rephrased as follows. That is, the average refractive index of the pixel transmission part 411 including the liquid crystal layer 1422, the surrounding electrodes, and the insulating film on the substrate is higher in the central portion in the width direction (that is, the lateral direction), and is lower at the end. Consequently, the gradient at which the leakage light is decreased in the light distribution characteristic can be increased, the width of the boundary region having the large 3D crosstalk that is close to the observation region boundary can be narrowed, and the three-dimensional viewing region can be widened.

### Example in Fifth Prerequisite Technique

A fifth prerequisite technique that is a prerequisite technique of the preferred embodiment (to be described later) will be described below.

A specific configuration in the case that an FFS (Fringe Field Switching) mode liquid crystal display panel is used as the liquid crystal display panel in the device of the third prerequisite technique, in which the display panel is the liquid crystal display panel and the parallax barrier is located on the back side of the display panel, will be described in the fifth prerequisite technique.

FIG. 45 is a view illustrating an example of the specific configuration immediately below the pixel transmission part 411 (also referred to as the upper opening) of the display panel 41 illustrated in FIG. 33. As illustrated in FIG. 45, the pixel transmission part 411 has a vertically elongated rectangular shape in planar view, and a light shielding film 2412 is formed outside the pixel transmission part 411.

A liquid crystal layer 2422 is driven by the electric field generated between a flat-shaped common electrode 2421 and a comb-shaped pixel electrode 2423, which is provided on the common electrode 2421 and extends in the width direction of the upper opening (pixel transmission part 411). The pixel electrode 2423 is provided independently for each upper opening (pixel transmission part 411), and is provided in a region corresponding to at least the lower portion of the upper opening (pixel transmission part 411).

By adopting the above configuration, the appropriate voltage can be applied to the pixel electrode 2423 to form the electric field between the pixel electrode 2423 and the common electrode 2421, and the orientation of the liquid crystal layer 2422 can be controlled by the electric field to change the transmittance of the light in each upper opening (pixel transmission part 411).

In the liquid crystal layer 2422, an in-liquid crystal layer insulating film 2424 made of a silicon oxide film or a silicon nitride film is disposed in a region corresponding to two ends in the width direction of the upper opening (pixel transmission part 411), and the thickness of the liquid crystal layer 2422 in the region corresponding to the two ends is thinner than that in the central portion. That is, as illustrated in FIG. 45, a pair of the in-liquid crystal layer insulating films 2424 are disposed above the pixel electrode 2423, and the in-liquid crystal layer insulating film 2424 is thinned on the central side of the upper opening (the pixel transmission part 411) while thickened on the end side, so that the liquid crystal layer 2422 is substantially thinned at the end in the width direction of the upper opening (pixel transmission part 411).

That is, because the maximum thickness of the in-liquid crystal layer insulating film 2424 is about a half of the thickness of the liquid crystal layer 2422, it is said that the thickness of the liquid crystal layer 2422 at the end in the width direction of the upper opening (pixel transmission part 411) is smaller than the thickness of the liquid crystal layer 2422 in the central portion.

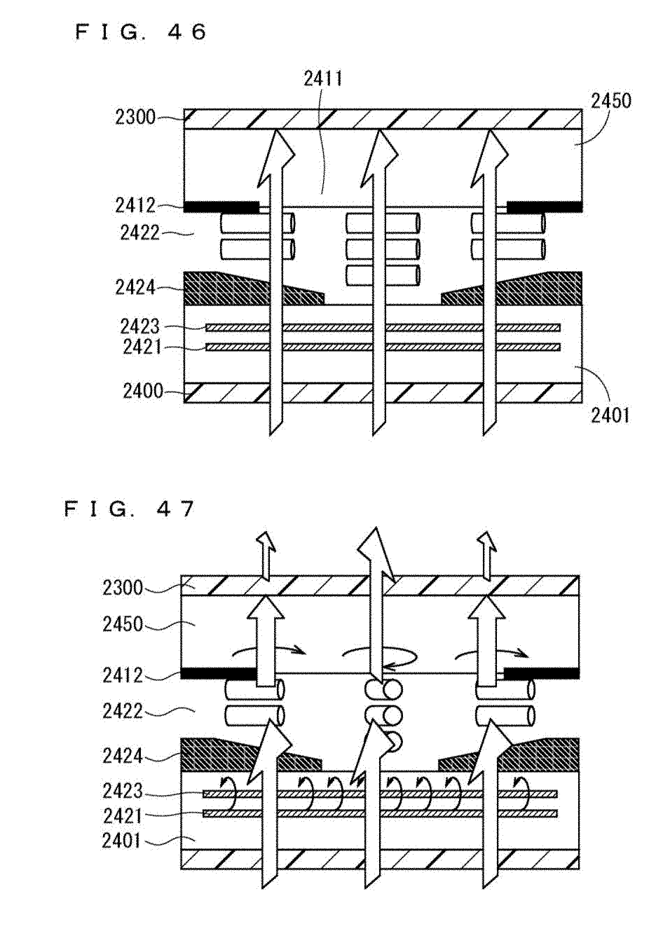

The operation of the liquid crystal layer 2422 having the above configuration will be described below with reference to sectional views in FIGS. 46 and 47. The FFS mode liquid crystal display panel is a normally black panel in which the transmittance becomes zero while the voltage is not applied. Thus, as illustrated in FIG. 46, a rubbing direction of the liquid crystal layer 2422 and polarization directions of the polarizing plate 2400 and the polarizing plate 2300 are decided such that the light passing through a polarizing plate 2400 and a lower transparent substrate 2401 is wholly absorbed by a polarizing plates 2300 through an upper transparent substrate 2450 while the voltage is not applied to the pixel electrode 2423.

When the transmittance of the upper opening (pixel transmission part 411) is maximized, as illustrated in FIG. 47, the voltage is applied to the pixel electrode 2423 to form the electric field between the pixel electrode 2423 and the common electrode 2421, and an orientation angle of liquid crystal molecules in the liquid crystal layer 2422 is rotated. When the voltage that rotates the polarization direction of the incident light passing through the center of the upper opening (pixel transmission part 411) by just 90 degrees is applied, the incident polarized light is not absorbed by the polarizing plate 2300 but most of the incident polarized light is transmitted, and the transmittance of the upper opening (pixel transmission part 411) is maximized.

In the in-liquid crystal layer insulating film 2424, the orientation angle of the liquid crystal molecules can be controlled. That is, due to the existence of the in-liquid crystal layer insulating film 2424, the thickness of the liquid crystal layer 2422 at the end in the width direction of the upper opening (pixel transmission part 411) is about a half of that in the central portion, so that the rotation of the polarization direction of the incident light passing through the in-liquid crystal layer insulating film 2424 is smaller than 90 degrees and the transmittance of the polarizing plate 2300 at the end in the width direction of the upper opening (pixel transmission part 411) is lower than that in the central portion. Consequently, the region where the transmittance is lower than that in the central portion, namely, the translucent region can be constructed at both ends in the width direction of the upper opening (pixel transmission part 411). Thus, the low-leakage light luminance distribution can be obtained as illustrated in FIG. 40.

In addition, there is also an effect that the electric field applied to the liquid crystal layer 2422 is relaxed by disposing the in-liquid crystal layer insulating film 2424 at the position close to the pixel electrode 2423. The change in the orientation angle of the liquid crystal molecules is also decreased, so that the rotation of the polarization direction of the incident light is further decreased to increase the absorption by the polarizing plate 2300.

The in-liquid crystal layer insulating film 2424 may be provided at the position close to the light shielding film 2412. However, by disposing the in-liquid crystal layer insulating film 2424 at the position close to the pixel electrode 2423, the transmittance can effectively be lowered by the thickness of the thinner in-liquid crystal layer insulating film 2424, a step in the liquid crystal layer 2422 is decreased, and the rubbing process is easy to perform.

When the thickness of the liquid crystal layer 2422 at the end in the width direction of the upper opening (pixel transmission part 411) can be decreased to about a half of that in the central portion, the present invention is not limited to this method, but similarly the region where the transmittance is lower than that of the central portion, namely, the translucent region can be constructed at both ends in the width of the upper opening (pixel transmission part 411).

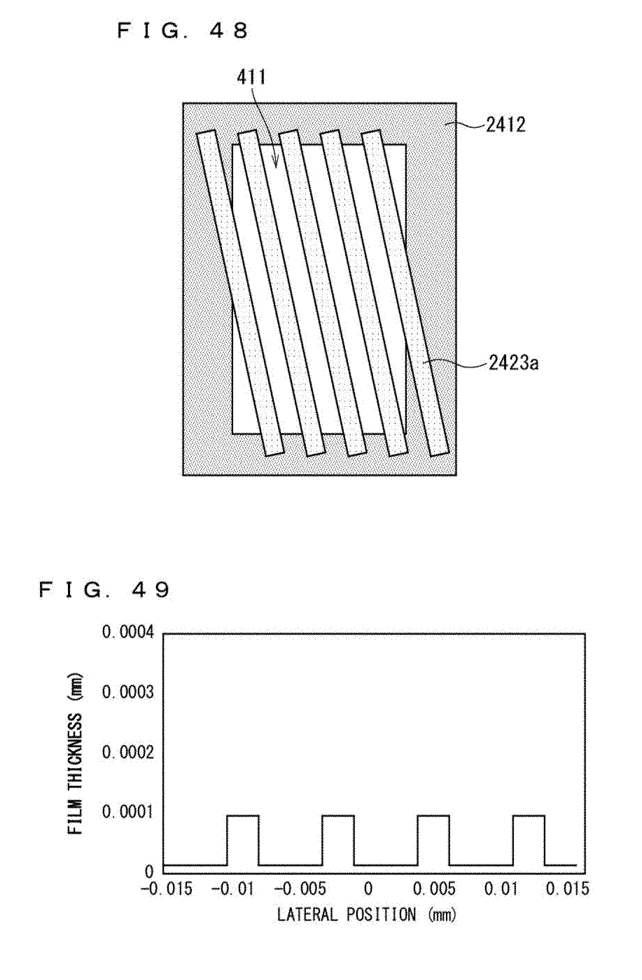

In FIG. 45, the pixel electrode 2423 has the comb shape extending in the width direction of the upper opening (the pixel transmission part 411). Alternatively, as illustrated in FIG. 48, the following problem arises in the case that the pixel electrodes are arranged so as to extend in the longitudinal direction of the upper opening (pixel transmission part 411).

That is, in FIG. 48, a comb-shaped pixel electrode 2423a is obliquely disposed with respect to the longitudinal direction of the upper opening (pixel transmission part 411). Because the pixel electrode 2423a is usually made of an ITO film having a thickness of about 0.1 μm, the thickness of the pixel electrode 2423a protrudes by about 0.1 μm in the liquid crystal layer 2422. Because the ITO thin film has the refractive index of 1.9 to 2.1 larger than the refractive index (1.5 to 1.6) of the liquid crystal layer 2422, a concave-convex-shaped phase delay distribution (Δnd phase delay distribution) is generated in the width direction of the upper opening (pixel transmission part 411).

In FIG. 49, the horizontal axis indicates the position [mm] in the width direction of the upper opening (pixel transmission part 411), the vertical axis indicates the film thickness [mm]. FIG. 49 illustrates the generation of the phase delay corresponding to the thickness (specifically, 0.0001 mm) of the pixel electrode 2423a in a period of the arrangement of the pixel electrode 2423a.

This is the concave and convex that cannot be ignored as compared with the ideal film thickness distribution of the high-refractive index film in FIG. 39, the diffraction is generated in the width direction, and the leakage light is increased in the width direction.

On the other hand, for the shape extending in the width direction of the upper opening (pixel transmission part 411) like the pixel electrode 2423 in FIG. 45, the diffracted light is expanded in the longitudinal direction of the upper opening (pixel transmission part 411) but is not expanded in the width direction, so that the leakage light is not increased in the width direction.

In the IPS mode or FFS mode, the comb-shaped electrode thin wire is obliquely disposed by about ±5° to about 10° with respect to the width direction or the longitudinal direction of the opening. This is because the rotation direction of molecular orientation is aligned. Thus, even in the case where the pixel electrode 2423 has the comb shape extending in the width direction, it is conceivable to obliquely dispose the pixel electrode 2423 by about ±5° to about 10° with respect to the width direction.

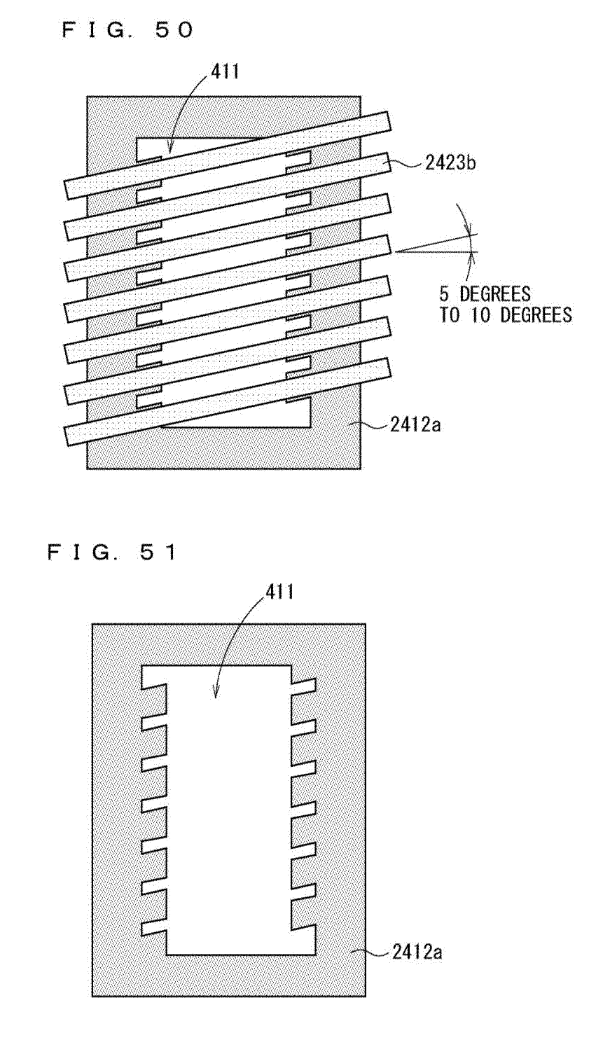

FIG. 50 illustrates a configuration in which a comb-like pixel electrode 2423b is obliquely disposed with respect to the width direction of the upper opening (pixel transmission part 411). In the case of adopting this configuration, the light diffracted by the pixel electrode 2423b travels in a direction inclined by ±5° to 10° with respect to the longitudinal direction of the upper opening (pixel transmission part 411), so that the increase of the leakage from the width direction of the opening is prevented.

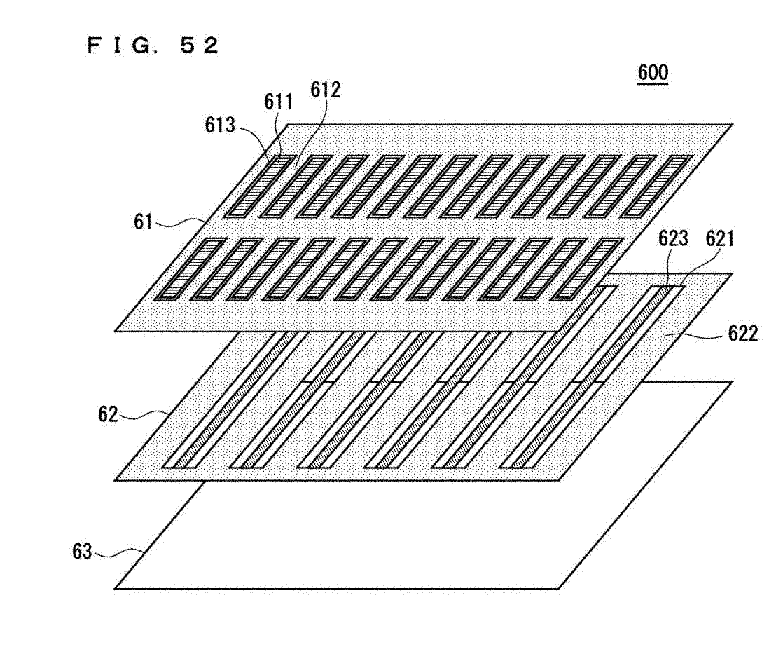

In the case of adopting the configuration in FIG. 50, a light shielding film 2412a has a planar shape of in FIG. 51. That is, a concave-convex structure is formed at both ends in the width direction of the upper opening (pixel transmission part 411), a convex portion shielding the light is formed at a portion corresponding to the pixel electrode 2423b made of an ITO film, and a concave portion transmitting the light is formed between the pixel electrodes 2423b. As a result, a region in which the average transmittance is lower than that in the central portion of the upper opening (pixel transmission part 411) is formed at the end in the width direction of the upper opening (pixel transmission part 411).

At the end in the width direction of the upper opening (pixel transmission part 411), only a portion that does not correspond to the pixel electrode 2423b made of the ITO film constitutes the transmission part, and the portion is not affected by the high refractive index of the pixel electrode 2423b, so that the average transmittance is lower than that in the central portion of the upper opening (pixel transmission part 411). For this reason, the film thickness distribution of the high-refractive index film in FIG. 39 is easily obtained.

Although not illustrated in FIG. 45, the high-refractive index film 1424 in FIGS. 36 and 37, the high-refractive index film 1425 in FIGS. 41 and 42, the high-refractive index film 1426 in FIG. 43, or the high-refractive index film 1427 in FIG. 44 may be provided such that the average refractive index of the transmission part is lowered on the end side compared with the central portion in the lateral direction of the transmission part.

### Example in Sixth Prerequisite Technique

A sixth prerequisite technique that is a prerequisite technique of the preferred embodiment (to be described later) will be described below.

The sixth premise technique is a technique in which the flat region of the peak luminance in the light distribution characteristic of the display device is further expanded by controlling the transmittance of the transmission part of the parallax barrier in the liquid crystal display panel having a configuration in which the liquid crystal display panel of the third, fourth, and fifth prerequisite techniques in which the pixels are arranged in the matrix form and the parallax barrier disposed between the liquid crystal display panel and the backlight disposed on the back side of the liquid crystal display panel are combined, and a configuration in which the transmittance of the transmission part of the liquid crystal display panel is high in the central portion in the width direction (also referred to as the lateral direction or the horizontal direction) and is low on the end side (that is, the end side is lower than the central portion) or the average refractive index of the transmission part of the liquid crystal display panel is high in the central portion in the width direction (that is, the lateral direction) and is low on the end side (that is, the end side is lower than the central portion).

<Device Configuration>

FIG. 52 is a schematic perspective view illustrating a display device 600 that is a two-image display that displays different images according to the observation direction of the sixth prerequisite technique. The display device 600 is one having a configuration in which a display panel 61, a parallax barrier 62, and a backlight 63 are disposed in this order.

As illustrated in FIG. 52, the parallax barrier 62 is disposed on the back side of the display panel 61 in which the plurality of pixels are arranged in the matrix form. The backlight 63 is provided on the back side of the parallax barrier 62.

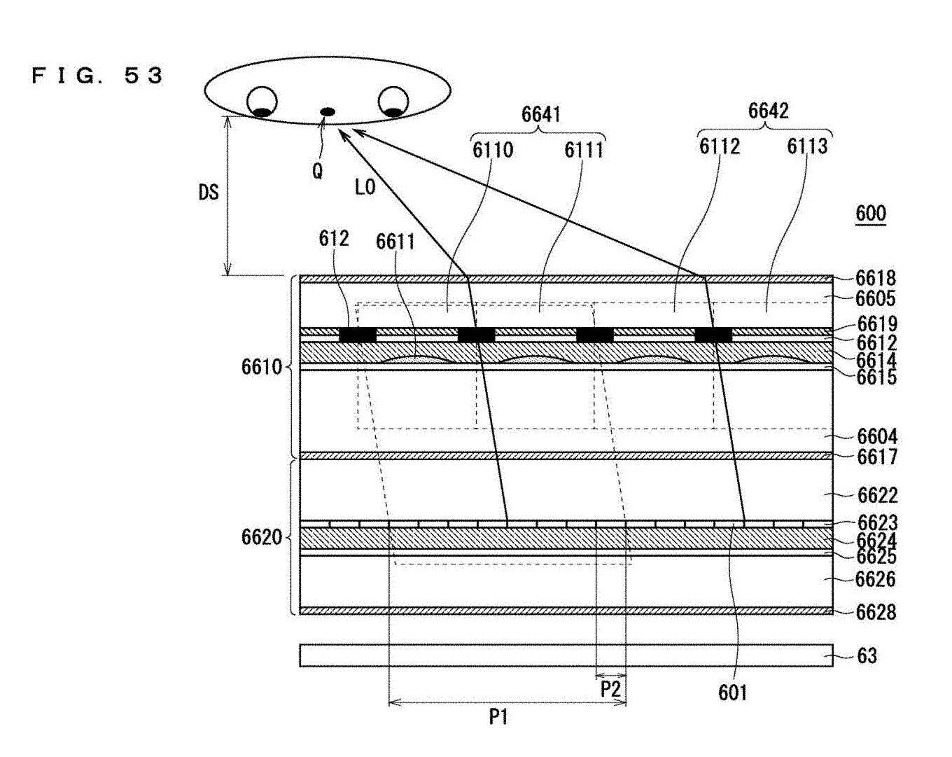

In the display panel 61, the plurality of openings provided in a light shielding part 612 constitute pixel transmission parts 611. Each of the pixel transmission parts 611 has a stripe shape in planar view, and is arranged such that the long sides are parallel to the lateral direction. A region 613 having the refractive index lower than that of the central portion or the transmittance lower than that of the central portion is provided along each long side. The structure of the display panel 61 will further be described with reference to FIG. 53.

In the parallax barrier 62, a plurality of openings provided in a barrier light shielding part 622 constitute barrier transmission parts 621. Each of the barrier transmission parts 621 has a stripe shape in planar view, and is arranged such that long sides are parallel to the lateral direction. The width of the barrier transmission part 621 of the parallax barrier 62 is about a half of the pitch in the lateral direction of the barrier transmission part 621, and a region 623 having the transmittance lower than that of the end in the lateral direction exists in the central portion in the lateral direction. The configuration of the parallax barrier 62 will further be described with reference to FIG. 53.

FIG. 52 is a schematic diagram illustrating a positional relationship among the backlight 63, the pixel transmission part 611 of the display panel 61, and the barrier transmission part 621 of the parallax barrier 62, and is a view in which the transparent electrode or transparent glass that is provided on the display panel is not illustrated. The pixel transmission part 611 of the display panel 61 and the barrier transmission part 621 of the parallax barrier 62 may be disposed apart from each other with a predetermined distance, and a medium such as air or glass may exist therebetween.

FIG. 53 is a sectional view taken along the arrangement direction of the barrier transmission part 621 in FIG. 52. FIG. 53 illustrates a sectional configuration in the lateral direction in the case that the display device 600 is the naked-eye stereoscopic display. Alternatively, the display device 600 may be a multi-image display that displays different images in each observation direction.

As illustrated in FIG. 53, the display device 600 includes a display panel 6610, a parallax barrier shutter panel 6620 disposed on the back side (that is, on the light source side) of the display panel 6610, and the backlight 63 disposed on the back side of the parallax barrier shutter panel 6620.

As illustrated in FIG. 53, the display panel 6610 is a liquid crystal panel, and includes a liquid crystal layer 6614 sandwiched between two transparent glass substrates 6604 and 6605, a surface polarizing plate 6618 provided on the main surface on the front side (that is, the observer side) of the transparent glass substrate 6605, and an intermediate polarizing plate 6617 provided on the main surface on the back side of the transparent glass substrate 6604.

A counter transparent electrode 6615 provided integrally over the entire surface is disposed on the main surface on the back side of the liquid crystal layer 6614, a sub-pixel transparent electrode 6612 divided for each pixel is disposed in the main surface on the front side of the liquid crystal layer 6614, and the electric field is applied to each pixel between the two electrodes. A color filter 6619 is disposed on the sub-pixel transparent electrode 6612, and ends of the sub-pixel transparent electrode 6612 and the color filter 6619 are shielded by the light shielding part 612.

A sub-pixel 6110, a sub-pixel 6111, a sub-pixel 6112, and a sub-pixel 6113 are formed in the crosswise direction (that is, the horizontal direction) according to the sub-pixel transparent electrode 6612 divided by the light shielding part 612. A sub-pixel pair 6641 that displays different parallax images in the right direction and the left direction is constructed by combining, for example, two adjacent sub-pixels of the sub-pixel 6110 and the sub-pixel 6111. A sub-pixel pair 6642 that displays different parallax images in the right direction and the left direction is constructed by combining two adjacent sub-pixels of the sub-pixel 6112 and the sub-pixel 6113. That is, the sub-pixel pair 6641 and the sub-pixel pair 6642 are a pixel set including two sub-pixels that display images observed from different directions.

In each transmission region of the sub-pixel divided by the light shielding part 612, a high-refractive index film 6611 is formed on a counter transparent electrode 6615 on the main surface on the back side of the liquid crystal layer 6614. The high-refractive index film 6611 is a thin film having the refractive index higher than that of the liquid crystal layer 6614 of the display panel 6610, and is formed in the central portion in the horizontal direction of a light transmission region of the sub-pixel. The high-refractive index film 6611 is made of a transparent conductive film (ITO), and has a shape that is thick at the center in the lateral direction of the transmission part and is thin at the end (that is, the end side is thinner than the central portion).

The refractive index of the transparent conductive film (ITO) ranges from 1.8 to 2.0, and is higher than the refractive index (1.5 to 1.7) of the liquid crystal layer 6614, For this reason, in the light transmission regions of the refractive indexes of the sub-pixel 6110, the sub-pixel 6111, the sub-pixel 6112, and the sub-pixel 6113, an average refractive index averaged in the vertical direction that is the light transmission direction is formed in the sub-pixel transparent electrode 6612, the liquid crystal layer 6614, the high-refractive index film 6611, and the counter transparent electrode 6615, the average refractive index having the distribution in which the average refractive index is high in the center in the lateral direction of the light transmission region and is low at the end.

A parallax barrier shutter panel 6620 includes a liquid crystal layer 6624 sandwiched between a transparent glass substrate 6622 (first transparent substrate) and a transparent glass substrate 6626 (second transparent substrate) and a display surface polarizing plate 6628 provided on the main surface on the front side of the transparent glass substrate 6626. A polarizing plate is also provided on the main surface of the transparent glass substrate 6622 on the side of the display panel 6610. However, in this case, the intermediate polarizing plate 6617 is also used as the polarizing plate.

The mode of the liquid crystal layer 6624 may be twisted nematic (TN), super twisted nematic (STN), inplane switching (IPS), optically compensated bend (OCB), or the like.

A transparent electrode 6625 (second transparent electrode) provided integrally over the entire surface is disposed on the back side main surface of the liquid crystal layer 6624, namely, on the transparent glass substrate 6626 on the side of liquid crystal layer 6624, and a transparent electrode 6623 is disposed on the main surface on the front side of the liquid crystal layer 6624, namely, on the transparent glass substrate 6622 on the side of the liquid crystal layer 6624.

A reference parallax barrier pitch P1 is defined with a length corresponding to the disposition width of each sub-pixel pair, and the transparent electrode 6623 is divided into a plurality of electrically insulated pieces within the reference parallax barrier pitch P1. Although FIG. 53 illustrates an example in which the transparent electrode 6623 is divide into eight pieces, it is not limited thereto, and the number of divisions may further be increased. Each of the divided transparent electrodes 6623 constitutes a sub-opening 601, and the width of the sub-opening 601 becomes a sub-opening pitch P2.

At this point, the positional relationship between the sub-pixel 6110 and the sub-pixel 6111, which constitute the sub-pixel pair 6641, and the corresponding sub-opening 601 within the reference parallax barrier pitch P1 is set such that the virtual light LO, which emerges from the central point within the reference parallax barrier pitch P1 and passes through the center of the light shielding part 612 located between the sub-pixel 6110 and the sub-pixel 6111, is concentrated at the design viewing point Q set in front of the display device. At this point, it is assumed that the design observation distance DS is the distance from the display panel 6610 to the design viewing point Q.

In the parallax barrier shutter panel 6620 having the above configuration, the plurality of sub-openings 601 are independently switched between a light transmission state and a light shielding state by applying the electric field to the liquid crystal layer 6624 using the transparent electrode 6623 and the transparent electrode 6625. In other words, in the parallax barrier shutter panel 6620, the divided sub-openings 601 are individually controlled to apply the electric field to the liquid crystal layer 6624, namely, the transmittance of the liquid crystal layer 6624 is controlled in each sub-opening 601 to form the barrier transmission part 621.

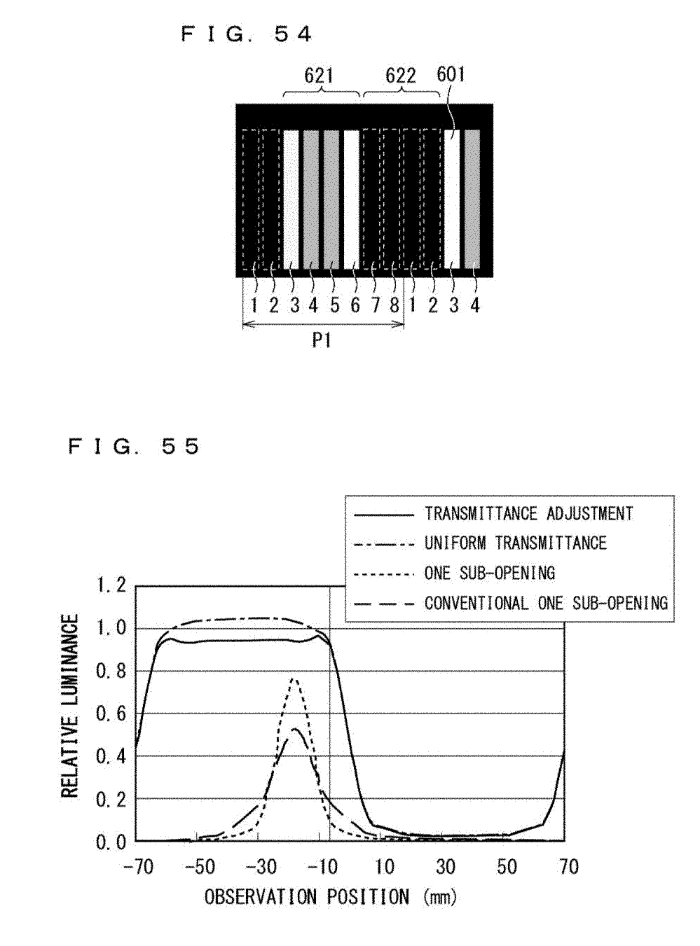

An example of the operating state of the parallax barrier shutter panel 6620 will be described below with reference to FIG. 54.

In FIG. 54, the electric field is applied to the liquid crystal layer 6624 using each transparent electrode 6623 such that four of the eight sub-openings 601 within the reference parallax barrier pitch P1 are set to the light transmission state to form the transmission part 621, and such that the remaining four sub-openings 601 are set to the light shielding state to form the light shielding part 622, thereby controlling the liquid crystal. The transmittance of the two sub-openings 601 inside the four sub-openings 601 forming the barrier transmission part 621, namely, in the central portion in the horizontal direction is set lower than the transmittance on both sides, namely, at the end in the horizontal direction of the sub-opening 601 by 2% to 20%. That is, in the sub-opening 601 disposed in the central portion in the horizontal direction among the sub-openings 601 forming the barrier transmission parts 621, the liquid crystal layer 6624 is driven such that the transmittance is lower than that of the liquid crystal layer 6624 driven in the sub-opening 601 disposed at the end in the horizontal direction.

The reason why the position of the barrier transmission part 621 of the parallax barrier shutter panel 6620 can be moved in the lateral direction with the pitch of the sub-opening 601 is similar to the operating principle that is described with reference to FIGS. 20 to 27 in the second prerequisite technique.

In FIG. 55, the horizontal axis indicates the observation position, and the vertical axis indicates the relative luminance. FIG. 55 illustrates the wave optics calculation result of the light distribution characteristic in the case that the black image and the white image are displayed in the right-eye image and the left-eye image, respectively, in the naked-eye stereoscopic display of the sixth prerequisite technique using the parallax barrier.

The transparent glass member has the refractive index of 1.5, and the wavelength is set to 550 nm in the wave optics calculation. The calculation result is the relative luminance distribution on the screen located at a position separated from the parallax barrier shutter panel by the design observation distance of 800 mm.

At this point, the liquid crystal panel has the pixel pitch of 0.076 mm, the parallax barrier shutter panel has the reference parallax barrier pitch P1 of 0.152 mm, and the inside of the reference parallax barrier pitch P1 is divided into 12 sub-openings. In the barrier transmission part of the parallax barrier shutter panel, six sub-openings of the twelve sub-openings within the reference parallax barrier pitch P1 are set to the light transmission state and the remaining sub-openings are set to the light shielding state. In the light transmission state, namely, the six sub-openings serving as the barrier transmission parts are continuously arranged. Thus, the parallax barrier shutter panel has the opening width of 0.076 mm. The transmittance of the central four sub-openings among the six sub-openings constituting the barrier transmission parts is set to 90% of the transmittance of the two sub-openings located at both ends.

The center of the left-eye pixel of the liquid crystal panel is located at −0.038 mm on the left, the center of the right-eye pixel is located at 0.038 mm on the right, the parallax barrier shutter panel has the opening width of 0.076 mm, and the opening is located below the substantial center of the pair of the right-eye pixel and the left-eye pixel of the liquid crystal panel. The distance between the opening of the liquid crystal shutter panel and the pixel is 1.3 mm.

FIG. 55 illustrates the light distribution indicated by the solid line (transmittance adjustment) in the case that the transmittance of the central four sub-openings among the six sub-openings constituting the barrier transmission parts is set to 90% of the transmittance of the sub-openings located at both the ends similarly to the display device of the sixth prerequisite technique. Additionally, as in the conventional case, the light distribution in the case that the transmittance of the six sub-openings constituting the barrier transmission parts is uniform is indicated by a long chain line (uniform transmittance) for the purpose of comparison.

Additionally, the light distribution characteristic in which one sub-opening among the six sub-openings constituting the barrier transmission parts has the transmittance of 100% while the remaining five sub-openings are set to the light shielding state in the display device of the sixth prerequisite technique is indicated by a broken line (one sub-opening) as a reference. Unlike the other three cases, a long broken line (conventional one sub-opening) indicates the light distribution characteristic in the case that the high-refractive index film does not exist in the central portion in the lateral direction of the transmission part of the liquid crystal panel, and details will be described later.

In the case that the transmittance of the six sub-openings of the barrier transmission parts is uniform as indicated by the long chain line in FIG. 55, the luminance peak has a gentle chevron shape, and the luminance is decreased by about 10% with respect to the peak in the vicinity of the observation positions of −63 mm and −7 mm (that is, the position indicated by the chain line in FIG. 55). On the other hand, in the case that the transmittance of the center four sub-openings among the six sub-openings of the barrier transmission part is set to 90% of the transmittance of the sub-openings at both the ends, the light distribution characteristic is flat as illustrated by the solid line in FIG. 55, and the decrease in the luminance with respect to the peak luminance is not generated even in the vicinity of the observation positions of −63 mm and −7 mm.

Generally, a spatial luminance step or instantaneous luminance change of about 5% or more is an amount that is sufficiently visually recognized by human eyes, and possibly becomes a trouble as the generation of a flicker change in luminance or a luminance step in the display screen in performing control of the change of the position of the barrier transmission part with respect to the movement of the observer's position to the optimum position. In the display device of the sixth prerequisite technique, the region where the luminance difference exceeds 5% is reduced, and the region where the luminance difference falls within 5% is enlarged. Consequently, in performing control of the change of the position of the barrier transmission part with respect to the movement of the observer's position to the optimum position, a frequency of the generation of the flicker change in luminance or the luminance step in the display screen is lowered, and the control is easy to perform.

The light distribution characteristic in the case that only the second sub-opening from the end of the six sub-openings of the transmission parts of the parallax barrier shutter panel has the transmittance of 100% while the remaining sub-openings are set to the light shielding state is illustrated by a broken line (one sub-opening) in FIG. 55. This luminance profile is steep, and contributes to only about 10% of the peak luminance in the luminance in the vicinity of the observation position of −7 mm. Thus, it can be understood that the steep luminance change is a factor that can control the light distribution by adjusting the transmittance of each sub-opening of the parallax barrier shutter panel. This is due to the effect that the profile of the luminance distribution is steepened by the action of the high-refractive index film 6611 provided in the transmission part of the liquid crystal panel as described in the third prerequisite technique.

In the case that the high-refractive index film does not exist in the central portion in the lateral direction of the transmission part of the liquid crystal panel, the light distribution characteristic in which the second sub-opening from the end of the six sub-openings of the barrier transmission part has the transmittance of 100% while the regaining sub-openings are set to the light shielding state is indicated by a long broken line (conventional one sub-opening) in FIG. 55. The light distribution in this case also has the peak of the luminance distribution inside the luminance peak having a gentle chevron shape in the case that the transmittance of the six sub-openings of the transmission parts indicated by the long chain line in FIG. 55 is uniform, and the flatness of the light distribution characteristic can be improved by lowering the transmittance of the sub-opening portion in the center portion of the barrier transmission part compared with the transmittance of the sub-opening at the end of the barrier transmission part.

However, in the case that the high-refractive index film does not exist in the central portion in the lateral direction of the transmission part of the liquid crystal panel, as compared with the case that the high-refractive index film exists in the central portion in the lateral direction of the transmission part of the liquid crystal panel, the light distribution characteristic (conventional one sub-opening) is wider and gentler, and contributes to about 20% of the peak luminance in the luminance in the vicinity of the observation position of −7 mm. For this reason, the luminance in the vicinity of the observation position of −7 mm is decreased when the transmittance of the sub-opening in the central portion of the barrier transmission part is decreased. Thus, in the case that the high-refractive index film does not exist in the central portion of the transmission part of the liquid crystal panel, the transmittance in the central portion of the barrier transmission part is significantly decreased as compared with the case that the high-refractive index film exists. That is, even if the high-refractive index film does not exist in the central portion of the transmission part of the liquid crystal panel, the transmittance in the central portion of the barrier transmission part is significantly decreased as compared with the case that the high-refractive index film exists, and the flatness of the light distribution characteristic can be improved.

In the case that the high-refractive index film exists in the central portion of the transmission part of the liquid crystal panel, a range of reduction of the transmittance of the sub-opening can be decreased as compared with the case the high-refractive index film does not exist, so that the decrease in luminance efficiency can be prevented.

As described above, in the direction-specific two-image display device in which a parallax barrier including a stripe-shaped opening is disposed on the back side of the display panel in which the plurality of pixels are arranged in the matrix form while the backlight is disposed on the back side of the parallax barrier, the luminance flat region of the light distribution peak can be widened by forming the region where the transmittance in the central portion in the lateral direction of the barrier transmission part is lower than the transmittance at the end in the lateral direction. This enables the observer to visually recognize the good image with no change in luminance over a wide range even if the observer's position moves laterally.

In the direction-specific two-image display device in which the parallax barrier including stripe shaped openings is disposed on the back side of the display panel in which the plurality of pixels are arranged in the matrix form while the backlight is disposed on the back side of the parallax barrier, the barrier transmission part is formed by individually controlling the plurality of sub-openings formed by the division into each region corresponding to the pixel, and the liquid crystal layer is driven such that the region where the transmittance in the central portion in the lateral direction of the barrier transmission part is lower than the transmittance at the end in the lateral direction, which allows the luminance flat region of the light distribution peak to be widened. Consequently, the movement of the barrier opening position can be controlled with no change in luminance of the image in changing the opening position of the parallax barrier shutter panel according to the lateral movement of the observer's position.

In the direction-specific two-image display device in which the parallax barrier including stripe shaped openings is disposed on the back side of the display panel in which the plurality of pixels are arranged in the matrix form while the backlight is disposed on the back side of the parallax barrier, the region having the transmittance lower than the transmittance at the end in the lateral direction of the barrier transmission part is formed in the central portion in the lateral direction, and the region having the refractive index lower than the refractive index in the central portion in the lateral direction of the display panel or the transmittance lower than the transmittance in the central portion in the lateral direction of the display panel is formed at the end in the lateral direction. Consequently, the luminance flat region of the light distribution peak can be widened while the decrease in luminance efficiency is prevented.

In the sixth prerequisite technique, the plurality of openings of the parallax barrier are arranged into the stripe shape by way of example. However, the present invention is not limited to this configuration. The similar effect is also obtained in the case that the plurality of openings of the parallax barrier are arranged in a matrix form.

As illustrated in FIG. 35 or 55 as an example, even in the case that the transmittance of the six sub-openings of the barrier transmission parts is uniform, and even in the case that the central four sub-openings among the six sub-openings are set to 90% of the transmittance of the sub-openings located at both the ends, the relative luminance at the midpoint between the right and left images at the position of 0 mm is about 50% of the peak.

Consequently, in the case that white and white are displayed in the right and left images, the luminance at the midpoint also becomes almost similar to the peak, and a 3D moire does not appear. The 3D moire is one of the factors that degrades quality of the naked-eye stereoscopic display, and the effect that enhances the quality can be obtained by eliminating the 3D moire.

The reason why the relative luminance of the midpoint between the right and left images at the position of 0 mm is about 50% of the peak is that geometrical optically the opening width of the barrier is 50% of the barrier pitch. The luminance at the intermediate point changes somewhat due to the influence of the diffraction. However, in the direction-specific two-image display device in which the parallax barrier is disposed on the back side of the display panel while the backlight is disposed on the back side of the parallax barrier, the region having the refractive index lower than that in the central portion or the transmittance lower than in the central portion is provided at the lateral ends of the pixel transmission part of the display panel. Consequently, the luminance distribution at the boundary becomes linear, so that the profile comes close to the profile predicted from geometrical optics.

### PREFERRED EMBODIMENT

In a display device and a driving method according to the preferred embodiment, by applying voltage Vs different from voltage Vi, which is applied to the transparent electrodes of the plurality of sub-openings constituting other light shielding parts in the parallax barrier, to the transparent electrodes located at lateral ends in the transparent electrodes of the plurality of sub-openings constituting the light shielding part of the parallax barrier, the 3D moire is prevented to decrease the 3D crosstalk in a configuration in which the liquid crystal display panel of the third, fourth, fifth and sixth prerequisite techniques in which the pixels are arranged in the matrix form and the parallax barrier disposed between the liquid crystal display panel and the backlight disposed on the back side of the liquid crystal display panel are combined, and a configuration in which the transmittance of the transmission part of the liquid crystal display panel is high in the central portion in the width direction (also referred to as the lateral direction) and is low on the end side (that is, the end side is lower than the central portion) or the average refractive index of the transmission part of the liquid crystal display panel is high in the central portion in the width direction (that is, the lateral direction) and is low on the end side (that is, the end side is lower than the central portion).

<Device Configuration>

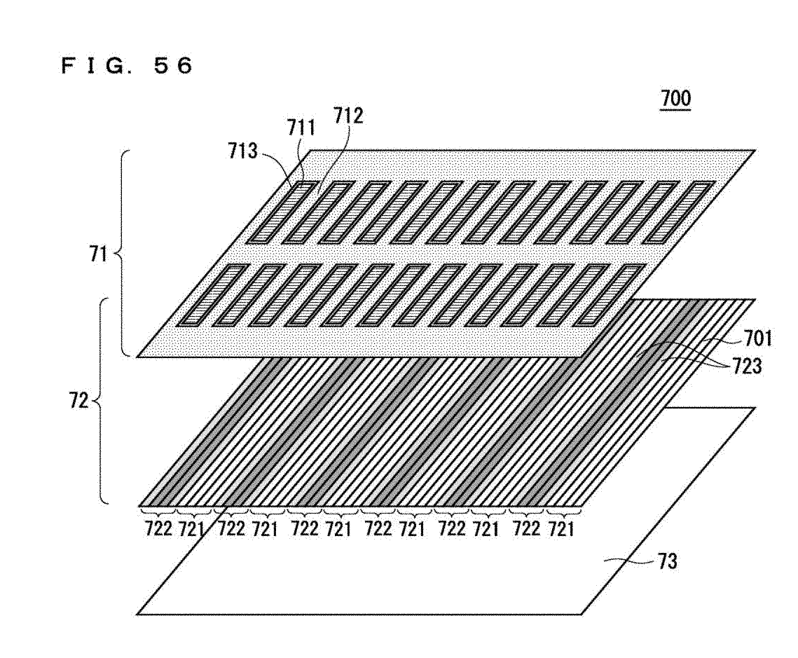

FIG. 56 is a schematic perspective view illustrating a two-image display of the preferred embodiment (that is, a display device 700) in which a pixel set (that is, a sub-pixel pair) having at least two pixels as one set that display different images according to the observation direction is disposed. The display device 700 is a display device having a configuration in which a display panel 71, a parallax barrier 72, and a backlight 73 are disposed in this order while overlapping one another in planar view.

As illustrated in FIG. 56, the parallax barrier 72 is disposed on the back side of the display panel 71 in which a plurality of pixels are arranged in a matrix form. The backlight 73 is provided on the back side of the parallax barrier 72.

In the display panel 71, the plurality of openings provided in a light shielding part 712 constitute pixel transmission parts 711 corresponding to the pixels. Each of the pixel transmission parts 711 has a substantially rectangular shape in planar view, and is arranged such that long sides are parallel to the lateral direction in FIG. 56.

A pixel translucent part 713 (diffraction preventing structure) that is a region having the average refractive index lower than that of the central portion or the transmittance lower than the central portion is provided along each long side. By providing the pixel translucent part 713, the luminance gradient is steepened at the boundary without largely decreasing the peak luminance, so that the leakage light can be prevented. The pixel transmission part 711 and the pixel translucent part 713 are combined to constitute the light transmission part. The specific configuration of the display panel 71 is similar to that of the display panel 6610 in FIG. 53 of the sixth prerequisite technique.

That is, the display panel 71 is a liquid crystal panel, and includes a liquid crystal layer sandwiched between two transparent glass substrates, a surface polarizing plate provided on the main surface on the front side (that is, the observer side) of the laminated structure, and an intermediate polarizing plate provided on the main surface on the back side of these laminated structures.

A counter transparent electrode provided integrally over the entire surface is disposed on the main surface on the back side of the liquid crystal layer, a sub-pixel transparent electrode divided for each pixel is disposed in the main surface on the front side of the liquid crystal layer, and the electric field is applied to each pixel between the two electrodes. A color filter is disposed on the sub-pixel transparent electrode, and ends of the sub-pixel transparent electrode and the color filter are shielded by the light shielding part 712.

The parallax barrier 72 includes 2n (n is an integer, n=4 in this case) sub-openings 701 per reference barrier pitch at which the sub-openings 701 are arranged at a uniform pitch in the lateral direction in FIG. 56. By setting the sub-openings 701 to the light shielding state and the light transmitting state in each n sub-openings 701, a barrier light shielding part 722 and a barrier transmission part 721 are formed while having a substantially identical lateral width.

In each transmission region of the sub-pixel divided by the light shielding part, a high-refractive index film is formed on a counter transparent electrode on the main surface on the back side of the liquid crystal layer. The high-refractive index film is a thin film having the refractive index higher than that of the liquid crystal layer of the display panel 71, and is formed in the central portion in the horizontal direction of a light transmission region (corresponding to the transmission part) of the sub-pixel. The high-refractive index film is made of a transparent conductive film (ITO), and has a shape that is thick at the center in the lateral direction of the transmission part and is thin at the end (that is, the end side is thinner than the central portion).

The transparent conductive film (ITO) has the refractive index of 1.8 to 2.0, which is higher than the refractive index (1.5 to 1.7) of the liquid crystal layer. For this reason, in the light transmission region of the sub-pixel, the average refractive index averaged in the vertical direction that is the light transmission direction is high in the center in the lateral direction of the light transmission region, and is low at the end.

By including the high-refractive index film, the width of the boundary region having the large 3D crosstalk can be narrowed, and the light distribution characteristic having the minimum leakage luminance can be obtained.

The width between barrier light shielding part ends 723 that are the sub-openings located at the ends of the barrier light shielding parts 722 in the sub-openings 701 constituting the barrier light shielding parts 722 is adjusted to equalize the width of the barrier light shielding part 722 and the width of the barrier transmission part 721 to each other, thereby preventing the generation of the 3D moire. The specific configuration of the parallax barrier 72 is similar to that of the parallax barrier shutter panel 6620 in FIG. 53 of the sixth prerequisite technique.

That is, the parallax barrier 72 includes a liquid crystal layer sandwiched between transparent glass substrates and a back polarizing plate provided on the main surface on the back side of the laminated structure.

The mode of the liquid crystal layer may be twisted nematic (TN), super twisted nematic (STN), inplane switching (IPS), optically compensated bend (OCB), or the like.

A transparent electrode provided integrally over the entire surface is disposed on the back side main surface of the liquid crystal layer, namely, on the transparent glass substrate on the side of liquid crystal layer, and a transparent electrode is disposed on the main surface on the front side of the liquid crystal layer, namely, on the transparent glass substrate on the side opposite to the liquid crystal layer.

The reference parallax barrier pitch P1 is defined with a length corresponding to the disposition width of each sub-pixel pair, and the transparent electrode is divided into a plurality of electrically insulated pieces within the reference parallax barrier pitch P1. Each of the divided transparent electrodes constitutes the sub-opening, and the width of the sub-opening becomes the sub-opening pitch.

In the parallax barrier 72 having the above configuration, the plurality of sub-openings are independently switched between a light transmission state and a light shielding state by applying the electric field to the liquid crystal layer using the transparent electrode. In other words, in the parallax barrier 72, the divided sub-openings are individually controlled to apply the electric field to the liquid crystal layer, namely, the transmittance of the liquid crystal layer is controlled in each sub-opening to form the barrier transmission part 721 and the barrier light shielding part 722. Desirably the barrier transmission part 721 has the high transmittance exceeding 90% in order to enhance the luminance efficiency, and desirably the barrier light shielding part 722 has the low transmittance of 10% or less in order to prevent the 3D crosstalk.

FIG. 56 is a schematic diagram illustrating a positional relationship among a backlight 73, the pixel transmission part 711 of the display panel 71, and the barrier transmission part 721 of the parallax barrier 72, and is a view in which the transparent electrode or transparent glass substrate that is provided on the display panel 71 is not illustrated. The pixel transmission part 711 of the display panel 71 and the barrier transmission part 721 of the parallax barrier 72 may be disposed apart from each other with a predetermined distance, and a medium such as air or glass may exist therebetween.

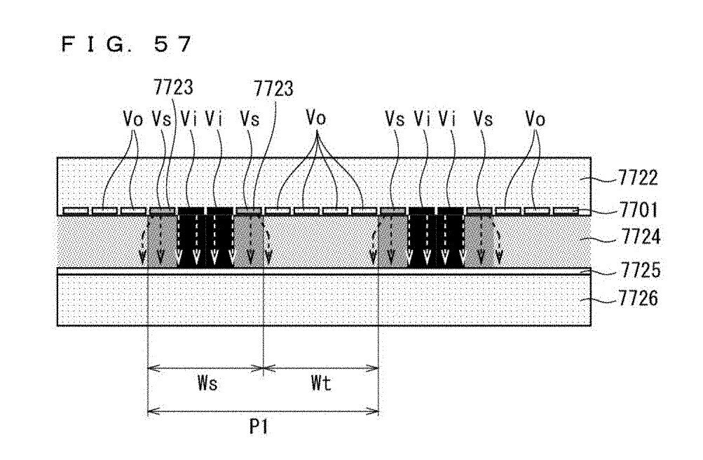

The operation of the parallax barrier 72 having the above configuration in the parallax barrier shutter panel will be described with reference to FIG. 57. In the parallax barrier shutter panel of the parallax barrier 72 of the preferred embodiment, for example, the liquid crystal mode is a normally white type twisted nematic (TN), in which the transmittance is decreased with increasing voltage applied to the liquid crystal layer and the transmittance is maximized in the state in which the voltage is not applied.

The voltage is applied to the liquid crystal layer 7724 held by transparent glass substrates 7722 and 7726 using a plurality of transparent electrodes 7701, which are arranged while further interposed in the laminated structure including the transparent glass substrates and the liquid crystal layer, and a common electrode 7725 opposed to the transparent electrodes 7701.

Specifically, the electric field is generated between the transparent electrode 7701 and the common electrode 7725 by applying predetermined voltages Vs and Vi to some of the transparent electrodes 7701 constituting the sub-opening 701, whereby the barrier light shielding part 722 is formed. A barrier transmission part 721 is formed by applying voltage Vo close to 0 V to the remaining transparent electrodes 7701 constituting the sub-opening 701.

At this point, 2n==8 sub-openings 701 (corresponding to the transparent electrode 7701) are arranged per reference barrier pitch. The numbers of the transparent electrodes 7701 constituting the barrier light shielding part 722 and the barrier transmission part 721 are equal to each other, and each n=4 transparent electrodes 7701 are provided.

That is, each of the transparent electrodes 7701 is divided into a plurality (in this case, 4) of pieces in the region corresponding to the sub-pixel that is one of the sub-pixel pair.

At this point, the voltage Vs<5.2 V is applied to the transparent electrode 7723 located at the barrier light shielding part end 723 such that the width of the barrier light shielding part 722 is equal to the width of the barrier transmission part 721, and such that the 3D moire is prevented. On the other hand, the voltage Vi>6.5 V, which is the voltage at which the 3D crosstalk is decreased in the oblique direction, is applied to other transparent electrodes 7701 in the barrier light shielding part 722.

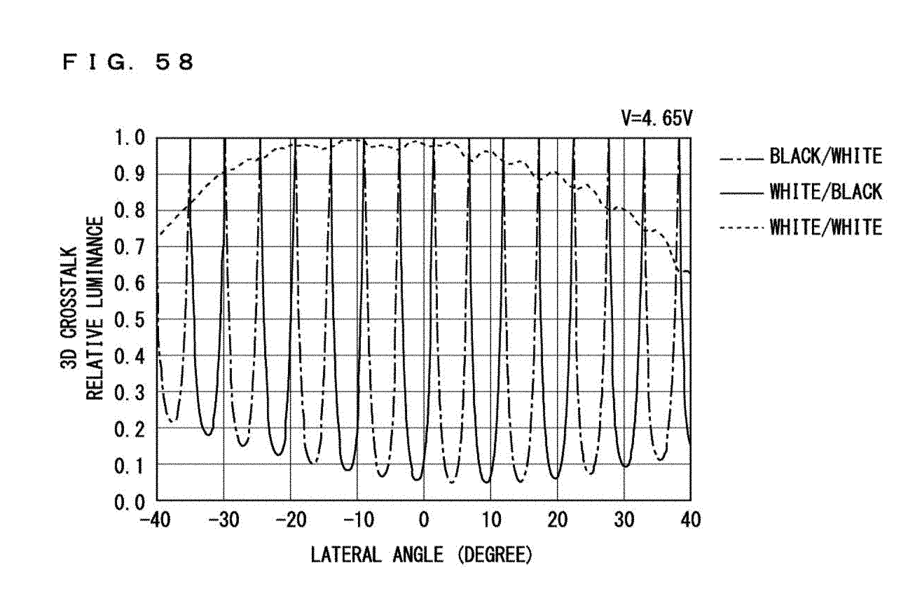

The voltages Vs and Vi applied to the transparent electrodes 7701 in the barrier light shielding part 722 will be described below with reference to FIGS. 58 to 63.

In FIGS. 58, 59, 60, and 61, the barrier light shielding part 722 is formed by applying a voltage V to the four consecutive transparent electrodes 7701 in 2n (n is an integer, n===4 in this case) sub-openings 701 within the reference parallax barrier pitch P1 to set the liquid crystal layer 7724 to the light shielding state while the barrier transmission part 721 is formed by applying 0 V to the remaining four transparent electrodes 7701 to set the liquid crystal layer 7724 to the light transmission state.

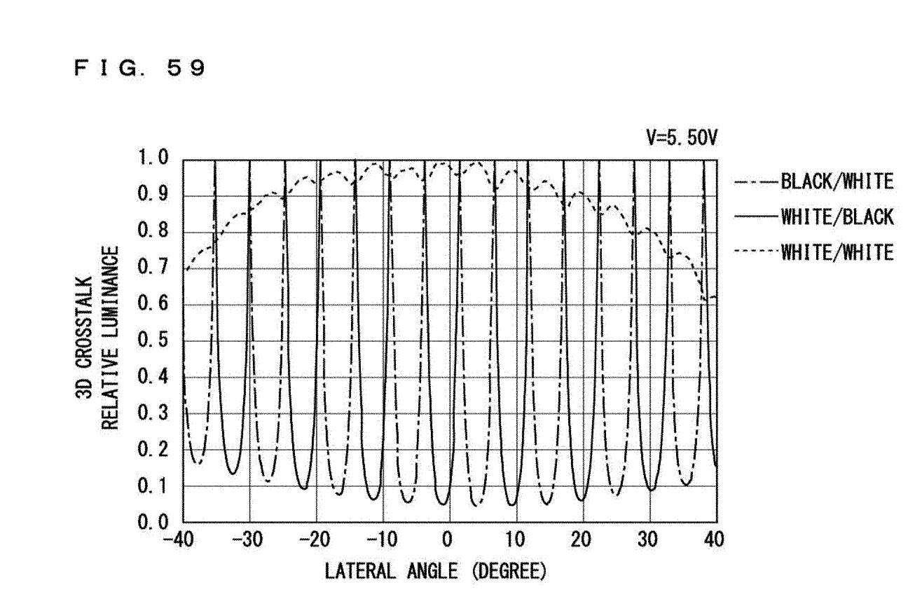

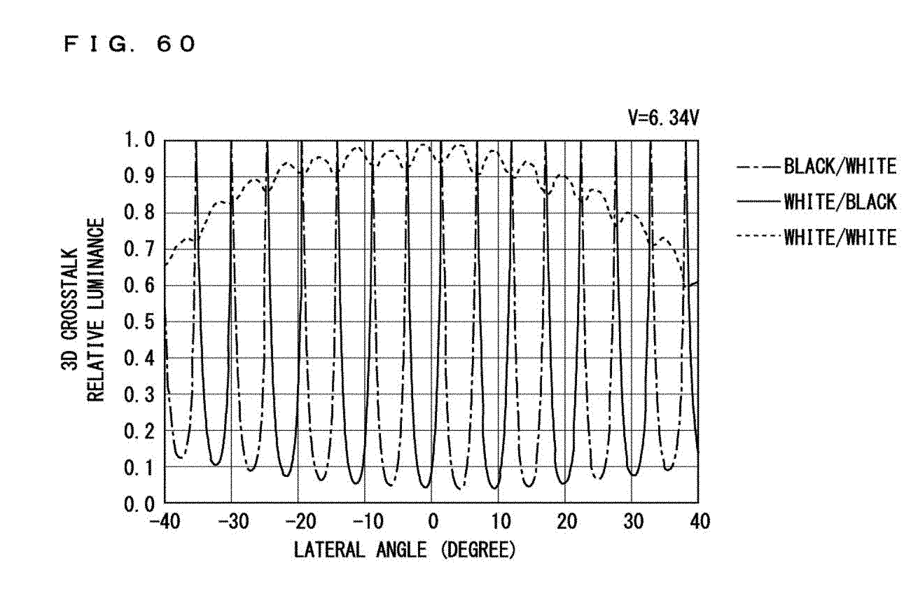

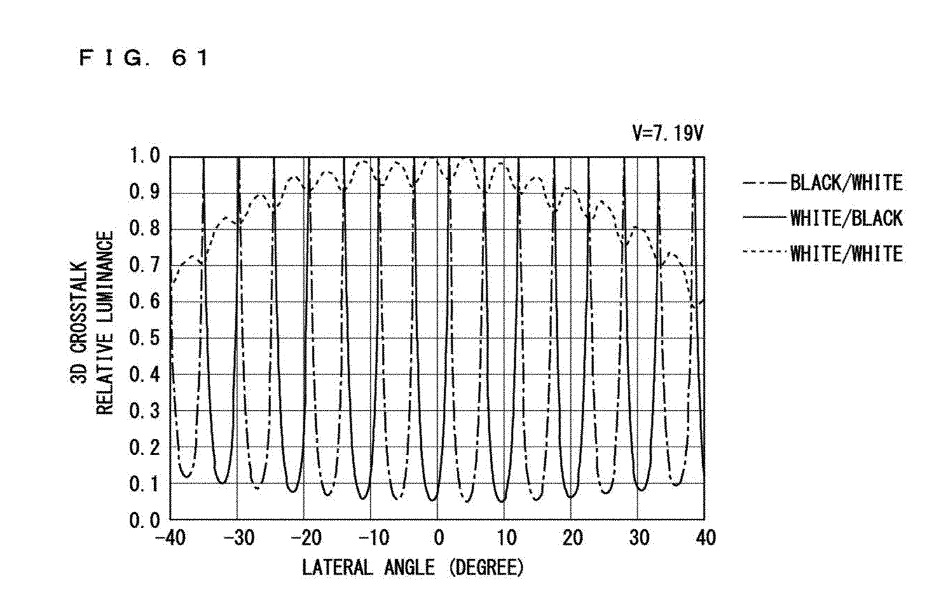

FIGS. 58, 59, 60, and 61 illustrate the lateral angular distribution of the 3D crosstalk in the case that the identical voltage is applied to the four consecutive transparent electrodes 7701 constituting the barrier light shielding part 722. That is, a relative luminance angle distribution (white/black) in the case that the right-eye image is the white image while the left-eye image is the black image is indicated by a solid line, a relative luminance angle distribution (black/white) in the case that the right-eye image is the black image while the left-eye image is the white image is indicated by a chain line, and a relative luminance angular distribution (white/white) in the case that both the right-eye image and the left-eye image are the white image is indicated by a dotted line. FIG. 58 illustrates the case of V 4.65 V, FIG. 59 illustrates the case of V=5.50 V, FIG. 60 illustrates the case of V=6.34 V, and FIG. 61 illustrates the case of V=7.19 V. In FIGS. 58, 59, 60, and 61, the vertical axis indicates the relative luminance, and the horizontal axis indicates the horizontal angle (degree).

As can be seen from FIGS. 58, 59, 60 and 61, when V ranges from 4.65 V to and 7.19 V, the 3D crosstalk in the front direction (specifically, near zero degree) is about 5%, and the parallax barrier functions effectively.

However, as illustrated in the case of V=4.65 V in FIG. 58, the 3D crosstalk in the oblique direction (specifically, −32° white/black, −27° black/white) becomes greater than or equal to 20% when the voltage V is low. The cause is due to the degradation of the contrast viewing angle performance by an influence of a pretilt angle of the liquid crystal molecules in a general normally white TN mode liquid crystal panel. This means that when the observer is positioned diagonally, the double image is generated due to the 3D crosstalk to degrade the image quality.

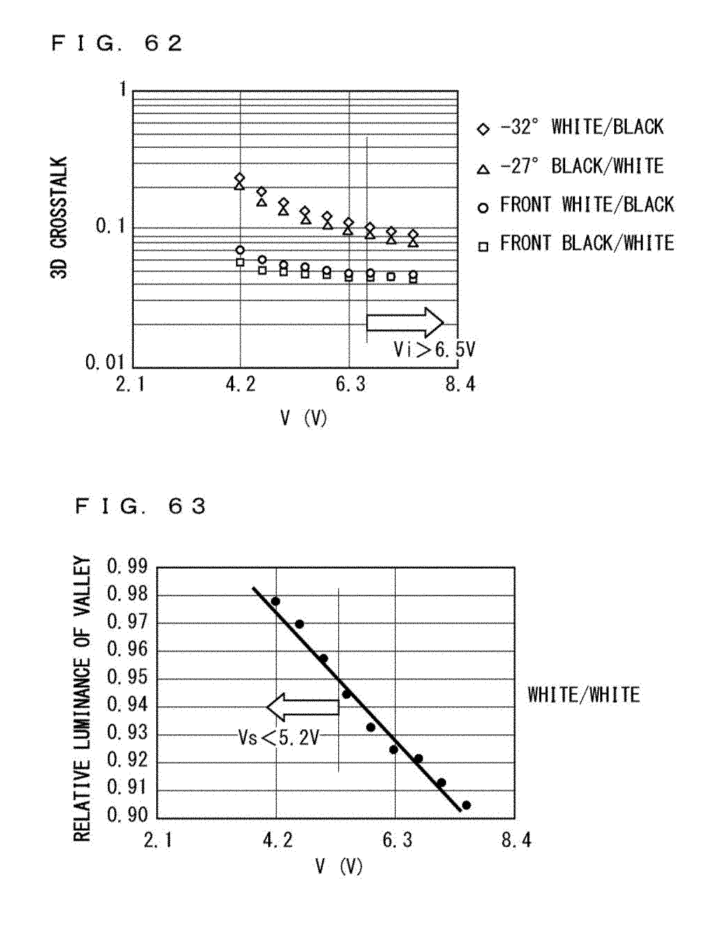

FIG. 62 illustrates a relationship between the 3D crosstalk and the voltage V. In FIG. 62, the 3D crosstalk (front white/black) is indicated by a circle, the 3D crosstalk (front black/white) is indicated by a square mark, the 3D crosstalk (−32° white/black) is indicated by a diamond mark, and the 3D crosstalk (−27° black/white) is indicated by a triangle mark.

The 3D crosstalk in the front direction (specifically, front white/black and front black/white) is as small as 7% or less at V 4.2 V, but the 3D crosstalk in the oblique direction (specifically, −32° white/black and −27° black/white) exceeds 20% at V=4.2 V. As can be seen from FIG. 62, in order to prevent the oblique 3D crosstalk to 10% or less, it is necessary to apply the voltage V higher than 6.5 V. In FIG. 62, the vertical axis illustrates a ratio of 3D crosstalk, and the horizontal axis illustrates the voltage [V].

As an indication of the oblique angular range where the 3D crosstalk needs to be prevented to 10% or less, the prevention may be performed within the range of about 30 degrees on the right and left, and more desirably within the range of about 40 degrees on the right and left.

On the other hand, when attention is paid to the relative luminance angular distribution (white/white) in the case that both the right-eye image and the left-eye image are the white image, as can be seen from FIGS. 58, 59, 60, and 61, a valley of the relative luminance angular distribution becomes deeper with increasing applied voltage V in the case that both the right-eye image and the left-eye image are the white image.

This means that the luminance is largely changed due to the difference in viewing angle, and indicates that the dense 3D moire is generated in the screen. The 3D moire is one of the factors that degrade the quality of the naked-eye stereoscopic display.

Geometrical optically, it is known that the valley of the relative luminance angle distribution is not generated when a width Wt of the barrier transmission part 721 is equal to a width Ws of the barrier light shielding part 722, and when the width Wt and the width Ws are exactly half of the reference parallax barrier pitch P1.

The reason why the valley of the relative luminance angular distribution becomes deeper is that with increasing applied voltage V increases, the width of the liquid crystal layer 7724 set to the light shielding state becomes larger than the width of the corresponding transparent electrode, and the width Wt of the barrier transmission part 721 becomes smaller than a half of the reference parallax barrier pitch P1 (that is, the width Ws of the barrier light shielding part 722 becomes larger than the width Wt of the barrier transmission part 721).

In order to prevent the 3D moire, it is necessary to prevent at least the difference between the relative luminance of valley in the angular distribution and the relative luminance of the peak in the angular distribution to 5% or less.

FIG. 63 illustrates the relationship between the relative luminance of the valley near the front of the relative luminance profile and the applied voltage V. In FIG. 63, the vertical axis indicates the relative luminance of the valley, and the horizontal axis indicates the applied voltage [V]. As can be seen from FIG. 63, in order to reduce the difference in density of the 3D moire (corresponding to an undulation width of the luminance distribution) to 5% or less, it is necessary that the relative luminance of the valley near the front that is the vertical axis of this graph be greater than or equal to 0.95 or more, namely, the range of the applied voltage V be smaller than 5.2 V. This indicates that the applied voltage V at which the prevention of the 3D moire and the prevention of the oblique 3D crosstalk are is compatible with each other does not exist.

In order to solve this problem, the inventors devised a driving method in which different voltages are applied to the transparent electrode 7723 located at the barrier light shielding part end 723 and other transparent electrodes 7701 in the barrier light shielding part 722.

That is, the voltage Vs<5.2 V at which the 3D moire is prevented is applied to the transparent electrode 7723 located at the barrier light shielding part end 723, and the higher voltage Vi>6.5 V at which the oblique 3D crosstalk is deceased is applied other transparent electrodes 7701 in the barrier light shielding part 722.

As illustrated in FIG. 57, the width Ws of the barrier light shielding part 722 is decided by the voltage Vs applied to the transparent electrode 7723 of the barrier light shielding part end 723. On the other hand, the minimum value of the oblique 3D crosstalk is decided by the transmittance (contrast viewing angle performance) of the central sub-opening 701 among the plurality of sub-openings 701 corresponding to the barrier light shielding part end 723.

As illustrated in FIG. 54 of the sixth prerequisite technique, the maximum value of the luminance profile is decided by the transmittance of the sub-opening located in the center among the plurality of sub-openings constituting the barrier transmission part. Similarly, as in the display device of the preferred embodiment, the minimum value of the oblique 3D crosstalk is decided by the transmittance (contrast viewing angle performance) of the sub-opening 701 located in the center in the barrier light shielding part 722. The parallax barrier 72 is of a normally white type, and the transmittance of the liquid crystal layer 7724 is decreased (that is, the contrast viewing angle performance is improved) with increasing voltage applied to the liquid crystal layer 7724.

In the display device of the preferred embodiment, the voltage Vs=4.2 V is applied to the transparent electrode 7723 at the barrier light shielding part end 723, and the voltage Vi>6.5 V is applied to other transparent electrodes 7701 in the barrier light shielding part 722. As a result, the relative luminance of the valley becomes 98% (that is, the difference between the luminance of the valley and the luminance of the peak is as small as 2%), the 3D moire is prevented, and at the same time the oblique 3D crosstalk can be prevented to 10% or less.

As described in the sixth prerequisite technique, this effect becomes more conspicuous in the case that the pixel translucent part 713 (diffraction preventing structure), which is the region having the low transmittance or the low refractive index, is provided at the ends in the lateral direction of the pixel transmission part 711 of the display panel 71. However, even if the diffraction preventing structure does not exist in the display panel 71, the oblique 3D crosstalk can be prevented as compared with the case that the voltage Vs<5.2 V is applied to all the transparent electrodes 7701 in the barrier light shielding part 722.

In the above description, the voltage V=4.2 V is applied to the two transparent electrodes 7723 located at the barrier light shielding part end 723, and the width in the lateral direction of the barrier light shielding part 722 and the width in the lateral direction of the barrier transmission part 721 are equalized to each other to prevent the 3D moire. Alternatively, a low voltage is applied to one of the two transparent electrodes 7723 located at the barrier light shielding part end 723, and the width in the lateral direction of the barrier light shielding part 722 and the width in the lateral direction of the barrier transmission part 721 can be equalized to each other to prevent the 3D moire.

In the preferred embodiment, because it is more effective in preventing the 3D moire, the present invention is applied to the display device having the configuration in which the parallax barrier is provided behind the display panel (that is, on the back side with respect to the image viewing side) based on the third, fourth, fifth, and sixth prerequisite techniques. Alternatively, the present invention may be applied to the display device having the configuration in which the parallax barrier is formed in front of the display panel (that is, the image viewing side) based on the first or second prerequisite technique. Even in this case, although there is a difference in degree from the display device of the preferred embodiment, the 3D moire can be prevented, and the oblique 3D crosstalk can be prevented.

As a specific indication of the setting value of the voltage Vs applied to the two transparent electrodes 7723 located at the barrier light shielding part end 723 and the setting value of the voltage Vi applied to other transparent electrodes 7701 in the barrier light shielding part 722, because basically the need to function as the barrier light shielding part 722 in the parallax barrier 72, it is necessary that both the voltages Vs and Vi be greater than or equal to a predetermined voltage at which the 3D crosstalk is prevented at least in the front direction (specifically, near zero degree). It is necessary that the voltage Vs applied to the two transparent electrodes 7723 located at the barrier light shielding part end 723 be less than or equal to a predetermined voltage at which the 3D moire is prevented at least in the front direction (specifically, near zero degree).

As a more specific indication of the predetermined voltage (lower limit), the voltage Vs applied to the two transparent electrodes 7723 located at the barrier light shielding part end 723 that is at a lower voltage of both the voltages may be set greater than or equal to a predetermined voltage at which the 3D crosstalk in the front direction (specifically, near zero degree) can be prevented less than or equal to 5%. As a more specific indication of the predetermined voltage (upper limit) of the voltage Vs required to prevent the 3D moire, as the voltage Vs<5.2 V is set in the preferred embodiment, the voltage Vs may be set less than or equal to a predetermined voltage at which the difference in density of the 3D moire (corresponding to the undulation width of the luminance distribution) can be prevented less than or equal to 5% or a predetermined voltage at which the relative luminance of the valley in the vicinity of the front is greater than or equal to 0.95.

On the other hand, as a specific indication of the setting value of the voltage Vi applied to other transparent electrodes 7701 in the barrier light shielding part 722, as the voltage Vi>6.5 V is set in the preferred embodiment, the voltage Vi may be set greater than or equal to a predetermined voltage at which the oblique 3D crosstalk can be prevented less than or equal to 10%. As described above, the indication of the oblique angular range where the 3D crosstalk needs to be prevented less than or equal to 10%, the prevention can be performed within the range of about 30° on the right and left, and more desirably within the range of about 40° on the right and left. Thus, more specifically, the voltage value Vi greater than or equal to the predetermined voltage at which the 3D crosstalk can be prevented less than or equal to 10% in at least the oblique direction within the range of 30° on the right and left may be set to the setting value, more desirably the voltage value Vi greater than or equal to the predetermined voltage at which the 3D crosstalk can be prevented less than or equal to 10% in the oblique direction within the range of 40° on the right and left.

The preferred embodiment is merely an example, and the present invention is not limited to the described specific content. For example, in the preferred embodiment, the number of images displayed for each direction is two has been described. However, the present invention is not limited to this configuration, and the same holds true for the case of multiple images such as three images and four images.

The preferred embodiment, the first prerequisite technique, the second prerequisite technique, the third prerequisite technique, the fourth prerequisite technique, the fifth prerequisite technique, and the sixth premise technology can freely be combined, or the modification or the omission of the preferred embodiment, the first prerequisite technique, the second prerequisite technique, the third prerequisite technique, the fourth prerequisite technique, the fifth prerequisite technique, and the sixth premise technology can appropriately be made.

<Effects Generated by Preferred Embodiment>

An example of the effect generated by the preferred embodiment will be described below. In the following description, the effect is described based on the specific configuration described in the preferred embodiment, but the effect may be replaced with other specific configurations illustrated in the specification within the scope in which the similar effect is generated.

According to the preferred embodiment, the display device includes the display panel 71 on which the pixel set including at least two pixels that display the images observed from different directions is disposed, the parallax barrier 72 that is disposed while overlapping the display panel 71 in planar view, and the backlight 73 that is disposed while overlapping the display panel 71 in planar view. At this point, for example, the pixel set corresponds to the sub-pixel pair 6641 defined by the reference parallax barrier pitch P1. The parallax barrier 72 includes the liquid crystal layer 7724 and a first electrode layer and a second electrode layer, which are disposed while overlapping the liquid crystal layer 7724 in planar view, the liquid crystal layer 7724 being interposed between the first electrode layer and the second electrode layer. For example, the first electrode layer corresponds to a plurality of transparent electrodes 7701. For example, the second electrode layer corresponds to the common electrode 7725. The transparent electrodes 7701 in the parallax barrier 72 are arranged while corresponding to the plurality of pixels in the display panel 71. The plurality of transparent electrodes 7701 includes a plurality of divided electrode layers divided from each other in a unit region corresponding to one pixel. At this point, for example, the unit region corresponds to a region corresponding to one sub-pixel. For example, the divided electrode layer corresponds to each transparent electrode 7701 that is divided and disposed in the region corresponding to one sub-pixel. A first voltage applied to at least one of the transparent electrodes 7701 located at the end in the unit region is higher than a second voltage applied to at least one of the transparent electrodes 7701 located at the position except for the edge in the unit region. For example, the first voltage corresponds to the voltage Vs applied to the transparent electrode 7701 located at the barrier light shielding part end 723. For example, the second voltage corresponds to the voltage Vi applied to the transparent electrode 7701 located at the position except for the barrier light shielding part end 723.

According to the configuration, the stereoscopic vision can be continued over the wide range even if the observer moves, and the generation of the 3D crosstalk and the 3D moire can be prevented.

Other configurations except for those described in the specification of the present application can appropriately be omitted. That is, as long as the display device have at least these configurations, the effects described above can be exerted.

However, in the case that at least one of other configurations illustrated by an example in this specification is appropriately added to the configuration described above, namely, even in the case that another configuration illustrated in the specification of the present application that is not described as the configuration described above is appropriately added, the same effect can be produced.

According to the preferred embodiment described above, the parallax barrier 72 is of a normally white type in which the transmittance of the liquid crystal layer 7724 is decreased with increasing voltage applied to the liquid crystal layer 7724. According to such a configuration, in the case that the voltage Vs applied to the transparent electrode 7701 located at the barrier light shielding part end 723 is lower than the voltage Vi applied to the transparent electrode 7701 located outside the barrier light shielding part end 723, the transmittance of the liquid crystal layer 7724 located at the barrier light shielding part end 723 can be made higher than the transmittance of the liquid crystal layer 7724 located at the position except for the barrier light shielding part end 723.

According to the preferred embodiment described above, the voltage Vs is set greater than or equal to the value of 4.65 V. According to such a configuration, the 3D crosstalk in the front direction (specifically, near zero degree) can be prevented to about 5%.

According to the preferred embodiment described above, the voltage Vs is set less than the value of 5.2 V. According to such a configuration, the difference in the density of the 3D moire can be prevented less than or equal to 5%.

According to the preferred embodiment described above, the voltage Vi is set greater than the value of 6.5 V. According to such a configuration, not only the 3D crosstalk in the front direction can be prevented, but also the oblique 3D crosstalk can be prevented less than or equal to 10%.

According to the preferred embodiment described above, the display panel 71 includes the transmission part that is disposed at the position corresponding to each pixels to transmit the light. For example, the transmission part corresponds to the place including the pixel transmission part 711 and the pixel translucent part 713. In the pixel translucent part 713 formed at the end of the transmission part, the average refractive index or the transmittance is lower than that of the pixel transmission part 711 formed at the position except for the end of the transmission part. According to such a configuration, by providing the pixel translucent part 713, the luminance gradient is steepened at the boundary without largely decreasing the peak luminance, so that the leakage light can be prevented.

According to the preferred embodiment described above, the transmission part includes the thin film formed in the central portion of the transmission part. The central portion of the transmission part has the average refractive index higher than that at the end of the transmission part. According to such a configuration, the width of the boundary region having the large 3D crosstalk can be narrowed, and the light distribution characteristic having the minimum leakage luminance can be obtained.

According to the preferred embodiment described above, the parallax barrier 72 is disposed while sandwiched between the display panel 71 and the backlight 73. According to such a configuration, the 3D moire can more effectively be prevented.

According to the preferred embodiment described above, in the display device driving method, the voltage Vs is applied to the transparent electrode 7701 that is at least one divided electrode layer located at the end in the unit region. Then, a voltage Vi is applied to the transparent electrode 7701 which is at least one of the divided electrode layers located in the unit region other than the end portion. The voltage Vs is lower than the voltage Vi.

According to the configuration, the stereoscopic vision can be continued over the wide range even if the observer moves, and the generation of the 3D crosstalk and the 3D moire can be prevented.

Other configurations except for those described in the specification of the present application can appropriately be omitted. That is, as long as the display device have at least these configurations, the effects described above can be exerted.

However, in the case that at least one of other configurations illustrated by an example in this specification is appropriately added to the configuration described above, namely, even in the case that another configuration illustrated in the specification of the present application that is not described as the configuration described above is appropriately added, the same effect can be produced.

When there is no particular restriction, the order in which each processing is performed can be changed.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a display panel on which a pixel set including at least two pixels as one set that display each of images observed from different directions is disposed;
a parallax barrier that is disposed while overlapping the display panel in planar view; and
a backlight that is disposed while overlapping the display panel in planar view, wherein
the parallax barrier includes:
a liquid crystal layer; and
a first electrode layer and a second electrode layer, which overlap the liquid crystal layer in planar view and are disposed with the liquid crystal layer interposed between the first electrode layer and the second electrode layer,
the parallax barrier is of a normally white type in which transmittance of the liquid crystal layer is decreased with increasing voltage applied to the liquid crystal layer,
the first electrode layer in the parallax barrier is disposed while corresponding to the plurality of pixels in the display panel,
the first electrode layer includes 2N divided electrode layers divided from each other in a unit region corresponding to the one pixel set,
a transmission part is formed by applying voltage at which the transmittance of the liquid crystal layer becomes greater than or equal to 90% to the consecutive N divided electrode layers,
a light shielding part is formed by applying voltage at which the transmittance of the liquid crystal layer becomes less than or equal to 10% to the N divided electrode layers continuously extended from the divided electrode layer adjacent to the transmission part, and
a first voltage applied to at least one of the divided electrode layers located at an end of the light shielding part is lower than a second voltage applied to at least one of the divided electrode layers located at a position except for the end of the light shielding part.

2. The display device according to claim 1, wherein the first voltage is applied to at least one of the divided electrode layers located at the end of the light shielding part such that an undulation width of a luminance distribution is less than or equal to 5% when a white image is displayed as a left-eye image of the display panel while a white image is displayed as a right-eye image of the display panel.

3. The display device according to claim 1, wherein the second voltage is applied to at least one of the divided electrode layers located at the position except for the end of the light shielding part such that a ratio of an oblique 3D crosstalk is less than or equal to 10% when a black image is displayed as a left-eye image of the display panel while a white image is displayed as a right-eye image of the display panel, or when the white image is displayed as the left-eye image of the display panel while the black image is displayed as the right-eye image of the display panel.

4. The display device according to claim 3, wherein the oblique direction falls within a range of 30 degrees on the right and left.

5. The display device according to claim 1, wherein
the display panel further includes a light transmission part that is disposed at a position corresponding to each of the pixels to transmit light, and
in the light transmission part, an end of the light transmission part is lower than a portion except for the end of the light transmission part in an average refractive index or the transmittance.

6. The display device according to claim 5, wherein
the light transmission part includes a thin film formed in a central portion of the light transmission part, and
in the light transmission part, the central portion of the light transmission part is higher than the end of the light transmission part in an average refractive index.

7. The display device according to claim 1, wherein the parallax barrier is arranged so as to be sandwiched between the display panel and the backlight.

8. A display device driving method for driving a display device including:
a display panel on which a pixel set including at least two pixels as one set that display each of images observed from different directions is disposed;
a parallax barrier that is disposed while overlapping the display panel in planar view; and
a backlight that is disposed while overlapping the display panel in planar view, wherein
the parallax barrier includes:
a liquid crystal layer; and
a first electrode layer and a second electrode layer, which overlap the liquid crystal layer in planar view and are disposed with the liquid crystal layer interposed between the first electrode layer and the second electrode layer,
the parallax barrier is of a normally white type in which transmittance of the liquid crystal layer is decreased with increasing voltage applied to the liquid crystal layer,
the first electrode layer in the parallax barrier is disposed while corresponding to the plurality of pixels in the display panel,
the first electrode layer includes 2N divided electrode layers divided from each other in a unit region corresponding to the one pixel set,
a transmission part is formed by applying voltage at which the transmittance of the liquid crystal layer becomes greater than or equal to 90% to the consecutive N divided electrode layers,
a light shielding part is formed by applying voltage at which the transmittance of the liquid crystal layer becomes less than or equal to 10% to the N divided electrode layers continuously extended from the divided electrode layer adjacent to the transmission part,
a first voltage is applied to at least one of the divided electrode layers located at an end of the light shielding part,
a second voltage is applied to at least one of the divided electrode layers located at a position except for the end of the light shielding part, and
the first voltage is lower than the second voltage.

9. The display device driving method according to claim 8, wherein the first voltage is applied to at least one of the divided electrode layers located at the end of the light shielding part such that an undulation width of a luminance distribution is less than or equal to 5% when a white image is displayed as a left-eye image of the display panel while a white image is displayed as a right-eye image of the display panel.

10. The display device driving method according to claim 8, wherein the second voltage is applied to at least one of the divided electrode layers located at the position except for the end of the light shielding part such that a ratio of an oblique 3D crosstalk is less than or equal to 10% when a black image is displayed as a left-eye image of the display panel while a white image is displayed as a right-eye image of the display panel, or when the white image is displayed as the left-eye image of the display panel while the black image is displayed as the right-eye image of the display panel.

11. The display device driving method according to claim 10, wherein the oblique direction falls within a range of 30 degrees on the right and left.
